(19) United States
(12) Patent Application Publication
(10) Pub. No.: US 2022/0042641 A1
(43) Pub. Date: Feb. 10, 2022

(54) JOINT CONFIGURATIONS

(71) Applicant: CONCEPT GROUP LLC, Wellesley, MA (US)

(72) Inventors: Shriram RADHAKRISHNAN, West Palm Beach, FL (US); David H. REID, Jr., Fort Pierce, FL (US); Aarne H. REID, Jupiter, FL (US); Peter ROACH, Jacksonville, FL (US); Michael Cline MURRAY, Jupiter, FL (US)

(21) Appl. No.: 17/297,742

(22) PCT Filed: Nov. 27, 2019
(86) PCT No.: PCT/US2019/063574

§ 371 Date: May 27, 2021

Related U.S. Application Data
(60) Provisional application No. 62/773,816, filed on Nov. 30, 2018.
(60) Provisional application No. 62/811,217, filed on Feb. 27, 2019.
(60) Provisional application No. 62/825,123, filed on Mar. 28, 2019.
(60) Provisional application No. 62/876,075, filed on Jul. 19, 2019.
(60) Provisional application No. 62/911,443, filed on Oct. 7, 2019.

(51) Int. Cl. F16L 59/065; F17C 3/08; A24F 40/42; A24F 40/70

(52) U.S. Cl. CPC F16L 59/065; A24F 40/70; A24F 40/42; F17C 3/08

(57) ABSTRACT

Provided are thermally insulating components that include sealed joints between the walls that define an insulating space therebetween. Also provided are related methods of forming and using the disclosed components. Additionally provided are thermally insulating components that include a positive thermal coefficient material.

### RELATED APPLICATIONS

The present application claims priority to and the benefit of U.S. Patent Application No. 62/773,816, “Joint Configurations” (filed Nov. 30, 2018); U.S. Patent Application No. 62/811,217, “Joint Configurations” (filed Feb. 27, 2019); U.S. Patent Application No. 62/825,123, “Joint Configurations” (filed Mar. 28, 2019); U.S. Patent Application No. 62/876,075, “Variably-Dimensioned Thermal Insulation Components” (filed Jul. 19, 2019); and U.S. Patent Application No. 62/911,443, “Vacuum Insulated Articles Comprising Positive Thermal Coefficient Components” (filed Oct. 7, 2019). All of the foregoing applications are incorporated herein by reference in their entireties for any and all purposes.

### TECHNICAL FIELD

The present disclosure relates to the field of forming sealed, evacuated spaces for use as thermal insulation.

### BACKGROUND

Thermally-insulating components are needed in a broad range of applications, e.g., fluid transport, fluid storage, and the like. Existing thermally-insulating components, however, can be difficult to assemble and may not always meet the user's needs in terms of their thermal insulation capabilities. In particular, the wall-to-wall joints used to assemble existing thermal insulation components can be difficult to manufacture and process. Accordingly, there is a long-felt need in the art for improved thermal insulation components, as well as related methods of using such components.

Additionally, with traditional resistive heater devices, current is applied and the resistive material (e.g., a metal) heats up in response to the applied current as described by the well-known i²R relationship, where i is current and R is the resistance of the material to which the current is applied. Such devices are typically operated in an on/off fashion in which current is applied until the material reaches a desired temperature and then the current is then turned on and off to maintain the temperature of the material at the desired level. Although such devices are simple in their construction and can achieve comparatively high temperatures, the devices are also difficult to control and require careful monitoring, as extended application of current can cause the device to “run away” and overheat. Accordingly, there is a need in the art for improved heater devices, as well as a technology that can enclose such heaters so as to conserve heat that such heaters may evolve.

### SUMMARY

In meeting the long-felt needs described above, the present disclosure first provides an insulating component, comprising: a first wall bounding an interior volume; a second wall spaced at a distance from the first wall so as to define an insulating space between the first wall and the second wall; and an end cap, the end cap optionally being toroidal in form and optionally defining a U-shaped cross-sectional profile, the end cap comprising a portion that extends along the first wall, the end cap comprising a portion that extends along the second wall, the end cap at least partially sealing the insulating space defined between the first wall and the second wall.

Also provided is a molecule excitation chamber, comprising: a first wall bounding an interior volume, the first wall comprising a main portion having a length and a projection portion having a length, the main portion optionally extending perpendicular to the projection portion; a second wall bounding the interior volume, the second wall comprising a main portion having a length and optionally comprising a projection portion having a length, (a) the projection portion of the first wall and the second wall defining a first vent therebetween, or (b) the second wall and the first wall defining a second vent therebetween, or (c) both (a) and (b), and the ratio of the length of the main portion of the first wall to the projection portion of the first wall being from about 1000:1 to about 1:1, and, optionally, a heat source configured to effect heating of molecules disposed within the interior volume of the molecule excitation chamber.

Also provided are methods, comprising opening the first vent of a molecule excitation chamber according to the present disclosure.

Further provided are methods, comprising: assembling (a) a first wall comprising a main portion having a length and a projection portion having a length, the main portion optionally extending perpendicular to the projection portion, and the ratio of the length of the main portion of the first wall to the projection portion of the first wall being from about 1000:1 to about 1;1, and (b) a second wall comprising a main portion having a length and optionally comprising a projection portion having a length, the assembling being performed so as to define a first vent defined by the projection portion of the first wall and the second wall, and, sealing the first vent so as to seal a space between the first wall and the second wall.

Also disclosed are insulating components, comprising: a first wall bounding an interior volume; a second wall spaced at a distance from the first wall so as to define an insulating space between the first wall and the second wall; an inner surface of the second wall facing the insulating space, and an outer surface of the first wall facing the insulating space, (a) the first wall comprising an extension portion that (i) extends from a first end of the first wall toward the inner surface of the second wall and is optionally essentially perpendicular to the inner surface of the second wall and/or (ii) extends toward a second end of the first wall, the extension portion of the first wall optionally further comprising a land portion that is essentially parallel to the inner surface of the second wall, or (b) the second wall comprising an extension portion that (i) extends from a first end of the second wall toward the outer surface of the first wall and is optionally essentially perpendicular to the outer surface of the first wall and/or (ii) extends toward a second end of the second wall, the extension portion of the second wall optionally further comprising a land portion that is essentially parallel to the outer surface of the first wall, or both (a) and (b), and a first vent communicating with the insulating space to provide an exit pathway for gas molecules from the insulating space, the vent being sealable for sealing the insulating space following egress of gas molecules through the vent.

Additionally provided are methods, comprising communicating a fluid within the interior volume of an insulating component according to the present disclosure.

Also disclosed are methods, comprising heating a material disposed at least partially within the interior volume of an insulating component according to the present disclosure.

Further provided are methods, comprising: with a first wall bounding an interior volume and a second wall spaced at a distance from the first wall, a volume defined between the first wall and the second wall, (a) the first wall comprising an extension portion that extends toward the second wall and is optionally essentially perpendicular to the inner surface of the second wall, the extension portion of the first wall optionally further comprising a land portion that is essentially parallel to the inner surface of the second wall, (b) the second wall comprising an extension portion that extends toward the outer surface of the first wall and is optionally essentially perpendicular to the outer surface of the first wall, the extension portion of the second wall optionally further comprising a land portion that is essentially parallel to the outer surface of the first wall, or both (a) and (b), and (c) the land portion of the first wall contacting the second wall so as to define a volume between the first wall and the second wall, (d) the land portion of the second wall contacting the first wall so as to define a volume between the first wall and the second wall, or both (c) and (d), heating the first wall and the second wall under conditions effective to effect thermal expansion of the second wall relative to the first wall, the thermal expansion giving give rise to or increasing a space between the land portion of the first wall and the second wall and/or giving rise to or increasing a space between the land portion of the second wall and the first wall, thereby allowing gas molecules to exit the volume defined between the first wall and the second wall.

Additionally provided are insulating components, comprising: a first wall bounding an interior volume; a second wall spaced at a distance from the first wall so as to define an insulating space between the first wall and the second wall; a first cap, the first cap at least partially sealing the insulating space defined between the first wall and the second wall, the first cap comprising a first land, the first land optionally sealed to the first wall, and the first cap further comprising a second land, the second land optionally sealed to the second wall. a first vent communicating with the insulating space to provide an exit pathway for gas molecules from the insulating space, the first vent being sealable for sealing the insulating space following egress of gas molecules through the vent.

Further provided are insulating components, comprising: a first wall bounding an interior volume; a second wall spaced at a distance from the first wall so as to define an insulating space between the first wall and the second wall; a first cap defining a curved profile, the first cap at least partially sealing the insulating space defined between the first wall and the second wall, a second cap defining a curved profile, the second cap comprising a first portion sealed to the first wall, the second cap further comprising a second portion sealed to the second wall, and the curved profile of first wall and the curved profile of the second wall being concave away from one another.

Also provided are insulating components, comprising: a second wall bounding at least a portion of an interior volume and defining a lumen therein, the interior volume defining a major axis; a first wall spaced at a distance from the first wall so as to define an insulating space between the first wall and the second wall; the interior volume defining a first cross-sectional dimension at a first location along the major axis and the interior volume defining a second cross-sectional dimension at a second location along the major axis.

Further provided are methods, comprising communicating or retaining a fluid within the interior volume of an insulating component according to the present disclosure.

Additionally provided are insulating components, comprising: a first wall and a second wall, the first wall and second wall defining a sealed insulating space therebetween; a third wall and a fourth wall, the third wall and the fourth wall defining a sealed insulating space; and the second wall and third wall defining an interstitial space therebetween.

Also disclosed are methods, comprising: communicating or retaining a fluid within the lumen of an insulating component according to the present disclosure.

Additionally provided are insulating components, comprising: (i) a first vessel comprising (a) a second wall bounding at least a portion of an interior volume, the interior volume defining a major axis and (b) a first wall spaced at a distance from the first wall so as to define a sealed insulating space between the first wall and the second wall; (ii) a feedthrough portion comprising (a) a first feedthrough wall and (b) a second feedthrough wall, the first feedthrough wall and the second feedthrough wall defining a sealed insulated space therebetween, the second feedthrough wall defining a lumen therein, the lumen of the feedthrough portion being in fluid communication with the interior volume of the first vessel.

In meeting the long-felt needs described above, the present disclosure first provides an insulated article comprising: a first wall bounding an interior volume; a second wall spaced at a distance from the first wall to define an insulating space therebetween, the first and second walls being of the same or different materials; and a vent communicating with the insulating space to provide an exit pathway for gas molecules from the space, the vent being sealable for maintaining a vacuum within the insulating space following evacuation of gas molecules through the vent, the distance between the first and second walls being variable in a portion of the insulating space adjacent the vent such that gas molecules within the insulating space are directed towards the vent by the variable-distance portion of the first and second walls during the evacuation of the insulating space, the directing of the gas molecules by the variable-distance portion of the first and second walls imparting to the gas molecules a greater probability of egress from the insulating space than ingress, and (a) a positive thermal coefficient (PTC) material being at least partially disposed within the interior volume, (b) the first wall at least partially comprising a PTC material, (c) the second wall at least partially comprising a PTC material, (d) a PTC material being disposed exterior to the second wall, or any combination of (a), (b), (c), and (d).

The present disclosure also provides methods, comprising: applying a current to the PTC material of an insulated article according to the present disclosure so as to effect heating of the PTC material. The current can be constant, but can also be varying with time.

Also provided are insulated articles, comprising: a first wall bounding an interior volume; a second wall spaced at a distance from the first wall, a sealed insulating space defined between the first wall and the second wall; and (a) a positive thermal coefficient (PTC) material being at least partially disposed within the interior volume, (b) the first wall at least partially comprising a PTC material, (c) the second wall at least partially comprising a PTC material, (d) a PTC material being disposed exterior to the second wall, or any combination of (a), (b), (c), and (d).

Further provided are methods, comprising: applying a current to the PTC material of an insulated article according to the present disclosure so as to effect heating of the PTC material.

Additionally provided are insulating components, comprising: a first wall bounding an interior volume; a second wall spaced at a distance from the first wall so as to define an insulating space between the first wall and the second wall; and an end cap defining an M-shaped cross-sectional profile, the end cap comprising a portion that extends along the first wall, the end cap comprising a portion that extends along the second wall, the end cap comprising a portion that extends into the insulating space, the end cap at least partially sealing the insulating space defined between the first wall and the second wall.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1 provides a cutaway view of an exemplary component according to the present disclosure, showing an illustrative wall configuration;

FIG. 2 provides a cutaway view of an exemplary component according to the present disclosure, showing an illustrative wall configuration;

FIG. 3 provides a cutaway view of an exemplary component according to the present disclosure, showing an illustrative wall configuration;

FIG. 4 provides a cutaway view of an exemplary component according to the present disclosure, showing an illustrative wall configuration;

FIG. 5 provides a cutaway view of an exemplary component according to the present disclosure, showing an illustrative wall configuration;

FIG. 6 provides a cutaway view of an exemplary component according to the present disclosure, showing an illustrative wall configuration;

FIG. 7 provides a cutaway view of an exemplary component according to the present disclosure, showing an illustrative wall configuration;

FIG. 8 provides a cutaway view of an exemplary component according to the present disclosure, showing an illustrative wall configuration;

FIG. 9 provides a cutaway view of an exemplary component according to the present disclosure, showing an illustrative wall configuration;

FIG. 10 provides a cutaway view of an exemplary component according to the present disclosure, showing an illustrative wall configuration;

FIG. 11 provides a cutaway view of an exemplary component according to the present disclosure, showing an illustrative wall configuration;

FIG. 12 provides a cutaway view of an exemplary component according to the present disclosure, showing an illustrative wall configuration;

FIG. 13 provides a cutaway view of an exemplary component according to the present disclosure, showing an illustrative wall configuration;

FIG. 14 provides a cutaway view of an exemplary component according to the present disclosure, showing an illustrative wall configuration;

FIG. 15A, FIG. 15B, and FIG. 15C provide cutaway views of an exemplary component according to the present disclosure, showing an illustrative wall configuration;

FIG. 16 provides a cutaway view of an exemplary component according to the present disclosure, showing an illustrative wall configuration;

FIG. 17 provides a cutaway view of an exemplary component according to the present disclosure, showing an illustrative wall configuration;

FIG. 18 provides a cutaway view of an exemplary component according to the present disclosure, showing an illustrative wall configuration;

FIG. 19 provides a cutaway view of an exemplary component according to the present disclosure, showing an illustrative wall configuration;

FIG. 20 provides a cutaway view of an exemplary component according to the present disclosure, showing an illustrative wall configuration;

FIG. 21 provides a cutaway view of an exemplary component according to the present disclosure, showing an illustrative wall configuration;

FIG. 22 provides a cutaway view of an exemplary component according to the present disclosure, showing an illustrative wall configuration;

FIG. 23 provides a cutaway view of an exemplary component according to the present disclosure, showing an illustrative wall configuration;

FIG. 24 provides a cutaway view of an exemplary component according to the present disclosure, showing an illustrative wall configuration;

FIG. 25 provides a cutaway view of an exemplary component according to the present disclosure, showing an illustrative wall configuration;

FIG. 26 provides a cutaway view of an exemplary component according to the present disclosure, showing an illustrative wall configuration;

FIG. 27 provides a cutaway view of an exemplary component according to the present disclosure, showing an illustrative wall configuration;

FIG. 28 provides a close-up cutaway view of a joint region of an exemplary component according to the present disclosure;

FIG. 29 provides a cutaway view of an exemplary component according to the present disclosure, showing an illustrative wall configuration;

FIG. 30 provides a close-up cutaway view of a joint region of an exemplary component according to the present disclosure;

FIG. 31 provides a cutaway view of an exemplary component according to the present disclosure, showing an illustrative wall configuration;

FIG. 32 provides a cutaway view of an exemplary component according to the present disclosure, showing an illustrative wall configuration;

FIG. 33 provides a cross-sectional view of a joint region of an exemplary component according to the present disclosure;

FIG. 34 provides a close-up view of the ends of a ring of braze material in a component according to the present disclosure;

FIG. 35 provides a cutaway view of two tube sections joined according to the present disclosure;

FIG. 36 provides a cutaway view of an exemplary component according to the present disclosure, showing an illustrative wall configuration;

FIG. 37 provides a cutaway view of an exemplary component according to the present disclosure, showing an illustrative wall configuration;

FIG. 38 provides a cutaway view of an exemplary component according to the present disclosure, showing an illustrative wall configuration;

FIG. 39 provides a cutaway view of an exemplary component according to the present disclosure, showing an illustrative wall configuration;

FIG. 40 provides a cutaway view of an exemplary component according to the present disclosure, showing an illustrative wall configuration;

FIG. 41 provides a cutaway view of an exemplary component according to the present disclosure, showing an illustrative wall configuration;

FIG. 42 provides a cutaway view of an exemplary component according to the present disclosure, showing an illustrative wall configuration;

FIG. 43 provides a cutaway view of an exemplary component according to the present disclosure, showing an illustrative wall configuration;

FIG. 44 provides a cutaway view of an exemplary component according to the present disclosure, showing an illustrative wall configuration;

FIG. 45 provides a cutaway view of an exemplary component according to the present disclosure, showing an illustrative wall configuration;

FIG. 46 provides a cutaway view of an exemplary component according to the present disclosure, showing an illustrative wall configuration;

FIG. 47 provides a view of an exemplary cap according to the present disclosure; and

FIG. 48 provides a cutaway view of the cap shown in FIG. 47;

FIG. 49 provides a cutaway view of an exemplary article according to the present disclosure;

FIG. 50 provides a cutaway view of an exemplary article according to the present disclosure;

FIG. 51 provides a cutaway view of an exemplary article according to the present disclosure;

FIG. 52 provides a cutaway view of an exemplary article according to the present disclosure;

FIG. 53A provides a cutaway view of a variably-dimensioned article according to the present disclosure;

FIG. 53B provides a cutaway view of a variably-dimensioned article according to the present disclosure;

FIG. 54 provides a cutaway view of a variably-dimensioned article according to the present disclosure;

FIG. 55 provides a cutaway view of a variably-dimensioned article according to the present disclosure;

FIG. 56 provides a cutaway view of a variably-dimensioned article according to the present disclosure;

FIG. 57 provides a cutaway view of an exemplary article according to the present disclosure;

FIG. 58A provides a view of a variably-dimensioned article according to the present disclosure;

FIG. 58B provides a view of a variably-dimensioned article according to the present disclosure;

FIG. 58C provides a view of a variably-dimensioned article according to the present disclosure; and

FIG. 58D provides a view of a variably-dimensioned article according to the present disclosure.

FIG. 59 provides a cutaway view of an article according to the present disclosure;

FIG. 60 provides a magnified view of the article according to FIG. 59;

FIG. 61 provides a magnified view of an article according to the present disclosure;

FIG. 62 is a partial sectional view of a structure incorporating an insulating space according to the invention.

FIG. 63 is a sectional view of another structure according to the invention.

FIG. 64 is a sectional view of an alternative structure to that of FIG. 2 including a layer of spacer material on a surface of the insulation space.

FIG. 65 is a partial sectional view of a cooling device according to the invention.

FIG. 66 is a partial perspective view, in section, of an alternative cooling device according to the invention.

FIG. 67 is a partial perspective view, in section, of an end of the cooling device of FIG. 5 including an expansion chamber.

FIG. 68 is a partial sectional view of a cooling device having an alternative gas inlet construction from the cooling devices of FIGS. 4 through 6

FIG. 69 is a partial perspective view, in section, of a container according to the invention.

FIG. 70 is a perspective view, in section, of a Dewar according to the invention.

FIG. 71 provides a cutaway view of an embodiment of the disclosed technology.

FIG. 72 provides a cutaway view of an embodiment of the disclosed technology.

FIG. 73 provides a cutaway view of an exemplary component according to the present disclosure, showing an illustrative wall configuration.

FIG. 74 provides a cutaway view of an exemplary component according to the present disclosure, showing an illustrative wall configuration.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps may be performed in any order.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B may include parts in addition to Part A and Part B, but may also be formed only from Part A and Part B.

### Terms

As used herein, the term “ceramic” refers to an inorganic, non-metallic, solid material comprising metal, non-metal or metalloid atoms primarily held in ionic and covalent bonds. A ceramic can be crystalline or non-crystalline. The term “ceramic” should also be understood as including ceramic alloys.

The present invention increases the depth of vacuum that can be sealed within an insulation space by providing a geometry adjacent an exit having a guiding effect on gas molecules during an evacuation process. As will be described in greater detail, the geometry according to the invention provides for removal of a greater number of gas molecules from the space than could otherwise be achieved without the use of a getter material. The elimination of the need for a getter material in the evacuated space to achieve deep vacuums is a significant benefit of the present invention. By eliminating the need for getter material, the invention provides for deepened vacuums in insulated spaces in which this was not previously possible because of space constraints. Such insulated spaces include those for devices of miniature scale or devices having insulating spaces of extremely narrow width.

Exemplary walls, sealing processes, and insulating spaces can be found in, e.g., US2018/0106414; US2017/0253416; US2017/0225276; US2017/0120362; US2017/0062774; US2017/0043938; US2016/0084425; US2015/0260332; US2015/0110548; US2014/0090737; US2012/0090817; US2011/0264084; US2008/0121642; US2005/0211711; WO/2019/014463; WO/2019/010385; WO/2018/093781; WO/2018/093773; WO/2018/093776; PCT/US2018/047974; WO/2017/152045; U.S. 62/773,816; and U.S. Pat. No. 6,139,571, the entireties of which documents are incorporated herein for any and all purposes.

### FIGURES

The attached non-limiting figures illustrate various aspects of the disclosed technology. It should be understood that these figures are exemplary only and do not limit the scope of the present disclosure or the appended claims.

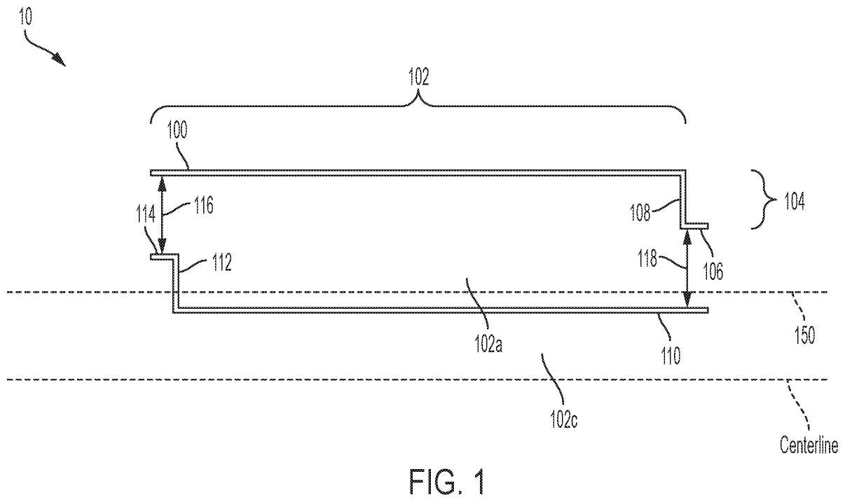

FIG. 1 provides an exemplary depiction of a component 10 according to the present disclosure. As shown, component 10 includes first wall 100, which first wall can define a main portion 102. The first wall can include a projection portion 108, which can optionally project perpendicular from the main portion, though this is not a requirement. Projection portion can define a length 104. The first wall can also include a land portion 106.

As shown, vent 118 can be defined between first wall 100 and second wall 110. Second wall 110 can include a main portion (not labeled); second wall 110 can also define a volume therein, e.g., when second wall 110 is tubular in configuration. Second wall 110 can also include projection portion 112, which can optionally project perpendicular from second wall 110. Second wall 110 can also include land portion 114. Second vent 116 can be defined between the first wall and the second wall. As shown, a line 150 that is parallel to the major axis of the space defined between first wall 100 and second wall 110 can be drawn. In some embodiments, such a parallel line does not intersect both first vent 116 and second vent 118. Wall 100 and wall 110 can define a space/volume 102a therebetween. (It should be understood that the terms “first wall” and “second wall” are for convenience only and are not limiting. As one example, the “first wall” can be the inner wall of a double-wall tube component or the outer wall of that double-wall tube component.)

It should be understood that one or both of walls 100 and 110 can be cylindrical in configuration. In this way, the walls can define a volume (102c) within wall 110, which volume 102c can be cylindrical in shape and can have a centerline (shown in FIG. 1). It should also be understood that either or both of walls 100 and 110 can include one or more fins extending therefrom. A fin can act as a heat sink and/or as a heat exchange surface.

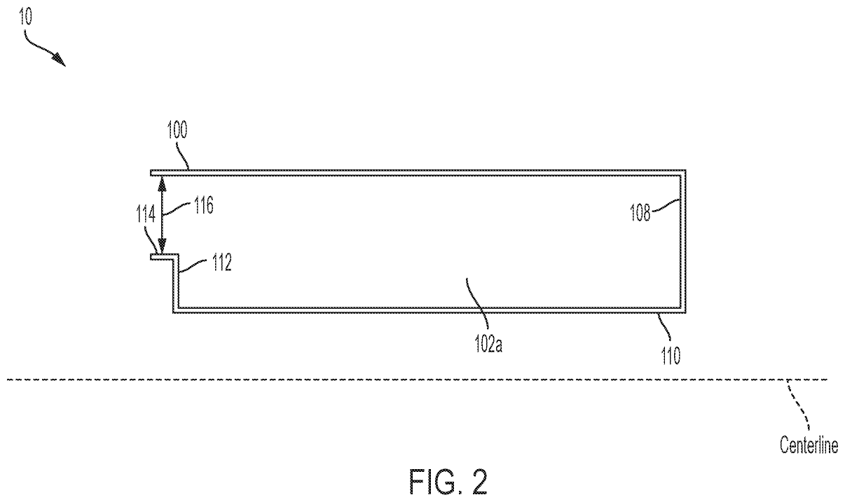

FIG. 2 provides a depiction of an alternative embodiment of a component according to the present disclosure. As shown, first wall 100 includes a projection portion 108, which can optionally project perpendicular from the main portion, though this is not a requirement. Second wall 110 can include a main portion (not labeled). Second wall 110 can also include projection portion 112, which can optionally project perpendicular from second wall 110. Second wall 110 can also include land portion 114. Second vent 116 can be defined between the first wall and the second wall. As shown, the embodiment of FIG. 2 includes only a single vent, i.e., vent 114. Wall 100 and wall 110 can define a space/volume 102a therebetween, which can be evacuated.

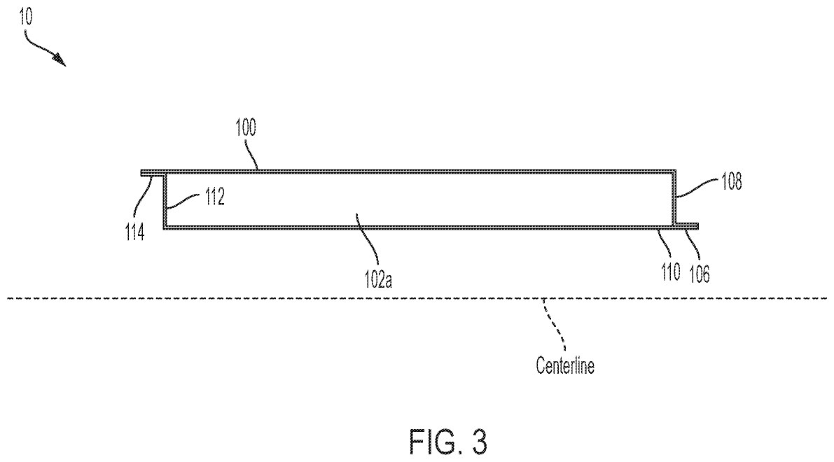

FIG. 3 provides a further depiction of an embodiment of the disclosed technology, in this case a sealed version of FIG. 1. More specifically, the depicted component includes a first wall 100. The first wall can include a projection portion 108, which can optionally project perpendicular from the main portion, though this is not a requirement. The first wall can also include a land portion 106, which land portion can be sealed to second wall 110. Second wall 110 can also include projection portion 112, which can optionally project perpendicular from second wall 110. Second wall 110 can also include land portion 114, which can be sealed to first wall 100. A parallel to the major axis of the space defined between first wall 100 and second wall 110 can be drawn. In some embodiments, such a parallel line does not intersect the seals between the first wall and the second wall at lands 106 and 114. Wall 100 and wall 110 can define a space/volume 102a therebetween.

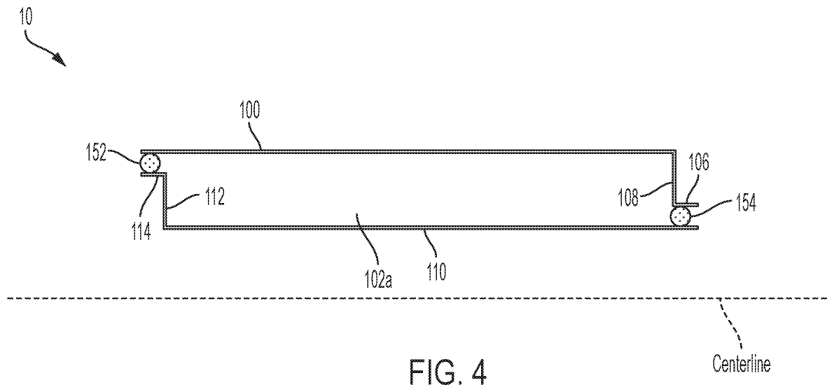

FIG. 4 provides a further depiction of an embodiment of the disclosed technology, in this case a sealed version of FIG. 1. More specifically, the depicted component includes a first wall 100. The first wall can include a projection portion 108, which can optionally project perpendicular from the main portion, though this is not a requirement. The first wall can also include a land portion 106, which land portion can be sealed to second wall 110 by way of sealant 154. Second wall 110 can also include projection portion 112, which can optionally project perpendicular from second wall 110. Second wall 110 can also include land portion 114, which can be sealed to first wall 100 by way of sealant 152. A parallel to the major axis of the space defined between first wall 100 and second wall 110 can be drawn. In some embodiments, such a parallel line does not intersect the seals between the first wall and the second wall at lands 106 and 114. Wall 100 and wall 110 can define a space/volume 102a therebetween.

Although the attached figures show in some cases that the spaces/vents between walls are open, it should be understood that any and all of these vents can be sealed.

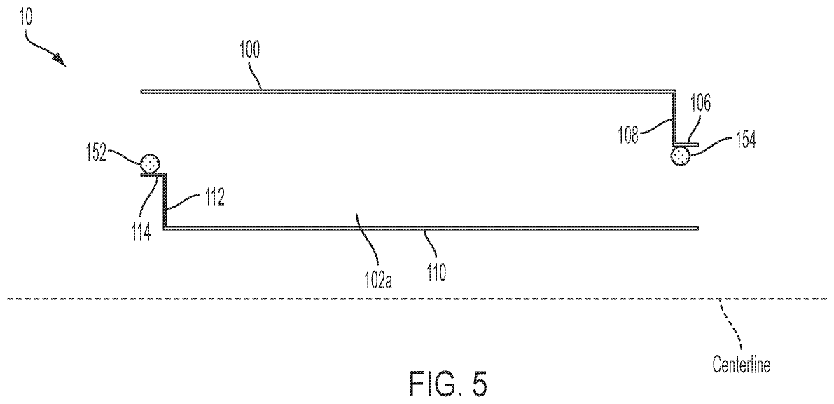

FIG. 5 provides a further depiction of an embodiment of the disclosed technology, in this case a version of the component of FIG. 5 that is not fully assembled. More specifically, the depicted component includes a first wall 100. The first wall can include a projection portion 108, which can optionally project perpendicular from the main portion, though this is not a requirement. The first wall can also include a land portion 106, which land portion can be sealed to second wall 110 by way of sealant 154. Second wall 110 can also include projection portion 112, which can optionally project perpendicular from second wall 110. Second wall 110 can also include land portion 114, which can be sealed to first wall 100 by way of sealant 152. A parallel to the major axis of the space defined between first wall 100 and second wall 110 can be drawn. In some embodiments, such a parallel line does not intersect the seals between the first wall and the second wall at lands 106 and 114. Wall 100 and wall 110 can define a space/volume 102a therebetween.

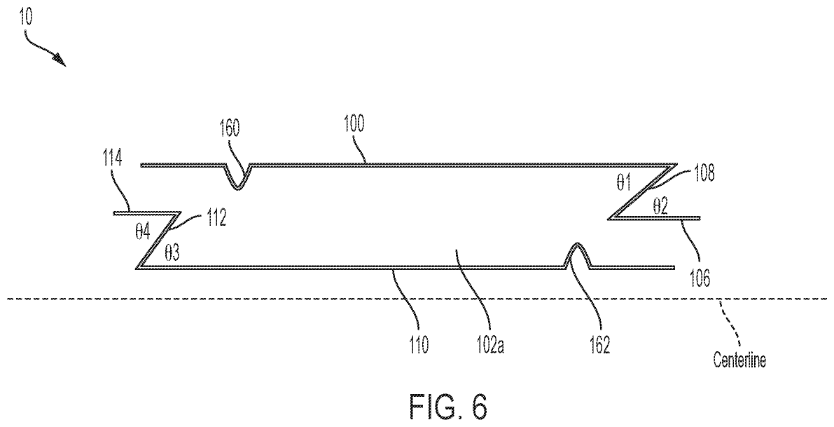

FIG. 6 provides a further depiction of an embodiment of the disclosed technology. As shown, the depicted component includes a first wall 100. The first wall can include a projection portion 108, which can project at an angle θ1 from first wall 100. The angle θ1 can be from about 90 degees to about 1 degree, i.e., with projection portion 108 angled back over wall 100. Land 106 can extend from projection portion 108, as shown. Land 106 can be at an angle θ2 from projection portion 108, which angle can be from about 1 to about 180 degrees, including all intermediate values and ranges of values. As shown, land 106 and wall 110 can define an opening or vent therebetween. Wall 100 can include feature 160, which feature can be, e.g., a ridge, a bump, a ring, and the like.

Without being bound by any particular theory, such a feature can act to impede the movement of molecules within the space defined between wall 100 and wall 110. Wall 110 can include a feature 162, which feature can be, e.g., a ridge, a bump, a ring, and the like. Without being bound by any particular theory, such a feature can act to impede the movement of molecules within the space defined between wall 100 and wall 110. Wall 110 can include a projection portion 112, which can project at an angle θ3 from second wall 110. Angle θ3 can be from about 90 degrees to about 1 degree, i.e. with projection portion 112 angled back over second wall 110. Second wall 110 can also include land 106. Land 106 can project at an angle θ4 from projection portion 112, which angle can be from about 1 to about 180 degrees, including all intermediate values and ranges of values. As shown, wall 100 and land 114 can define an opening (or vent) therebetween. Wall 100 and wall 110 can define a space/volume 102a therebetween.

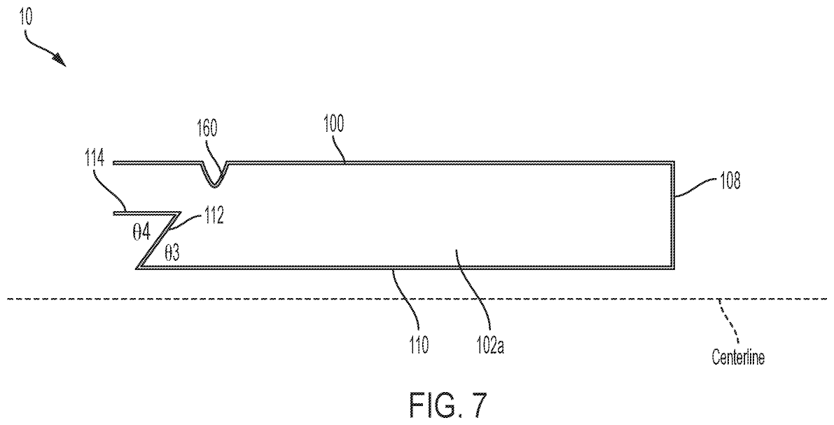

FIG. 7 provides a further depiction of an embodiment of the disclosed technology. As shown, the depicted component includes a first wall 100. The first wall can include a projection portion 108. Wall 100 can include feature 160, which feature can be, e.g., a ridge, a bump, a ring, and the like.

Without being bound by any particular theory, such a feature can act to impede the movement of molecules within the space defined between wall 100 and wall 110. Wall 110 can include a feature 162, which feature can be, e.g., a ridge, a bump, a ring, and the like.

Without being bound by any particular theory, such a feature can act to impede the movement of molecules within the space defined between wall 100 and wall 110. Wall 110 can include a projection portion 112, which can project at an angle θ3 from second wall 110. Angle θ3 can be from about 90 degrees to about 1 degree, i.e. with projection portion 112 angled back over second wall 110. Second wall 110 can also include land 106. Land 106 can project at an angle θ4 from projection portion 112, which angle can be from about 1 to about 180 degrees, including all intermediate values and ranges of values. Wall 100 and wall 110 can define a space/volume 102a therebetween.

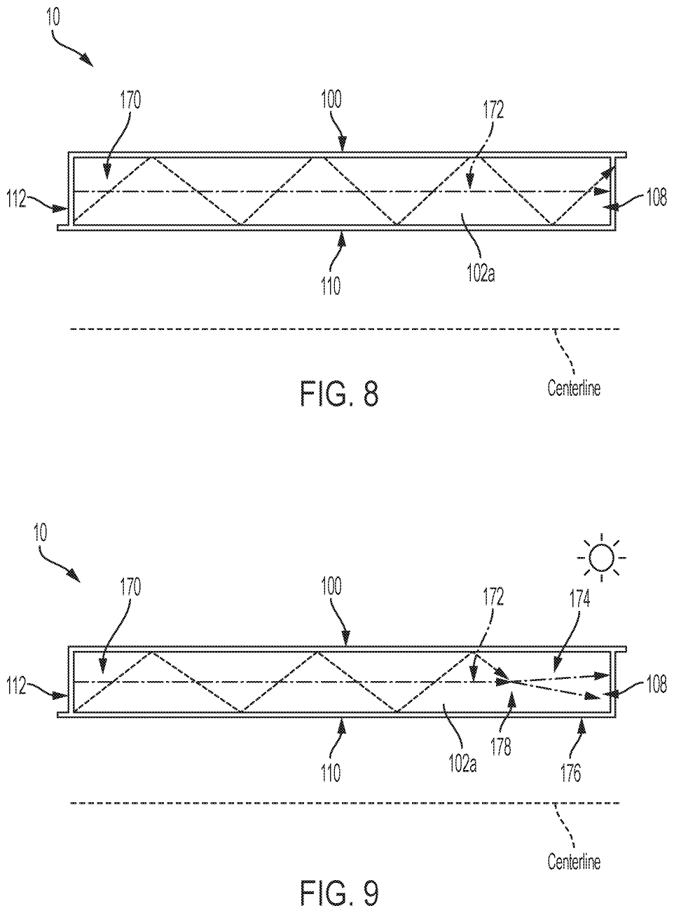

FIG. 8 provides a further depiction of an embodiment of the disclosed technology. As shown, the depicted component includes a first wall 100. The first wall can include a projection portion 108. Wall 110 can include a projection portion 112. As shown, path 170 shows the zig-zag path that is taken by a molecule that impacts first wall 100 and second wall 110, with centerline 172 being used to show the path of a molecule that travels roughly along the centerline of the component. Wall 100 and wall 110 can define a space/volume 102a therebetween.

FIG. 9 provides a further depiction of an embodiment of the disclosed technology. As shown, the depicted component includes a first wall 100. The first wall can include a projection portion 108. Wall 110 can include a projection portion 112. As shown, path 170 shows the zig-zag path that is taken by a molecule that impacts first wall 100 and second wall 110, with centerline 172 being used to show the path of a molecule that travels roughly along the centerline of the component.

As shown, path 170 and path 172 intersect when the paths' respective molecules collide at location 178, and, as shown, the colliding molecules' paths are changed by the collision, with path 172 being deflected slightly upward along trajectory 174, and with path 170 being deflected to path 176. Wall 100 and wall 110 can define a space/volume 102a therebetween.

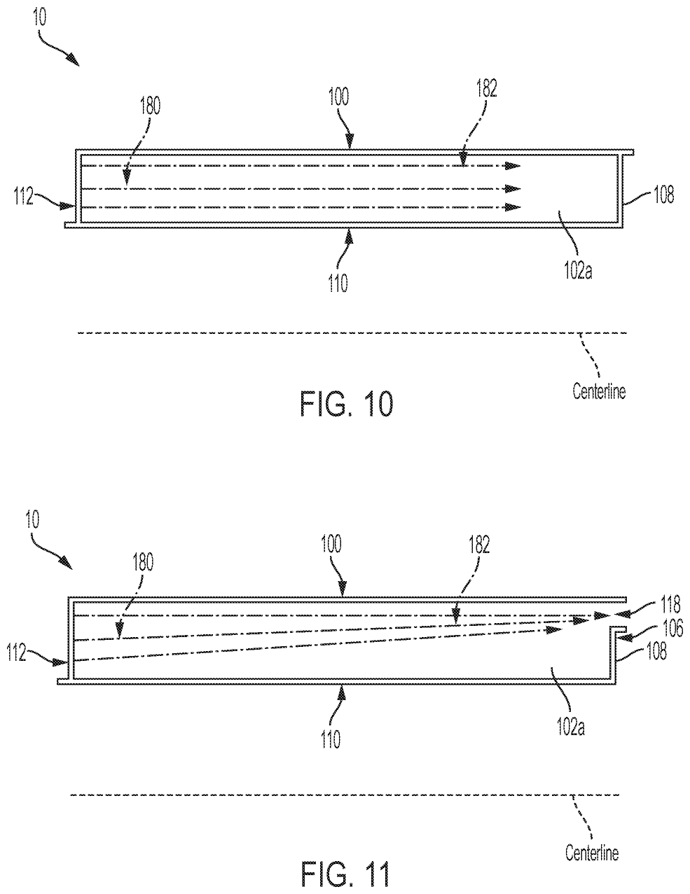

FIG. 10 provides a further depiction of an embodiment of the disclosed technology. As shown, the depicted component includes a first wall 100. The first wall can include a projection portion 108. Wall 110 can include a projection portion 112. As shown, paths 180 and 182 show the linear, parallel paths taken by molecules within the volume defined between wall 100 and wall 110.

As shown, the parallel molecular paths do not intersect one another, and because there is no exit from the volume, the molecules remain on their paths. Wall 100 and wall 110 can define a space/volume 102a therebetween.

FIG. 11 provides a further depiction of an embodiment of the disclosed technology. As shown, the depicted component includes a first wall 100. The first wall can include a projection portion 108. Wall 110 can include a projection portion 112. As shown, paths 180 and 182 now point toward vent 118, which vent is defined between land 106 and first wall 100. Wall 100 and wall 110 can define a space/volume 102a therebetween.

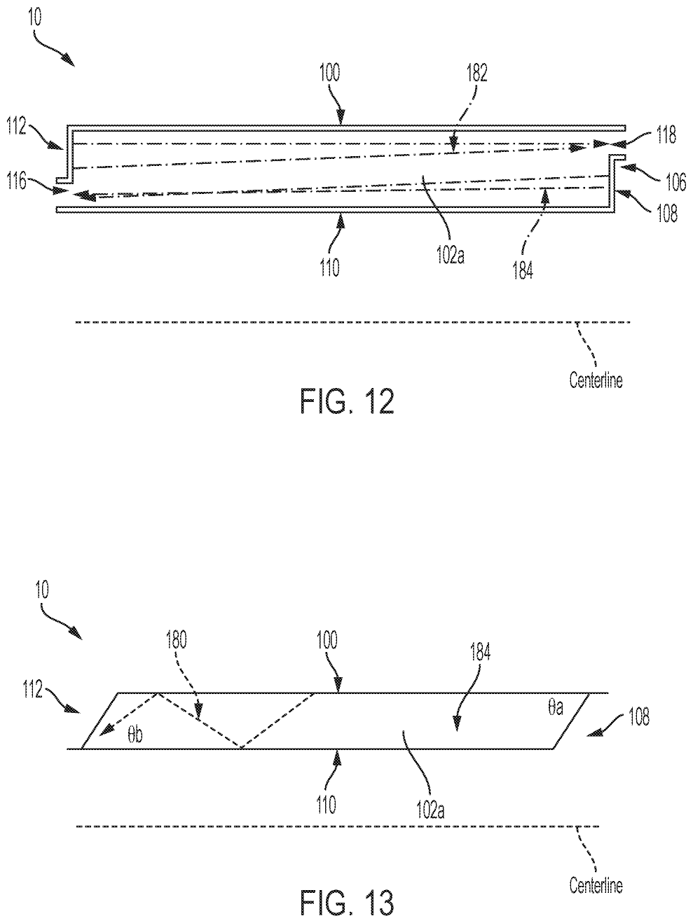

FIG. 12 provides a further depiction of an embodiment of the disclosed technology. As shown, the depicted component includes a first wall 100. The first wall can include a projection portion 108. Wall 110 can include a projection portion 112. As shown, paths 180 and 182 now point toward vent 118, which vent is defined between land 106 and first wall 100.

A second vent 116 is defined between the land (not shown) of first wall 100 and the second wall 110, and a first vent is defined between land 106 of second wall 110 and first wall 100. Wall 100 and wall 110 can define a space/volume 102a therebetween.

FIG. 13 provides a further depiction of an embodiment of the disclosed technology. More specifically, the depicted component includes a first wall 100. The first wall can include a projection portion 108, which can project at an angle θa from the main portion of the first wall. The angle θa can be from about 1 to about 180 degrees, and all values and ranges therein.

Wall 110 can include a projection portion 112, which can project at an angle θb from second wall 110. The angle θb can be from about 1 to about 180 degrees. Without being bound to any particular theory, angle θa and angle θb can be selected such that projection portions 108 and 112 act to deflect molecules moving within the space defined between wall 100 and wall 110 toward a vent located opposite the projection portion. Wall 100 and wall 110 can define a space/volume 102a therebetween.

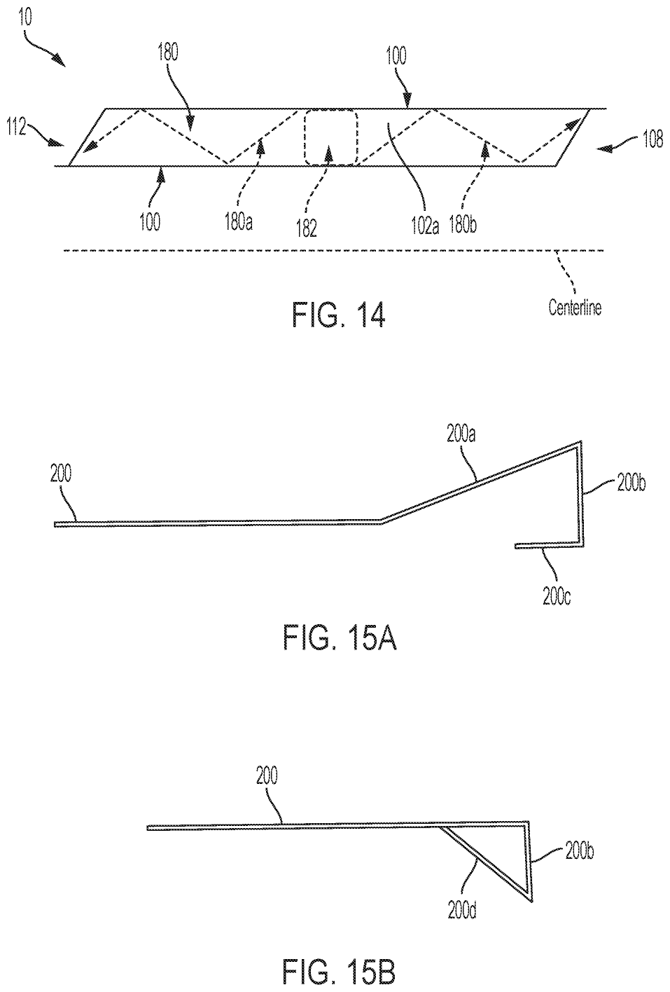

FIG. 14 provides a further depiction of an embodiment of the disclosed technology. More specifically, the depicted component includes a first wall 100. The first wall can include a projection portion 108, which can project at an angle θa (not shown) from the main portion of first wall. The angle θa can be from about 1 to about 180 degrees, and all values and ranges therein.

Wall 110 can include a projection portion 112, which can project at an angle θb from second wall 110. The angle θb can be from about 1 to about 180 degrees. Without being bound to any particular theory, angle θa and angle θb can be selected such that projection portions 108 and 112 act to deflect molecules moving within the space defined between wall 100 and wall 110 toward a vent located opposite the projection portion.

As shown, a molecule following path 180a can be directed to a vent that is at least partially defined by projection portion 108 or 112. Likewise, a molecule following path 180b can be directed to a vent that is at least partially defined by projection portion 108 or 112. Region 182 is shown to illustrate the region of “dead space” that is not most efficiently evacuated when using traditional techniques to evacuate sealed volumes. Wall 100 and wall 110 can define a space/volume 102a therebetween.

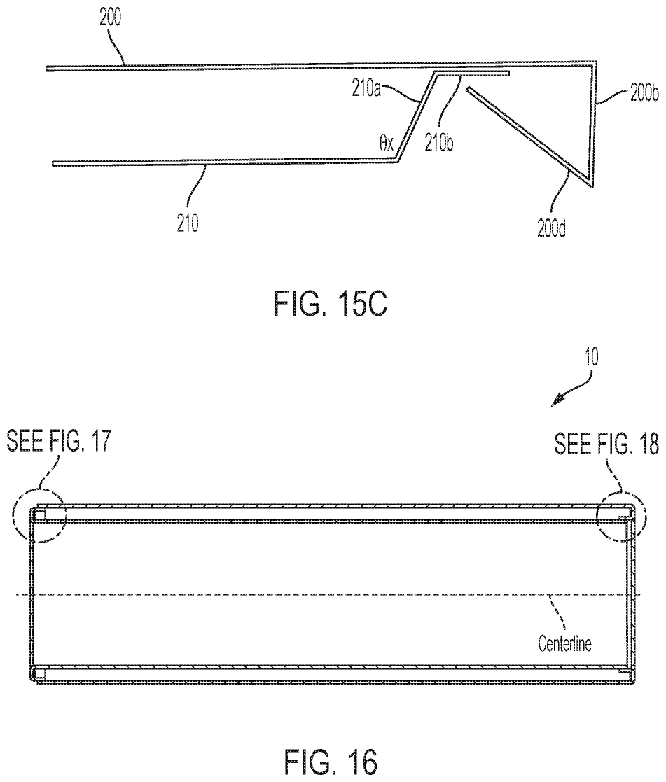

FIGS. 15A, 15B, and 15C provide depictions of various wall embodiments. As shown in FIG. 15A, wall 200 can include a first diverging portion 200a, which can flare outwards at an end of the wall. The wall can also include end portion 200b, which portion can taper inwards from diverging portion 200a. The wall can also include curl portion 200c, which can curl back from end portion 200b.

FIG. 15B provides a depiction of a wall embodiment. As shown wall 200 includes an end portion 200b and a curl portion 200d, which curl portion curls back (e.g., via pinching) against wall 200.

FIG. 15C provides a further depiction of a wall embodiments. As shown, wall 200 includes end portion 200b and curl portion 200d. Second wall 210 includes flare portion 210a that flares outward at angle θx from wall 210. (Angle θx can be from 1 to 180 degrees, but is preferably about 90 degrees.

As shown, wall 210 can include seal portion 210b, which can be inserted into a space between wall 200 and curl portion 200d, following which curl portion 200d can be pinched or otherwise exerted against seal portion 210a to make a sealed space defined between wall 200 and wall 210. Without being bound to any particular embodiment, walls 200 and 210 can be friction-fit against one another. In one such embodiment, wall 210 can exert a spring-back against curl portion 200d.

FIG. 16 provides a cutaway view of a component, comprising a sealed annular space, according to the present disclosure.

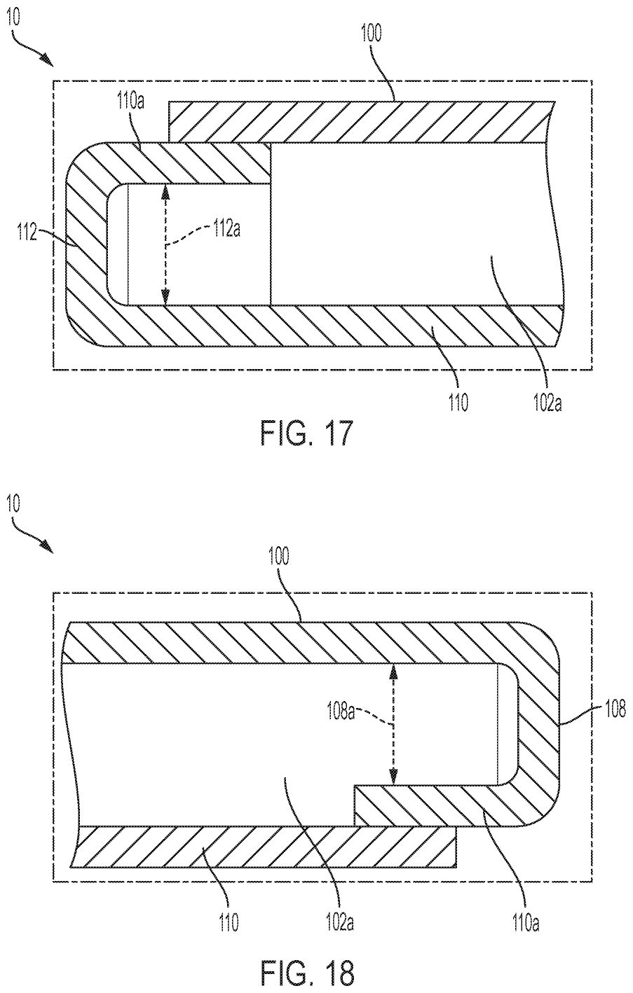

FIG. 17 provides a cutaway close up of region “B” from FIG. 16. As shown, first wall 100 can be sealed to curl portion 110a of second wall 110; curl portion 110a suitably extends from end portion 112. Height 112a can be defined between curl portion 110a and wall 110. Height 112a is suitably from about 1:1000 to about 1:2 of the length of the space 102a defined between walls 100 and 110.

In some embodiments, curl portion 110a can exert a springback against wall 100. In other embodiments, wall 100 can exert a compression against curl portion 110a, e.g., when the inner diameter of wall 100 is less than the outer diameter of curl portion 110a.

FIG. 18 provides a cutaway close up of region “C” from FIG. 16. As shown, first wall 100 can include projection 108 and curl portion 110a, which can also be termed a “land.” Wall 110 is suitably sealed to curl portion 108a. Height 108a can be defined between curl portion 108a and wall 110. Height 108a is suitably from about 1:1000 to about 1:2 of the length of the space 102a defined between walls 100 and 110.

In some embodiments, curl portion 110a can exert a springback against wall 110. In other embodiments, wall 110 can exert a compression against curl portion 110a, e.g., when the inner diameter of wall 100 is less than the outer diameter of curl portion 110a.

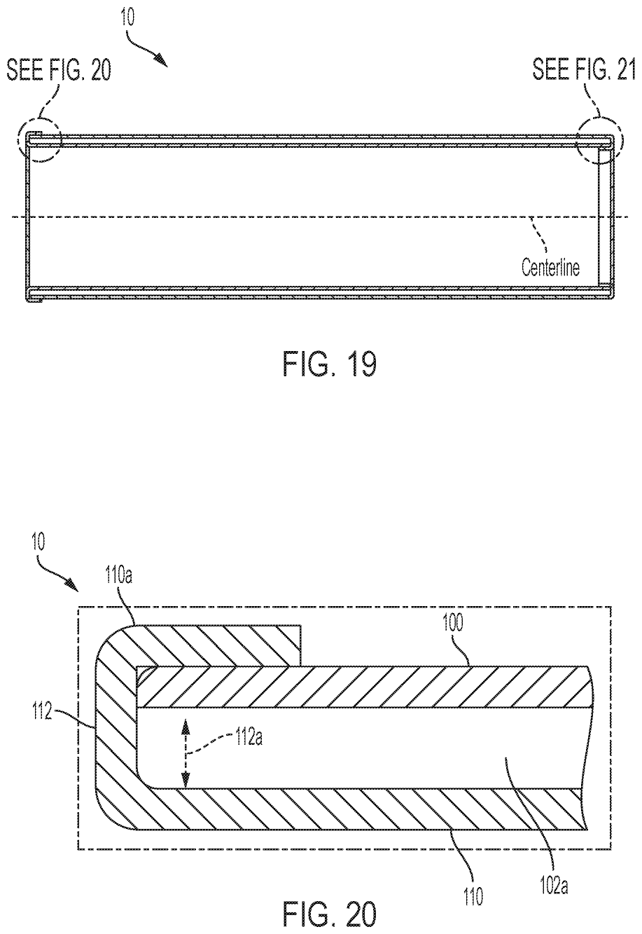

FIG. 19 provides a cutaway view of a component, comprising a sealed annular space, according to the present disclosure.

FIG. 20 provides a cutaway close up of region “E” from FIG. 19. As shown, first wall 100 can be sealed to curl portion 110a of second wall 110; curl portion 110a suitably extends from end portion 112.

Height 112a can be defined between curl portion 110a and wall 110. Height 112a is suitably from about 1:1000 to about 1:2 of the length of the space 102a defined between walls 100 and 110.

In some embodiments, wall 100 can springback against curl portion 110a. In other embodiments, curl portion 110a can exert a compression against wall 100, e.g., when the inner diameter of curl portion 110a less than the outer diameter of wall 100.

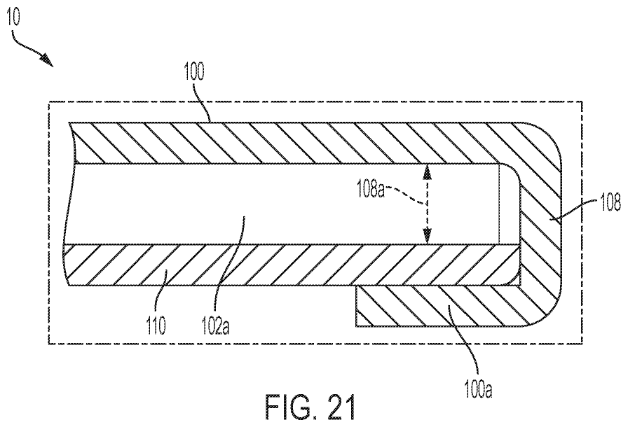

FIG. 21 provides a cutaway close up of region “F” from FIG. 16. As shown, first wall 100 can include projection 108 and curl portion 110a, which can also be termed a “land.” Wall 110 is suitably sealed to curl portion 108a. Height 108a can be defined between curl portion 108a and wall 110. Height 108a is suitably from about 1:1000 to about 1:2 of the length of the space 102a defined between walls 100 and 110.

In some embodiments, wall 110 can spring back against curl portion 100a. In other embodiments, curl portion 100a can exert a compression against wall 110, e.g., when the inner diameter of curl portion 100a is less than the outer diameter of wall 110.

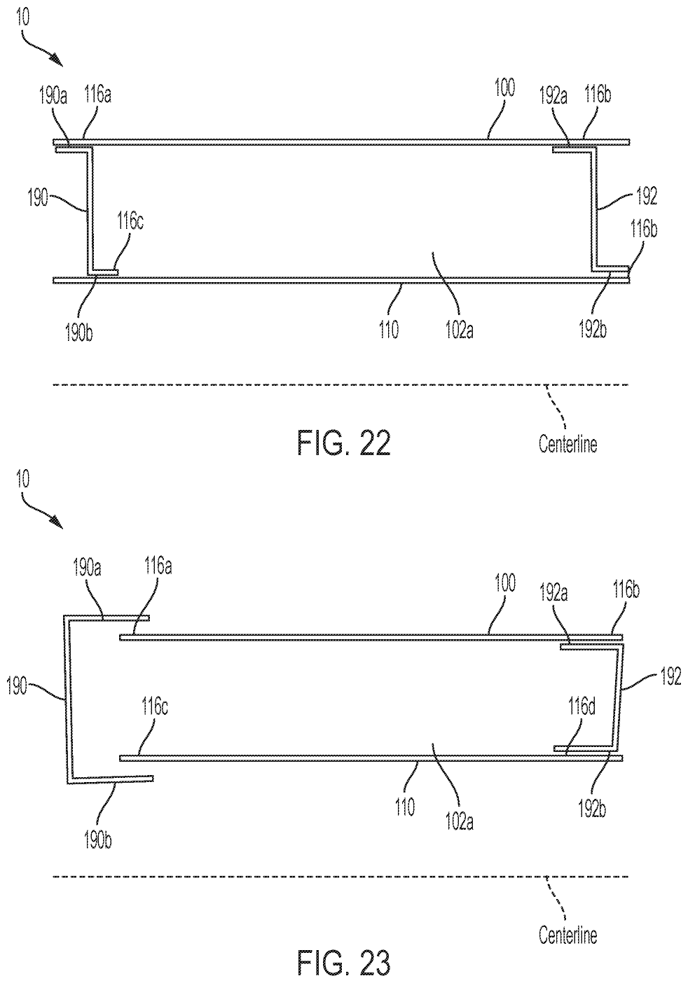

FIG. 22 provides a cutaway view of a component according to the present disclosure. As shown, walls 100 and 110 define a space 102a therebetween. A first cap 190 can include lands 190a and 190b. Lands 190a and 190b can be sealed, respectively, to wall 100 and wall 110.

As shown in FIG. 22, first cap 190 defines a height that is less than or about equal to the distance between walls 100 and 110. As shown in FIG. 22, lands 190a and 190b can extend in opposite directions, relative to one another. A component can include a second cap 192, which second cap can include lands 192a and 192b. Lands 192a and 192b can be sealed, respectively, to walls 100 and 110.

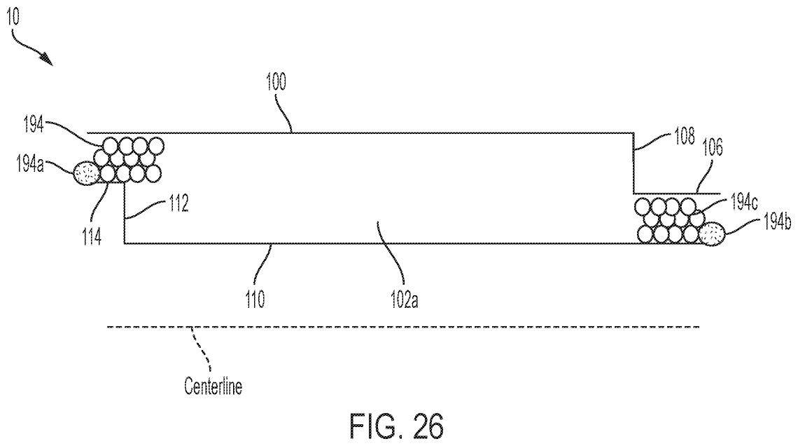

Sealing can be effected by various techniques known in the art, including, e.g., brazing, adhesives, welding, sonic welding, and the like. Sealing can be effected by, e.g., processing a circumferential ribbon of braze material. Sealing can also be effected by processing an amount of sealing material (e.g., braze material) has been disposed within a porous support material, e.g., a porous ceramic. Sealing material can be heated to as to at least partially soften or even liquefy. In its softened/liquefied form, the sealing material can be drawn into the porous support material, e.g., by wicking and/or capillary action. Sealing material can also be drawn and/or forced into the support material by application of a pressure gradient that effects movement of the sealing material into the support material. An example of this is found in non-limiting FIGS. 26-28.

As shown, lands 192a and 192b can extend in opposite directions, relative to one another. Space 102a can be at or below ambient pressure. Also as shown in FIG. 22, lands 190a, 190b, 192a, and 192b can be overlapped by one or both of walls 100 and 110. As shown in FIG. 22, land 190a defines a vent with wall 100, land 190b defines a vent with wall 110, land 192a defines a vent with wall 100, and land 192b defines a vent with wall 110.

The vents can be sealed simultaneously, but can also be sealed in a sequence. As one example, a user can first seal the vents defined by land 190a and wall 100 and land 192b and wall 110. In this way, the vents defined by land 190b and wall 100 and land 192a and wall 100 remain open and positioned diagonally (within space 102a) across from one another. It should be understood that either or both of caps 190 and 192 can be friction-fit against one or both of walls 100 and 110.

Without being bound to any particular theory, the configuration in FIG. 22 (and in other disclosed embodiments) allows for multiple avenues by which molecules present in the space 102a between the walls (e.g., 100 and 110) can transit out of that space. As shown, vent 116a is formed with wall 100 and land 190a of cap 190, vent 116c is formed with wall 110 and land 190b of cap 190, vent 116b is formed with wall 100 and land 192a of cap 192, and vent 116d is formed by land 192b and wall 110. In this way, molecules present in the space 102a have multiple avenues for egress.

FIG. 23 provides a cutaway view of a component according to the present disclosure. As shown, walls 100 and 110 define a space 102a therebetween. A first cap 190 can include lands 190a and 190b. Lands 190a and 190b can be sealed, respectively, to wall 100 and wall 110. As shown in FIG. 2, first cap 190 defines a height that is less than or about equal to the distance between walls 100 and 110.

It should be understood that cap 190 can include (as shown) a flat portion that connects lands 190a and 190b. It should be understood, however, that lands 190a and 190b can be connected by a curved portion, which curved portion can be concave or even convex. Cap 190 can be U-shaped, in some embodiments. As shown, the shape of cap 190 can be a flat-bottomed U. As an example, the U can have two 90-degree corners.

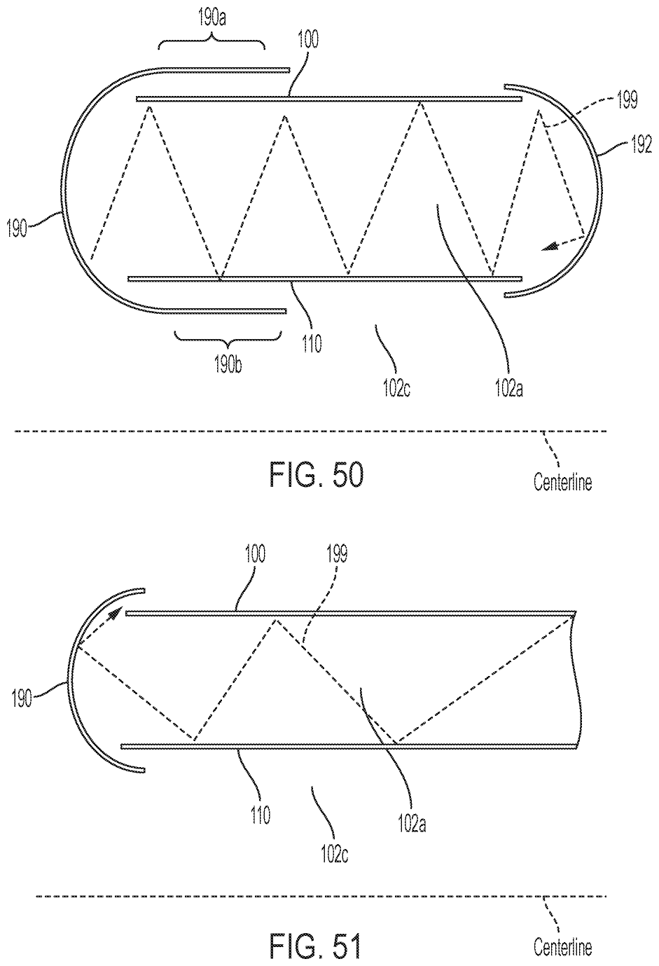

A flat-bottomed U, however, is not a requirement. As shown in FIG. 50, a cap (190) can be U-shaped. A cap can include—though it does not have to—first land 190a and second land 190b. (As shown in FIG. 50, cap 192 can be curved and be free of lands.)

As shown in FIG. 23, lands 190a and 190b can extend in or about in the same direction, relative to one another. A component can include a second cap 192, which second cap can include lands 192a and 192b. Lands 192a and 192b can be sealed, respectively, to walls 100 and 110.

As shown in FIG. 23, cap 192 can define a height that is less than or about equal to the distance between walls 100 and 110. Sealing can be effected by various techniques known in the art, including, e.g., brazing, adhesives, welding, sonic welding, and the like. Cap 190 can be constructed such that lands 190a and 190b overlap the exterior of walls 100 and 110.

As shown, lands 192a and 192b can extend in or about in the same direction, relative to one another. Space 102a can be at or below ambient pressure. As shown in FIG. 23, one or both of caps 190 and 192 can be convex relative to space 102a.

Also as shown in FIG. 23, lands 190a, 190b, 192a, and 192b can be overlapped by one or both of walls 100 and 110. As shown in FIG. 23, land 190a defines a vent with wall 100, land 190b defines a vent with wall 110, land 192a defines a vent with wall 100, and land 192b defines a vent with wall 110. The vents can be sealed simultaneously, but can also be sealed in a sequence. As one example, a user can first seal the vents defined by land 190a and wall 100 and land 192b and wall 110. In this way, the vents defined by land 190b and wall 100 and land 192a and wall 100 remain open and positioned diagonally (within space 102a) across from one another. It should be understood that either or both of caps 190 and 192 can be friction-fit against one or both of walls 100 and 110. As shown in FIG. 23, a portion of a cap (e.g., a land) can be disposed within the space between the walls, as shown by cap 192 in FIG. 23. Alternatively, a portion of a cap (e.g., a land) can be disposed outside the space between the walls, as shown by cap 190 in FIG. 23.

Without being bound to any particular theory, the configuration in FIG. 23 (and in other disclosed embodiments) allows for multiple avenues by which molecules present in the space 102a between the walls (e.g., 100 and 110) can transit out of that space. As shown, vent 116a is formed with wall 100 and land 190a of cap 190, vent 116c is formed with wall 110 and land 190b of cap 190, vent 116b is formed with wall 100 and land 192a of cap 192, and vent 116d is formed by land 192b and wall 110. In this way, molecules present in the space 102a have multiple avenues for egress. As further shown by FIG. 23, space 102a can be sealed by two caps, though this is not a requirement, as a space can be sealed at one end by a cap and at the other end by walls being sealed to on another.

A cap can be toroidal (e.g., a partial toroid) in configuration. As one example, a cap can be the upper half of a toroid, such as the shape of a doughnut that has been sliced along its equator. A cap can have the shape of a toroid formed by revolving a shape (e.g., a circle, an oval, a rectangle, a square, a triangle, a pentagon, a hexagon, or other polygon or other shape) around an axis and then taking a portion of that toroid (e.g., the shape formed by slicing the toroid along a plane orthogonal to the axis extending through the hole of the toroid, such as the upper half of a doughnut that has been sliced along its equator) as the cap. A cap can comprise one or more corners (e.g., in the case of a cap having the form of the upper half of a toroid made from a rectangle that has been revolved about an axis), but this is not a requirement. Thus, a cap can have the configuration that results from revolving an open curve (e.g., a C-shaped curve, a V-shaped curve, and the like) about an axis.

A cap can comprise one or more curves, e.g., in the case of a cap having the form of the upper half of a toroid formed by revolving a circle about an axis. A cap can also comprise a curve and a corner.

As shown in FIG. 23, cap 190 is shown such it is sealable to the outer surface of wall 100 and to the inner surface of wall 110. This is not a requirement, as cap 190 can be sealable to the outer surface of wall 100 and the outer surface of wall 110, or sealable to the inner surface of wall 100 and the outer surface of wall 110, or sealable to the inner surface of wall 100 and to the inner surface of wall 110.

Likewise, 192 is shown such it is sealable to the inner surface of wall 100 and to the outer surface of wall 110. This is not a requirement, as cap 192 can be sealable to the inner surface of wall 100 and the inner surface of wall 110, or sealable to the outer surface of wall 100 and the outer surface of wall 110, or sealable to the outer surface of wall 100 and to the inner surface of wall 110. Space 102 can be sealed by caps that are sealed to the same surfaces of the walls that define the space (e.g., both caps are sealed to the outer surface of the outer wall and sealed to the inner surface of the inner wall), but this, too, is not a requirement. As an example, a space can be sealed by a cap that is sealed to the outer surface of the outer wall and the inner surface of the inner wall and by a cap that is sealed to the inner surface of the outer wall and the outer surface of the inner wall.

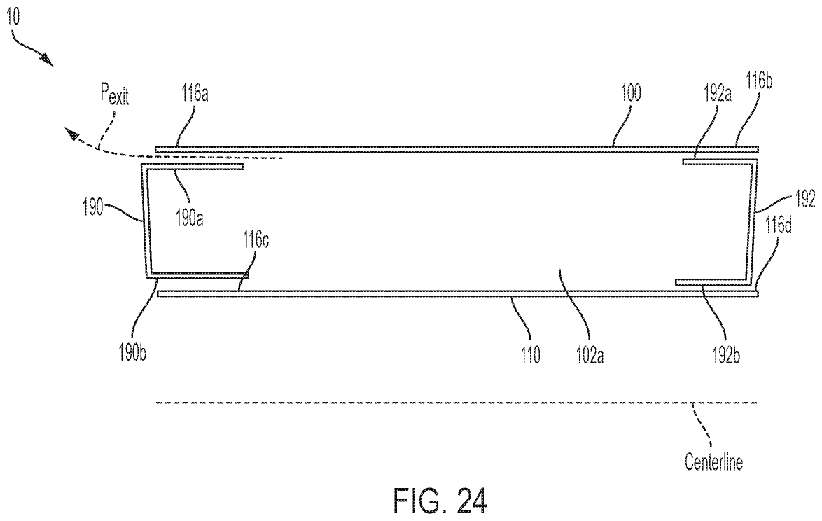

FIG. 24 provides a cutaway view of a component according to the present disclosure. As shown, walls 100 and 110 define a space 102a therebetween. A first cap 190 can include lands 190a and 190b. Lands 190a and 190b can be sealed, respectively, to wall 100 and wall 110.

As shown in FIG. 24, first cap 190 defines a height that is less than or about equal to the distance between walls 100 and 110. As shown in FIG. 24, lands 190a and 190b can extend in or about in the same direction, relative to one another. A component can include a second cap 192, which second cap can include lands 192a and 192b. Lands 192a and 192b can be sealed, respectively, to walls 100 and 110.

As shown in FIG. 24, first cap 190 can define a height that is less than or about equal to the distance between walls 100 and 110. Sealing can be effected by various techniques known in the art, including, e.g., brazing, adhesives, welding, sonic welding, and the like.

As shown, lands 192a and 192b can extend in or about in the same direction, relative to one another. Space 102a can be at or below ambient pressure. As shown in FIG. 24, one or both of caps 190 and 192 can be convex relative to space 102a. Also as shown in FIG. 24, a land and a wall (e.g., land 190a and wall 100) can be arranged such that the land overlaps the wall, rather than the wall (e.g., land 190b and wall 110) overlapping the land.

It should be understood that either or both of caps 190 and 192 can be friction-fit against one or both of walls 100 and 110.

Without being bound to any particular theory, the configuration in FIG. 22 (and in other disclosed embodiments) allows for multiple avenues by which molecules present in the space 102a between the walls (e.g., 100 and 110) can transit out of that space. As shown, vent 116a is formed with (i.e., between) wall 100 and land 190a of cap 190, vent 116c is formed with wall 110 and land 190b of cap 190, vent 116b is formed with wall 100 and land 192a of cap 192, and vent 116d is formed by land 192b and wall 110. In this way, molecules present in the space 102a have multiple avenues for egress.

As shown in FIG. 24, molecules that exit space 102a can follow an exit path shown by Pₑₓᵢₜ. As shown, the exit path is toward or in the direction of the end of wall 100 and away from the end of land 190a. Although this path is shown in the context of FIG. 24, it should be understood that the illustration with FIG. 24 is illustrative, and that the present disclosure contemplates such an exit path (i.e., in a direction toward the end of one wall (or land) of a component and away from the end of another wall (or land) of the component.

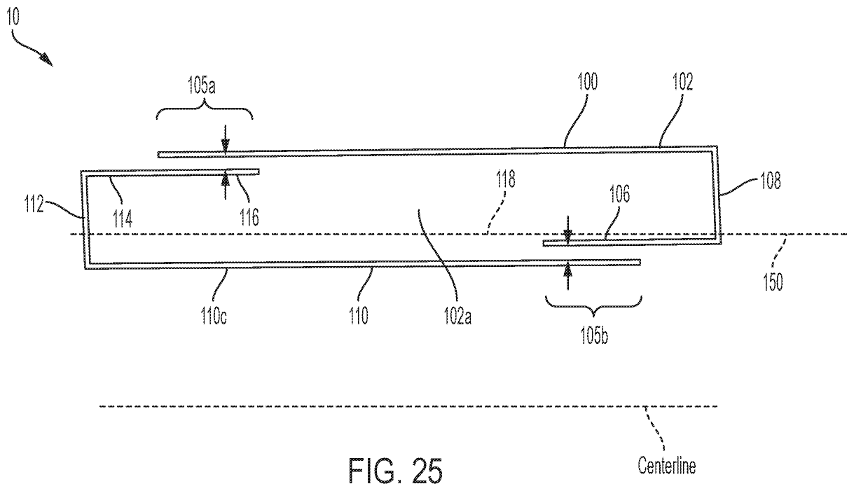

FIG. 25 provides an exemplary depiction of a component 10 according to the present disclosure. As shown, component 10 includes first wall 100, which first wall can define a main portion 102. The first wall can include a projection portion 108, which can optionally project perpendicular from the main portion, though this is not a requirement. Projection portion can define a length 104. The first wall can also include a land portion 106, which land portion can extend in the same direction as main portion 102. As shown, vent 118 can be defined between land portion 106 and second wall 110. Land 106 can also overlap by a distance 105b with second wall 110.

As shown, vent 118 can be disposed at a distance from projection portion 108, i.e., vent 118 need not be at the end of the component and can be located at essentially any location along wall 110.

Second wall 110 can include a main portion 110c. Second wall 110 can also include projection portion 112, which can optionally project perpendicular from second wall 110. Second wall 110 can also include land portion 114; as shown, land portion 114 can extend in the same direction as main portion 110c. A second vent 116 can be defined between the first wall and the second wall.

Land 114 can also overlap by a distance 105a with first wall 100. As shown, a line 150 that is parallel to the major axis of the space defined between first wall 100 and second wall 110 can be drawn.

In some embodiments, such a parallel line does not intersect both first vent 116 and second vent 118. Wall 100 and wall 110 can define a space/volume 102a therebetween. As shown, vent 116 can be disposed at a distance from projection portion 112, i.e., vent 118 need not be at an end of the component and can be located at essentially any location along wall 100.

It should be understood that a component according to the present disclosure can include only one vent, although multiple vents can also be used. It should also be understood that vents can be sealed via techniques known to those of ordinary skill in the art, e.g., brazing, welding, adhesive, and the like. Without being bound to any particular theory, by locating a vent further from an end of the component and closer to a midpoint of the component, one can more effectively evacuate the space defined between the walls of the component because it can be easier to draw molecules closer to the vent. Without being bound to any particular embodiment, walls 100 and 110 can be friction fit against one another, e.g., where one or both of land 114 and wall 100 exerts against the other. Likewise, one or both of land portion 106 and wall 110 can exert against the other.

FIG. 26 provides a cutaway view of an exemplary component 10 according to the present disclosure, showing an illustrative wall configuration. As shown in FIG. 26, first wall 100 can include projection portion 108, which can optionally project perpendicular from wall 100, although this (optional perpendicular projection) is not a requirement. Wall 100 can also include land portion 106, which land portion can optionally project perpendicular from projection portion 108.

Second wall 110 can include include projection portion 112, which can optionally project perpendicular from wall 110, although this (optionally perpendicular projection) is not a requirement. Wall 110 can also include land portion 114, which land portion can optionally project perpendicular from projection portion 112. Walls 100 and 110 can define space/volume 102a therebetween.

As shown, material 194 can be disposed between wall 100 and land portion 114. The ceramic material can be in particulate form. Material 194 can be a ceramic material. Material 194 can also be in porous form, e.g., as a ribbon or ring of porous material. An amount 194a of braze material can be disposed adjacent to material 194. The braze material can be present as a ring, ribbon, or in other form. The braze material may be disposed circumferentially about some or all of the space (not labeled) between wall 100 and land portion 114.

As shown, material 194c can be disposed between wall 110 and land portion 106. The ceramic material can be in particulate form. Material 194c can be a ceramic material. Material 194c can also be in porous form, e.g., as a ribbon or ring of porous material. An amount 194b of braze material can be disposed adjacent to material 194c. The braze material can be present as a ring, ribbon, or in other form. The braze material may be disposed circumferentially about some or all of the space (not labeled) between wall 110 and land portion 106.

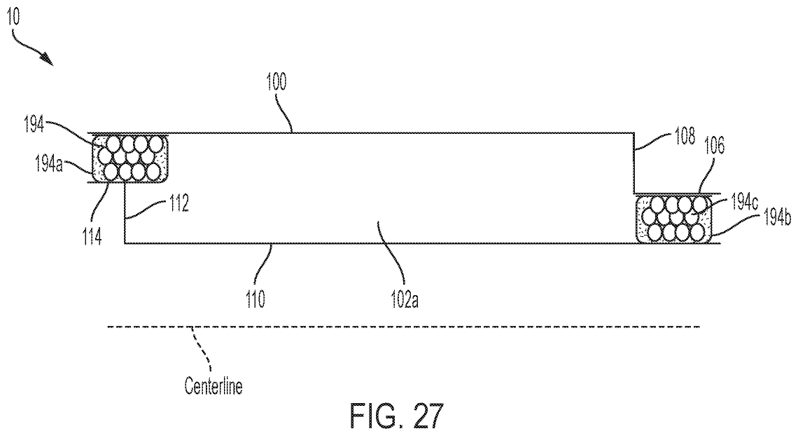

FIG. 27 provides a cutaway view of the component 10 shown in FIG. 26. As shown in FIG. 27, braze materials 194a and 194b have been processed (e.g., via heating) so as to become disposed within materials 194 and 194c. By reference to braze material 194a and material 194 (and also without being bound to any particular theory), braze material 194a can be heated to as to at least partially soften or even liquefy. In its softened/liquefied form, braze material 194a is drawn into material 194, e.g., by wicking and/or capillary action. Braze material 194a can also be drawn and/or forced into material 194 by application of a pressure gradient that effects movement of braze material 194a into material 194.

Again with reference to braze material 194a and material 194, after braze material 194a is disposed within material 194, braze material 194a (e.g., after re-hardening) acts to seal space 102a against the environment exterior to the component 12, as the braze material 194a fills in the spaces/voids within material 194a.

As a non-limiting example, braze material 194a can be selected such that it liquefies at a certain temperature TL. Component 10 can be heated in an environment that is at a temperature that is less than TL such that molecules disposed within space 102a become excited and exit space 102a. Following the exit of at least some of the molecules from space 102a, the temperature experienced by component 10 can be raised to a temperature about TL such that braze material 194a liquefies and becomes disposed within material 194.

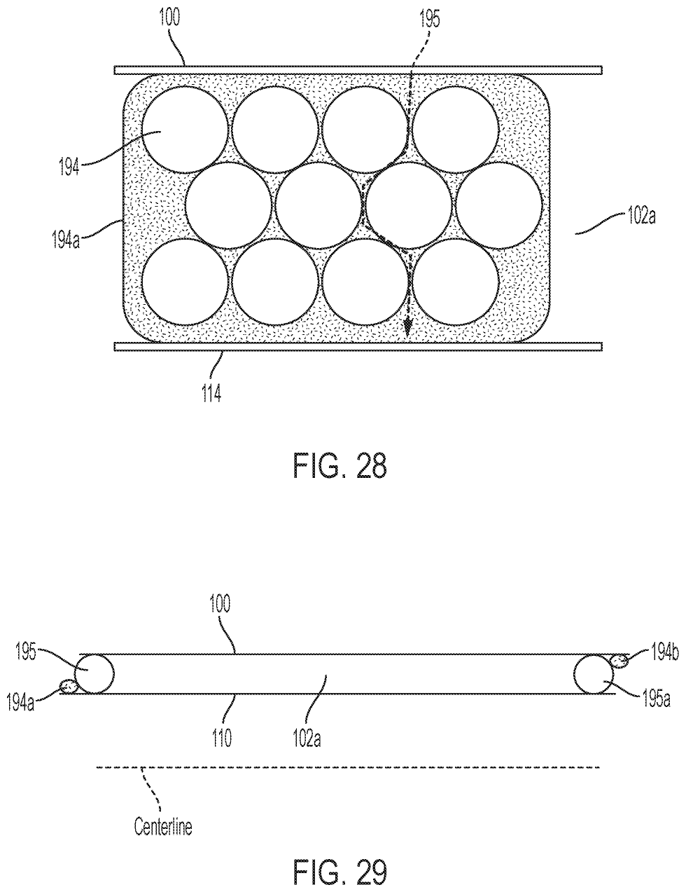

FIG. 28 provides a close-up cutaway view of a joint region of the exemplary component of FIGS. 26 and 27. As shown in FIG. 28, braze material 194a is disposed within material 194. In the exemplary embodiment of FIG. 28, material 194 is present as spheres, and braze material 194a has become disposed within the spaces between spheres. Also as shown in FIG. 28, the composite of braze material 194a and material 194 seals the space between wall 100 and land portion 114, so as to seal space 102a against the exterior environment.

Path 195 in FIG. 28 shows—without being bound to any particular theory—the pathway that heat would take between wall 100 and land portion 114. As shown, path 195 is tortuous and non-linear, as heat passing between wall 100 and land portion 114 cannot go directly through the relatively insulating material 194 and must instead travel within relatively conducting braze material 194. In this way, the relative insulating capability of the seal formed by braze material 194a and material 194 is greater (i.e., more insulating) than a seal that is formed entirely of braze material 194a. Without being bound by any particular theory, the disclosed approach acts to lengthen the pathway that heat must take to travel between wall 100 and land portion 114.

In addition, because some of the volume of the space between wall 100 and land portion 114 is occupied by material 194, a user can use relatively less braze material 194a to seal the space between wall 100 and land portion 114 than if there were no other material disposed in that space and the space were sealed with only braze material.

FIG. 29 provides a cutaway view of an exemplary component according to the present disclosure, showing an illustrative wall configuration. As shown in FIG. 29, walls 100 and 110 define a space 102a there between. By reference to the left side of the figure, a sealing material 195 can be disposed in the space between walls 100 and 110. The sealing material can be present in the form of a ring, e.g., a toroid. Although the cross-section of sealing material 195 is shown as circular, this is illustrative only, as the sealing material can be circular, ovoid, polygonal, or have some other cross-section. An amount 194a of braze material can be disposed adjacent to material 194. The braze material can be present as a ring, ribbon, or in other form. The braze material may be disposed circumferentially about some or all of the space (not labeled) between wall 100 and wall 110. Sealing material 195 can be sized so that it has a cross-sectional dimension (e.g., diameter) that is slightly less than the distance separating wall 100 and wall 110.

A sealing material can comprise a ceramic. A sealing material can be a material that has a lower thermal conductivity than a braze material used in a given component.

By reference to the right side of the figure, a sealing material 195a can be disposed in the space between walls 100 and 110. The sealing material can be present in the form of a ring, e.g., a toroid. Although the cross-section of sealing material 195a is shown as circular, this is illustrative only, as the sealing material can be circular, ovoid, polygonal, or have some other cross-section. An amount 194b of braze material can be disposed adjacent to material 195a. The braze material can be present as a ring, ribbon, or in other form. The braze material may be disposed circumferentially about some or all of the space (not labeled) between wall 100 and wall 110. Sealing material 195a can be sized so that it has a cross-sectional dimension (e.g., diameter) that is slightly less than the distance separating wall 100 and wall 110. Braze material 194a and 194b can be heated to a temperature such that the braze material enters and/or is encouraged into any spaces between sealing material 195 and 195a and walls 100 and 110. The braze material then solidifies, thereby forming a seal with sealing material 195 and 195a so as to seal space 102a against the exterior environment. (As described elsewhere herein, space 102a can be at least partially evacuated.)

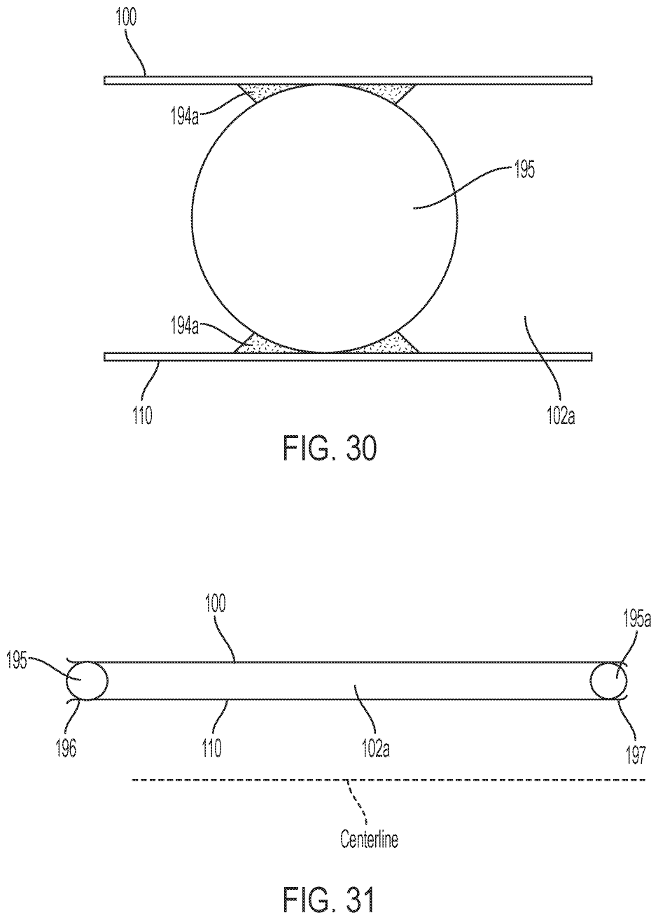

FIG. 30 provides a close-up cutaway view of a seal according to FIG. 30. As shown, braze material 194a has been disposed in the spaces between walls 100 and 110 and sealing material 195, so as to seal space 102a against the exterior environment. By using the disclosed approach, a user can form a seal between walls 100 and 110 that uses less braze material than if sealing material 195 were not present. Further, because sealing material 195 can be lower in thermal conductivity than braze material 194a, a seal formed according to the present disclosure will support less heat flow between walls 100 and 110 than a seal formed entirely of braze material. Further, a seal according to the present disclosure does not provide a complete path through (relatively conductive) braze material between walls 100 and 110. In this way, a seal according to the present disclosure can support less heat flow between walls 100 and 110 than a seal formed entirely of braze material.

FIG. 31 provides a cutaway view of an exemplary component according to the present disclosure, showing an illustrative wall configuration. By reference to the left side of the figure, sealing material 195 can be disposed in the space between walls 100 and 110. One or both of walls 100 and 110 can include a flared portion (e.g., flared portion 196 of wall 110), which flared portion can be adjacent to sealing material 195. Without being bound to any particular theory, a flared portion of a wall can provide a space into which a braze material (not shown) can more easily fit and flow into a space between the sealing material and the wall.

A wall can also include a curled portion (e.g., curled portion 197 of wall 110). The curled portion can at least partially enclose a sealing material, shown as 197 in FIG. 31. Without being bound to any particular theory, a curled portion can assist in maintaining a sealing material in position. Also without being bound to any particular theory, a curled portion can provide a space into which a braze material (not shown) can more easily fit and flow into a space between the sealing material and the wall.

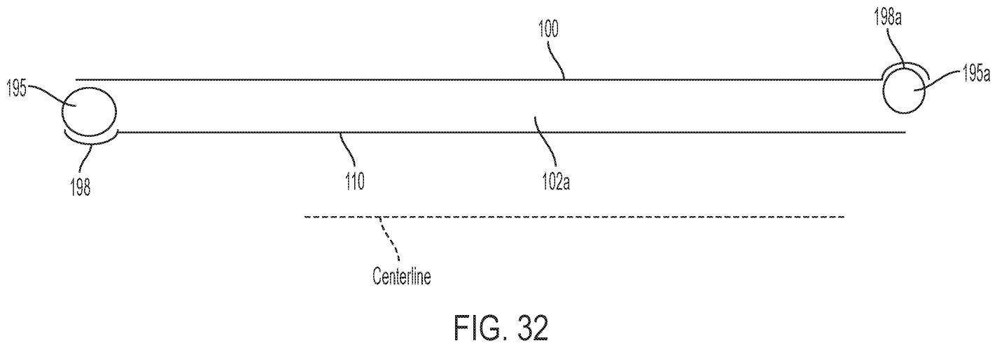

FIG. 32 provides a cutaway view of an exemplary component according to the present disclosure, showing an illustrative wall configuration. As shown, wall 110 can include a cupped portion 198, into which cupped portion sealing material 195 can fit. Wall 100 can also include a cupped portion 198a, into which cupped portion sealing material 195a can fit. Without being bound to any particular theory, a cupped portion can assist in positioning a sealing material and/or maintaining the sealing material in position. Brazing material (not shown) can be used to seal spaces between sealing material and adjacent walls, including spaces between a sealing material and a cupped portion.

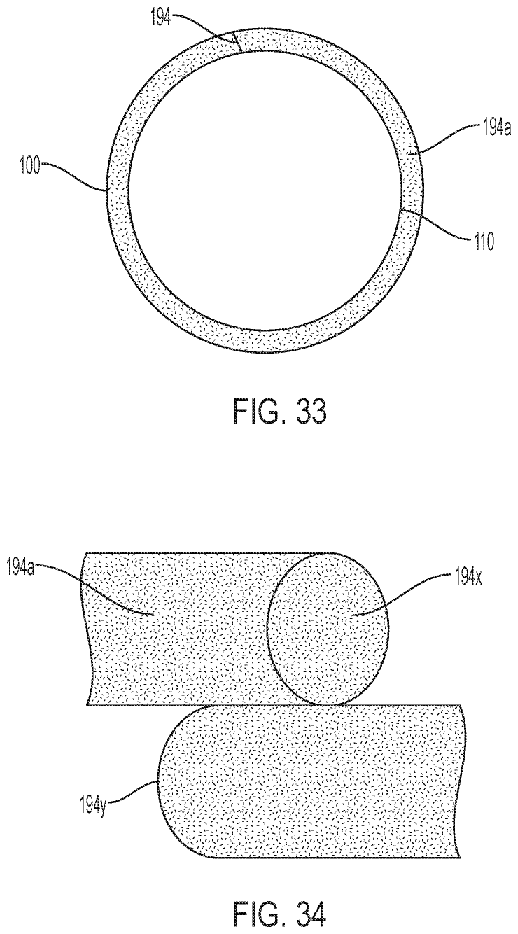

FIG. 33 provides a cross-sectional view of a joint region of an exemplary component according to the present disclosure. More specifically, FIG. 33 provides an end-on view of a component according to FIG. 28. As shown, the space (not labeled) between walls 100 and 110 has been sealed by the combination of material 194 and braze material 194. The seal is, in FIG. 33, annular in form.

FIG. 34 provides a close-up view of the ends of a ring of braze material in a component according to the present disclosure. As shown, braze material 194a can be present in a ring form, with ends 194x and 194y being disposed nearby to one another and overlapping such that the ring of braze material extends through a complete circle. Although not shown, ends 194x and 194y can face one another. It is not a requirement that the braze material be a complete circle, as the braze material can still form a circumferential seal after the braze material is liquefied.

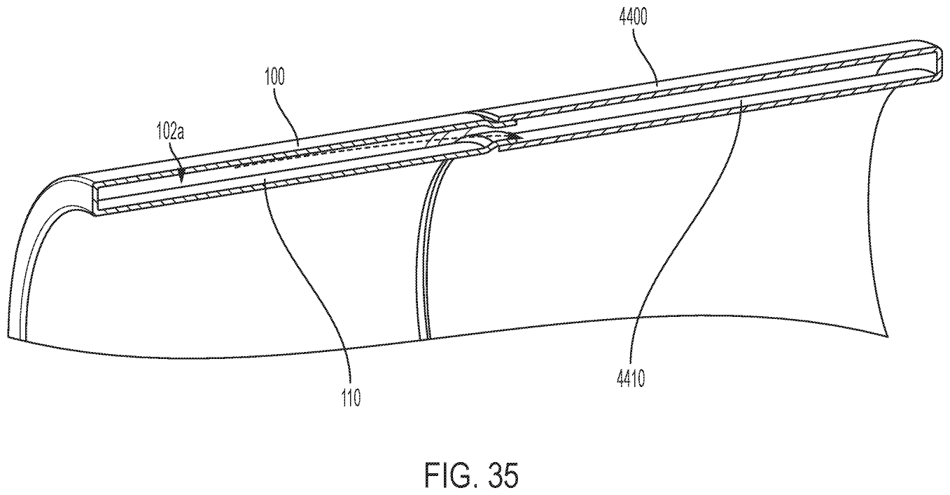

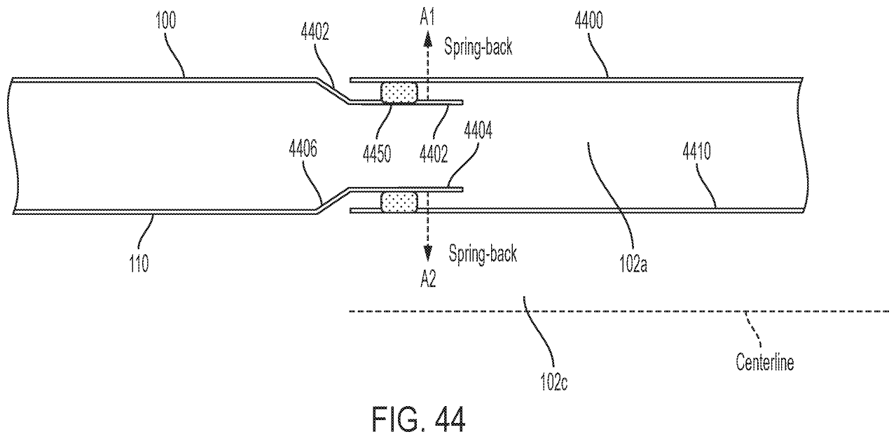

FIG. 35 provides a cutaway view of a component according to the present disclosure, similar to FIG. 44. As shown, the component can include wall 100, which wall can include a sloped portion (not labeled sloped portion 4402 connected with wall 100, and land 4402; the component can also include wall 100, sloped portion 4406, and land 4404. A sealed joint can be formed, e.g., by sealing material (such as braze material) 4450, which join in turn effects sealed space/volume 102a formed between walls 100, 110, 4400, and 4410. (Space/volume 102a can be evacuated.)

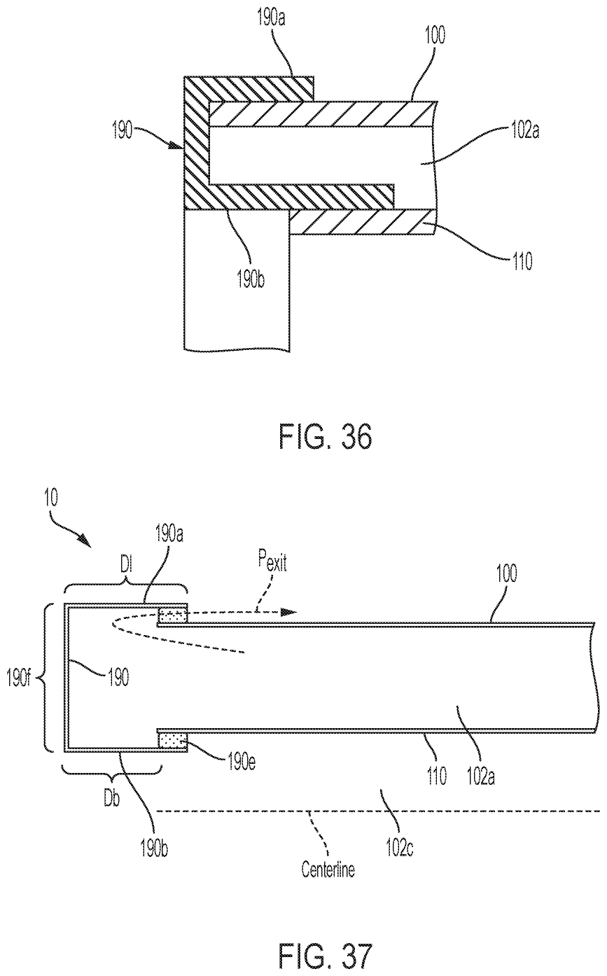

FIG. 36 provides a cutaway view of an exemplary component according to the present disclosure. As shown, cap 190 can seal the space 102a between wall 100 and wall 110. Cap 190 can include first land 190a and second land 190b. As shown, first land 190a can be disposed exterior to wall 100, and second land 190b can be disposed between wall 100 and wall 110. Land 190a can be sealed to wall 100 in virtually any way, e.g, brazing, welding, and the like. Land 190b can be sealed to wall 110 via brazing, including by any of the methods provided in the instant disclosure. Although not shown, one or more of wall 100, wall 110, and cap 190 can include one or more locator features (e.g., a ridge, a groove, a dimple, a bump) configured to facilitate locating or maintaining in place cap 190 relative to one or both of walls 100 and 110.

FIG. 37 provides a cutaway view of a component according to the present disclosure. As shown, walls 100 and 110 define a space 102a therebetween. A first cap 190 can include lands 190a and 190b. Lands 190a and 190b can be sealed, respectively, to wall 100 and wall 110. As shown in FIG. 2, first cap 190 defines a height that is less than or about equal to the distance between walls 100 and 110.

As shown in FIG. 37, lands 190a and 190b can extend in or about in the same direction, relative to one another. As shown, land 190 a defines a length Dl.

Also as shown in FIG. 37, lands 190a and 190b can overlap the ends of walls 100 and 110. As shown in FIG. 37, land 190a defines a vent with wall 100 and land 190b defines a vent with wall 110. The vents can be sealed simultaneously, but can also be sealed in a sequence. Although not shown, a second cap (not shown) having the same shape as cap 190 can be sealed to the other ends of walls 100 and 110. The second cap can also have a different shape as cap 190.

As an example, a user can seal the vents defined by land 190a and wall 100 and land 192b and wall 110 in a sequential way. A user can also seal other vents (not shown) at the other ends of walls 100 and 110 in a sequential way. Vents can be sealed simultaneously, sequentially, or a combination thereof.

Cap 190 can be friction-fit (e.g., interference fit) against one or both of walls 100 and 110. Cap 190 can be sealed to walls 100 and 100 by various techniques known in the art, including, e.g., brazing, adhesives, welding, sonic welding, and the like.

As shown in FIG. 37, braze material 190e can be used to seal cap 190 to walls 100 and 110. (As discussed elsewhere herein, brazing is but one way to effect this sealing; welding, adhesive, sonic welding, and the like can also be used.) The braze material can be located at a distance Db from the end of cap 190. As shown, Db can be less than Dl. In some embodiments, a portion of one or both of lands 190a and 190b extends (away from cap 190) beyond braze material 190e. In other embodiments, braze material 190e is essentially flush with the end of one or both of lands 190a and 190b. As shown brazing material 190e can be used to seal a vent, e.g., the first vent.

Without being bound to any particular theory, locating braze material 190e at a distance Db from the end of the component 10 (and cap 190) reduces heat transfer into (or out of) the volume (not labeled) defined within wall 110. Again without being bound by any particular theory, for heat to transfer out of the volume defined within wall 110, the heat would need to pass through sealing (e.g., braze material) 190e, along land 190b, along the end 190f of cap 190, and along at least part of land 190a. Such a comparatively long heat path can reduce the rate and/or amount of heat transferred between the volume defined within wall 110 and the environment exterior to wall 100. Further (and without being bound to any particular theory), by lengthening the distance Db, a user can reduce the rate and/or amount of heat transferred, as the illustrated configuration moves the joints and the associated connecting material (190e) away from the end (190) of the assembly.

It should be understood that the shape of cap 190 in FIG. 37 is illustrative only and does not limit the shape of the cap. As one example, one portion of the cap can be formed to taper or be otherwise configured to fit to a part or into a certain area. A cap can be symmetric, though this is not a requirement.

Without being bound to any particular theory, the thickness of end 190f can be less than the joint formed by 190b, 190e, and 110. In this way, the end can act as a thermal resistor to restrict the thermal transfer on the end of the device. This limits the conduction through the end of the device to the thermal properties of the wall of 190. (The cap can be made from essentially any material, e.g., stainless steel ceramic, and the like.)

Further, once thermal energy has moved through the thermal dam formed by 100, 190b, and 190f, a second thermal dam is encountered in the form of the joint formed by 190a, 190e, and 110. Because the thermal energy has encountered the thermal resistor of wall 190f before encountering the second thermal dam, there is less thermal energy to fill the second thermal dam before transferring the thermal energy to wall 100.

As shown in FIG. 37, molecules that exit space 102a can follow an exit path shown by Pₑₓᵢₜ. (It should be understood that Pₑₓᵢₜ is provided for illustration purposes and that molecules do not necessarily pass through braze material 190e.

As shown, the exit path is toward or in the direction of the end of wall 100 and away from the end of land 190a. Although this path is shown in the context of FIG. 37, it should be understood that the illustration with FIG. 37 is illustrative, and that the present disclosure contemplates such an exit path (i.e., in a direction toward the end of one wall (or land) of a component and away from the end of another wall (or land) of the component. The exit path of molecule leaving space 102a can this be described as doubled-back or at least partially reversing in its direction. As shown in FIG. 37 (and elsewhere herein), a joint can be formed between a first wall extending in a first direction and a second wall extending in a direction that is opposite to (or substantially opposite to) the first direction.

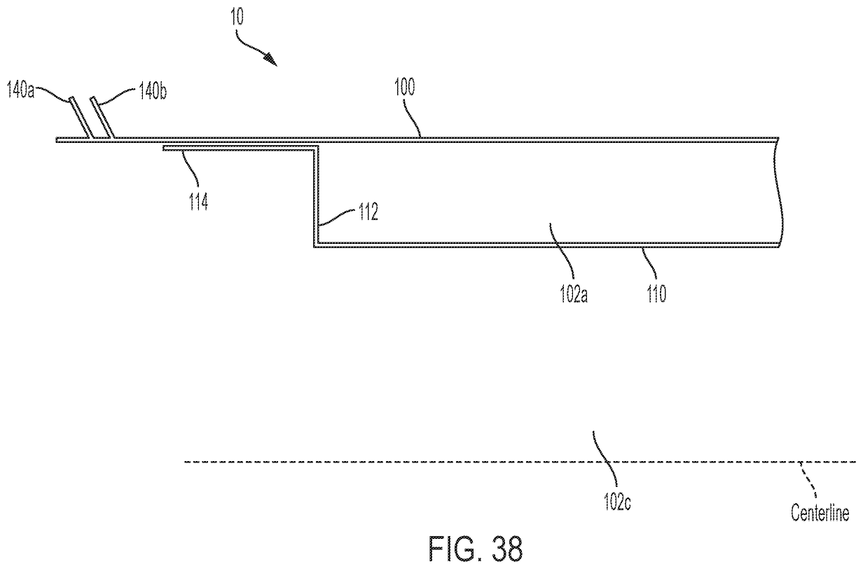

FIG. 38 provides an alternative embodiment of the disclosed technology. FIG. 1 provides an exemplary depiction of a component 10 according to the present disclosure. As shown, component 10 includes first wall 100.

A vent can be defined between first wall 100 and land portion 114 of second wall 110. Second wall 110 can also include projection portion 112, which can optionally project perpendicular from second wall 110. Second wall 110 can also include land portion 114. Land portion 114 can be sealed (e.g., via brazing) to wall 100; for clarity in the figure, the seal is not shown. Wall 100 and wall 110 can define a space/volume 102a therebetween. (It should be understood that the terms “first wall” and “second wall” are for convenience only and are not limiting. As one example, the “first wall” can be the inner wall of a double-wall tube component or the outer wall of that double-wall tube component.)

It should be understood that one or both of walls 100 and 110 can be cylindrical in configuration. In this way, the walls can define a volume (102c) within wall 110, which volume 102c can be cylindrical in shape and can have a centerline (shown in FIG. 1).

As shown in FIG. 38, a component can include one or more fins, shown as 140a and 140b. A fin can act as a heat sink and/or a heat radiator. Without being bound to any particular theory, a fin can act to retain heat that may transfer between volume 102c and the environment exterior to the component. As shown in FIG. 38, one or more fins can be disposed at an end of the component, e.g., at an end of wall 100. Fins can be disposed such that they do not overlie land 114, as shown in FIG. 38. A finned configuration has the advantage of being able to mitigate the heat transfer from the inner tube section to the outer tube section or from the outer tube section to the inner tube section. In this manner the fin configuration allows for the control of thermal energy by using convection cooling to release energy to the surrounding environment or to receive thermal energy from the surrounding environment into the apparatus. A fin/heat sink may also be used as a thermal dam. In this configuration, thermal energy is required to charge the thermal dam thus reducing the amount of thermal energy available to heat (or cool) the inner or outer wall, depending on the application

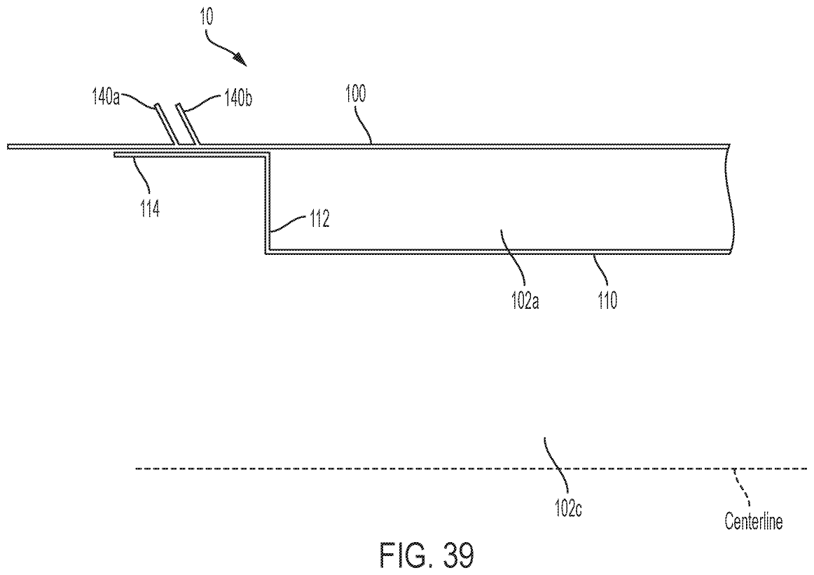

FIG. 39 provides a component similar to FIG. 38, except that fins 140a and 140b are located on wall 100 at a distance from the end of wall 100. In the embodiment shown in FIG. 39, the fins overlie land 114. In this configuration, fins can control the overall temperature of the wall which they are engaged. A heat sink placed away from the end joint connecting the inner section and the outer section of the vacuum space has the benefit of allowing the outward facing section of the device to heat or cool along the length while mitigating the temperature impact at or close to the fin configuration. This configuration can be desirable where conservation of energy is required in the application; a reduced skin temperature is also desirable. This configuration also allows the first fin formed from the outer tube (need a number for the section going from the joint to the fins) to act as a cooling device. This configuration is of particular utility if the end of the assembly is to be engaged for mounting or holding the tube and thermal profiles at this location are of interest.

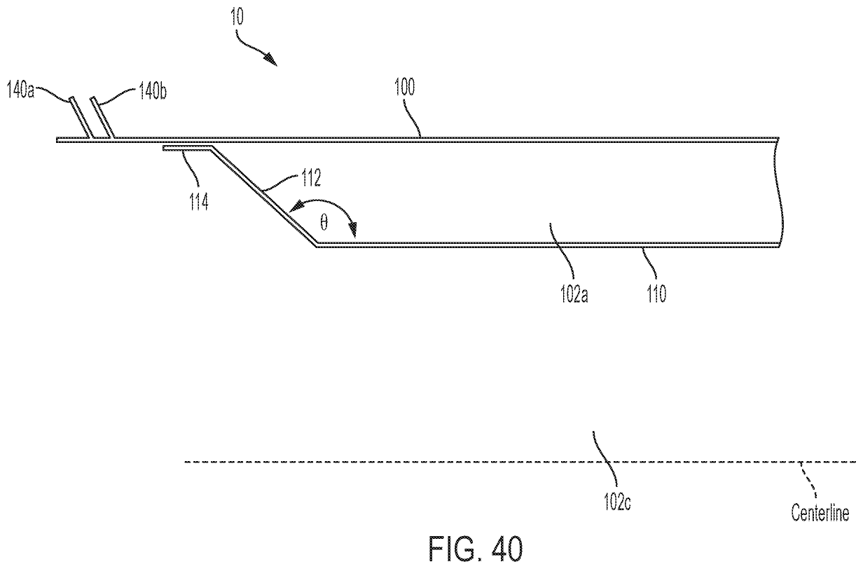

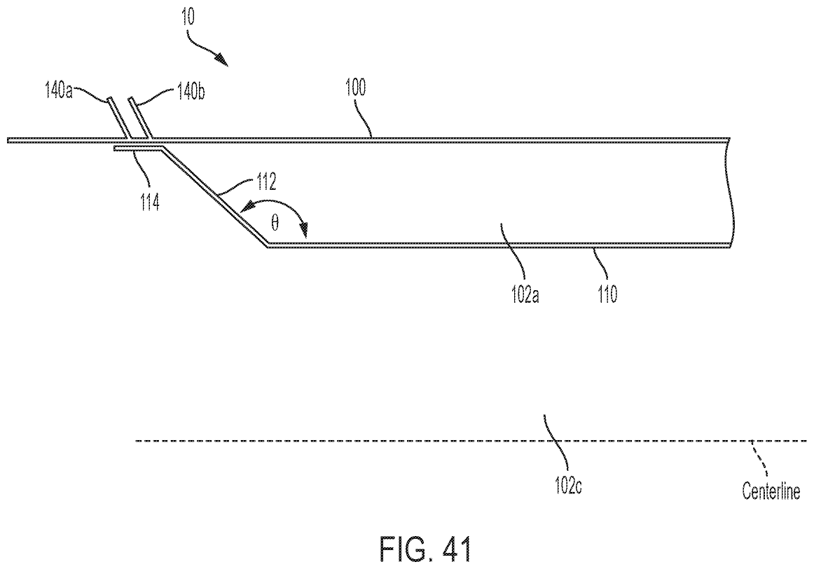

FIG. 39 provides a component similar to FIG. 38, except that projection portion 112 extends from wall 110 at an angle θ greater than 90 degrees, measured from the horizontal. Angle θ can be from 90.01 to about 179 degrees, e.g., from about 91 to about 179 degrees, from about 95 to about 175 degrees, from about 100 to about 170 degrees, from about 105 to about 165 degrees, from about 110 to about 160 degrees, from about 115 to about 155 degrees, from about 120 to about 150 degrees, from about 125 to about 145 degrees, or even from about 130 to about 135 degrees. As shown in FIG. 40, one or more fins can be disposed at an end of the component, e.g., at an end of wall 100. Fins can be disposed such that they do not overlie land 114, as shown in FIG. 40.

FIG. 41 provides a component similar to FIG. 38, except that fins 140a and 140b are located on wall 100 at a distance from the end of wall 100. In the embodiment shown in FIG. 41, the fins overlie land 114. This configuration allows for the heat sink to be in close proximity to the braze joint. This allows the heat sink to interact with the portion of the assembly that is typically thicker than the remainder of the assembly. In this manner the heat sink helps to drain the thermal dam created by the joint of the material.

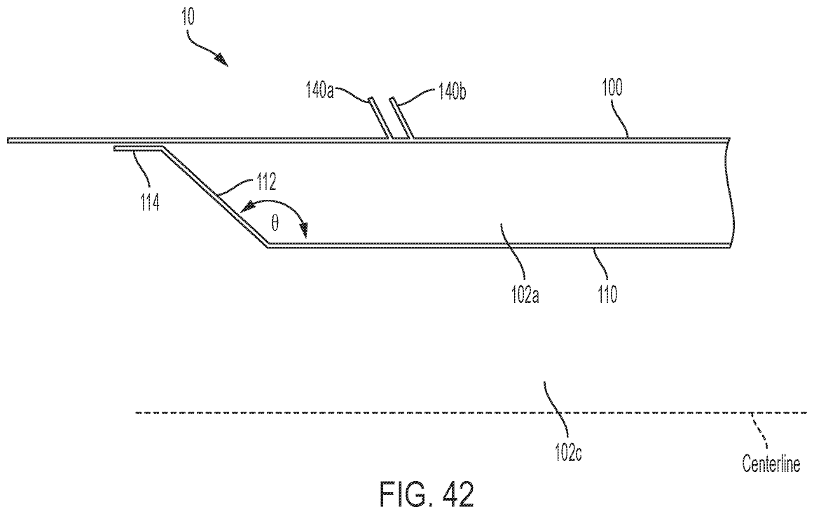

FIG. 42 provides a component similar to FIG. 41, except that fins 140a and 140b are located on wall 100 at a distance from the end of wall 100, and do not overlie land 114. In this configuration, fins can help control the overall temperature of the wall with which they are engaged. A heat sink placed away from the end joint connecting the inner section and the outer section of the vacuum space has the benefit of allowing the outward facing section of the device to heat or cool along the length while mitigating the temperature impact at or close to the fin configuration. This configuration can be desirable where conservation of energy is required in the application; however, a reduced skin temperature is also desirable. Numerous sets of fins can be configured on the wall of the apparatus to control the thermal energy between the sets of fins. This configuration may be particularly useful in applications where mounting devices need to be isolated, where sensitive equipment may be located nearby, to control and/or route the thermal energy in a consumer application, or in other applications.

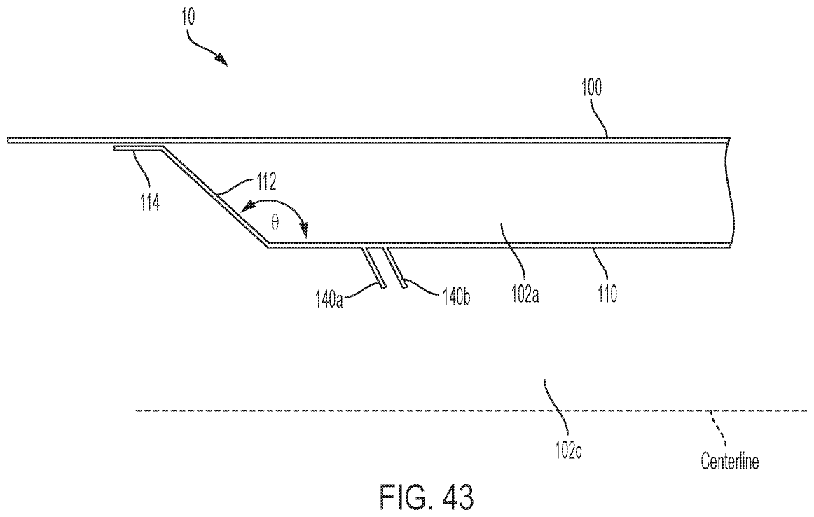

FIG. 43 provides a component similar to FIG. 42, except that fins 140a and 140b are located on wall 110, and do not overlie land 114. This benefit of this implementation is similar to FIG. 42 only the thermal energy is controlled on the inner lumen of the device. This may be needed to protect sensitive electronics, isolate equipment, or similar.

All of these aforementioned fin configurations can be used individually or combined in a single device. The number and configurations of the fins can be selected based on application and the thermal requirements of the user.

FIG. 44 provides a cutaway view of a joint-containing component according to the present disclosure. As shown, the component can include wall 100, sloped portion 4402 connected with wall 100, and land 4402; the component can also include wall 100, sloped portion 4406, and land 4404. A sealed joint can be formed, e.g., by sealing material (such as braze material) 4450, which join in turn effects sealed space/volume 102a formed between walls 100, 110, 4400, and 4410. (Space/volume 102a can be evacuated.) As shown, walls 110 and 4410 can enclose space 102c.

The component can be configured such that one or both of land 4402 and 4402 spring back against wall 4400 and/or wall 4410, as shown by spring back directions A1 and A2. Spring back is not a rule or requirement, but it can be used to maintain the relative positions of the walls and/or help to secure walls to one another. Without being bound to any particular theory or configuration, lands 4402 and 4404 can diverge outward (e.g., in the manner of a trumpet) when not inserted into the space between walls 4400 and 4410. In this way, two segments of a component can be joined to one another while also maintaining the seal (and reduced pressure) of space/volume 102a.

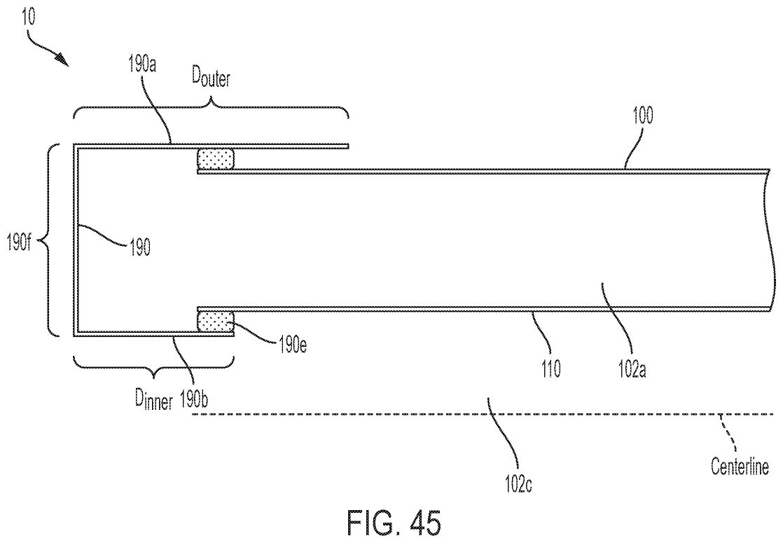

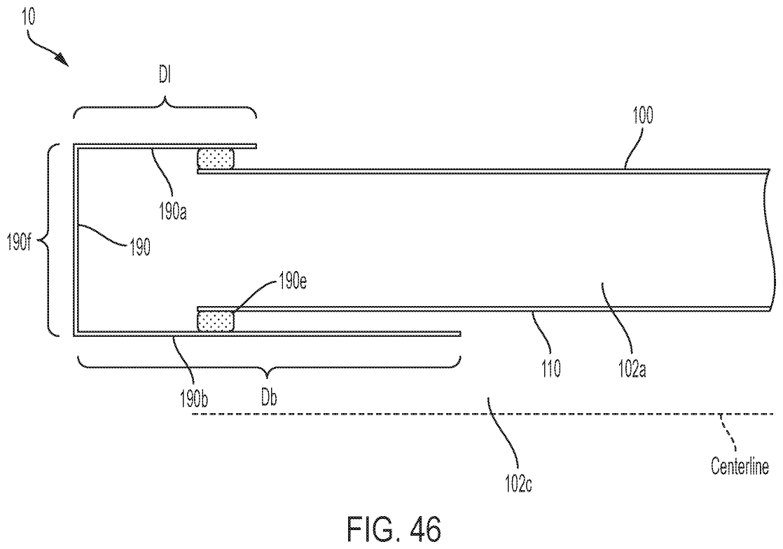

FIGS. 45 and 46 provide alternative embodiments of the component shown in FIG. 37. As shown in FIG. 45, distance Dl can be greater than distance Db. As shown in FIG. 46, distance Db can be greater than distance Dl.

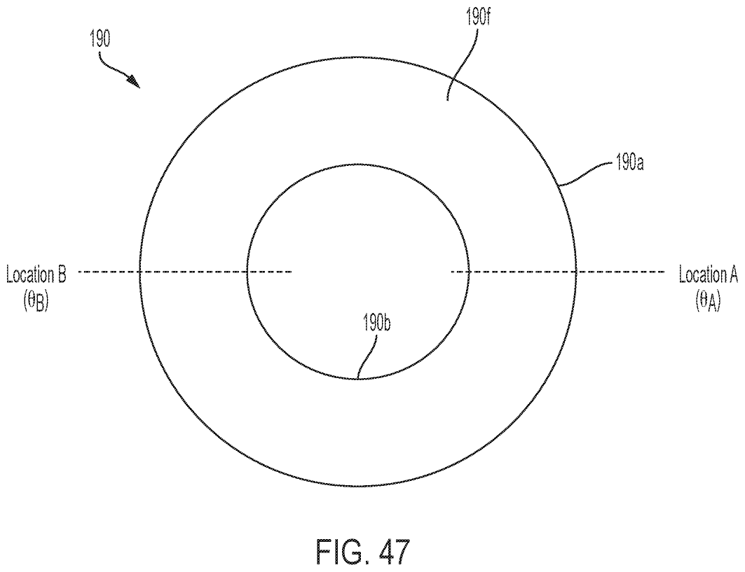

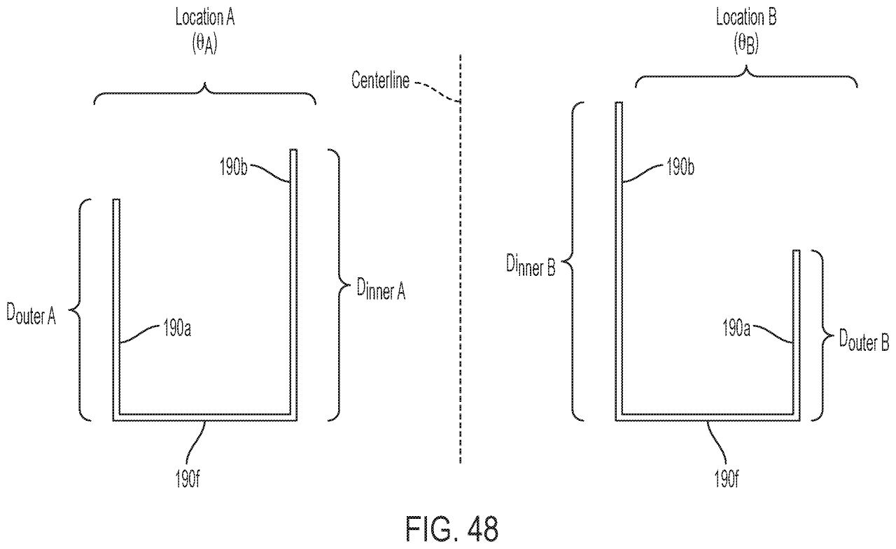

FIG. 47 provides an end-on view of a cap 190 according to the present disclosure. (An exemplary such cap is shown in FIG. 45.) As shown, cap 190 includes land 190a (which can also be considered the outer wall of w cap), end 190f, and land 190b (which can also be considered the inner wall of the cap). The end 190f can serve to connect land 190a and land 190b. FIG. 47 also defines two locations (i.e., Location A and location B) that are disposed at different angles (θA and θB) around the circumference of the cap. As shown in FIG. 48, the inner and outer walls of the cap can be of different heights at different locations around the circumference of the cap.

FIG. 48 provides a cross-sectional view of the cap shown in FIG. 47. As shown, the heights of the lands of a cap can differ around the circumference of the cap. For example, at location A (0A), the outer wall/land 190a defines a height p_{outer A}. At location B (0B), the outer wall/land 190a defines a height p_{outer B}, which can be the same as, greater than, or less than p_{outer A}. Likewise, at location A (0A), the inner wall/land 190b defines a height Dinner A. At location B (0B), the inner wall/land 190b defines a height Dinner B, which can be the same as, greater than, or less than Dinner A. In this way, a cap can provide a region around its circumference that extends further along an inner wall to which the cap is fitted. A cap can also provide a region around its circumference that extends further along an outer wall to which the cap is fitted.

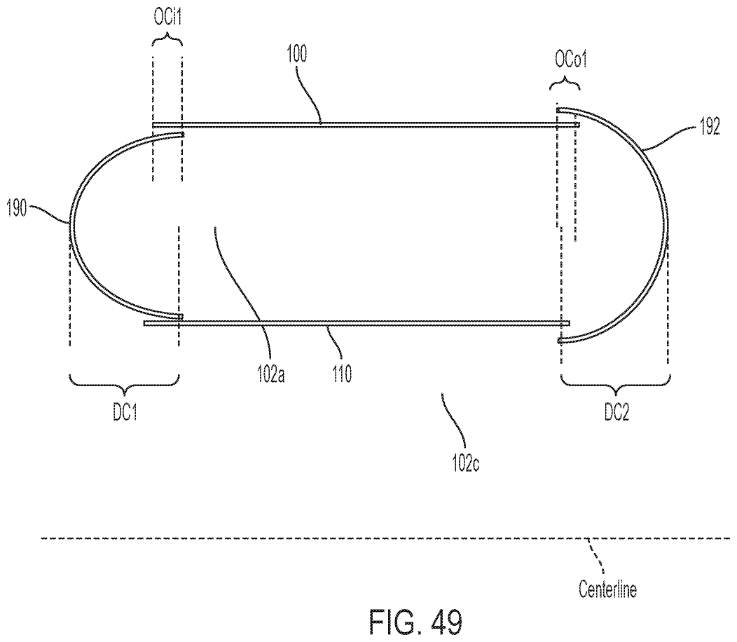

FIG. 49 provides a cutaway view of an exemplary article according to the present disclosure. As shown, an article can include first wall 100 and second wall 110. First cap 190 can be sealed to first wall 100 and second wall 110; exemplary sealing processes include brazing, welding, and the like. As shown, first cap 190 can be curved or cup-shaped in configuration. First cap 190 can be fitted such that it is sealed to facing surfaces of first wall 100 and second wall 110. As shown, the first cup can define a height DC. As shown by the article of FIG. 49, first cap 190 can define an overlap length OCi, which is the length of the overlap between first cap 190 and first wall 100. The ratio of DC to OCi1 can be, e.g., from about 200:1 to about 1:200, or from about 100:1 to about 1:100, or from 50:1 to about 1:50, or from 10:1 to about 1:10, or from about 5:1 to about 1:5.

Likewise, first cap 190 can define an overlap length OCi2 (not labeled) between itself and second wall 110. The ratio of DC to OCi2 can be, e.g., from about 200:1 to about 1:200, or from about 100:1 to about 1:100, or from 50:1 to about 1:50, or from 10:1 to about 1:10, or from about 5:1 to about 1:5.

Second cap 192 can be sealed to first wall 100 and second wall 110; exemplary sealing processes include brazing, welding, and the like. As shown, second cap 192 can be curved or cup-shaped in configuration. Second cap 192 can be fitted such that it is sealed to non-facing surfaces of first wall 100 and second wall 110. As shown, second first cup can define a height DC2. As shown by the article of FIG. 49, second cap 192 can define an overlap length OCo1, which is the length of the overlap between second cap 192 and first wall 100. The ratio of DC2 to OCo1 can be, e.g., from about 200:1 to about 1:200, or from about 100:1 to about 1:100, or from 50:1 to about 1:50, or from 10:1 to about 1:10, or from about 5:1 to about 1:5.

Likewise, second cap 192 can define an overlap length OCi2 (not labeled) between itself and second wall 110. The ratio of DC2 to OCi2 can be, e.g., from about 200:1 to about 1:200, or from about 100:1 to about 1:100, or from 50:1 to about 1:50, or from 10:1 to about 1:10, or from about 5:1 to about 1:5. As shown in FIG. 49, sealed space 102a can be defined by first cap 190, second cap 192, first wall 100, and second wall 110. A lumen or other space 102c can be defined by second wall 110; the lumen can define a centerline (as shown).

FIG. 50 provides a cutaway view of an exemplary component according to the present disclosure, showing both first cap 190 and second cap 192 being sealed to non-facing surfaces of first wall 100 and second wall 110. As shown by path 199, a molecule disposed within space 102a can deflect against any or all of first cap 190, second cap 192, first wall 100, and second wall 110, when the molecule undergoes excitation, e.g., thermal excitation.

FIG. 51 provides a cutaway view of a component according to the present disclosure. As illustrated by pathway 199 (and without being bound to any particular theory), first cap 190 can act as a reflector in that molecules that enter the end through or near the focal point at an angle will naturally be directed toward the outer edge of the end fitting.

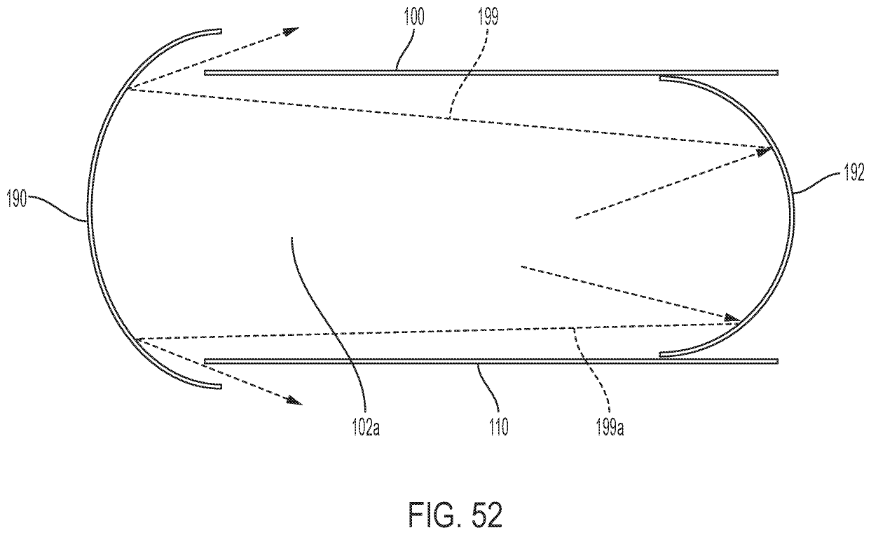

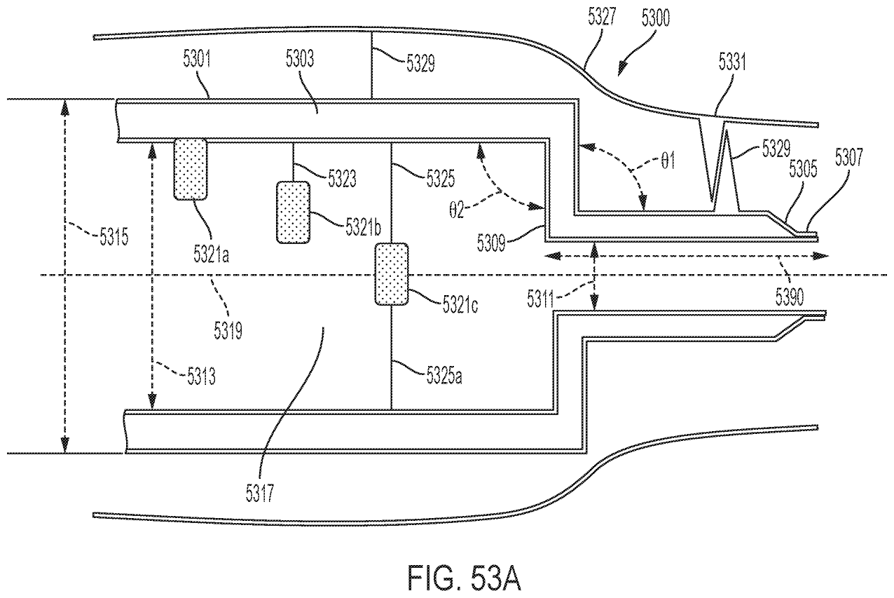

FIG. 52 provides a cutaway view of an exemplary component according to the present disclosure. As shown, a molecule following pathway 199 deflects off of concave second cap 192. Following that deflection, the molecule is naturally directed towards the periphery of space 102a defined between first wall 100 and second wall 110. Following along path 199, the deflected molecule the deflects (again) against concave first cap 190 and then out of space 102a through the gap (not labeled) between first cap 190 and first wall 100. Similarly, a molecule following pathway 199a deflects off of second cap 192. Following along path 199a, that molecule then deflects off of first cap 190 and then out of space 102a through the gap (not labeled) between first cap 190 and first wall 100.

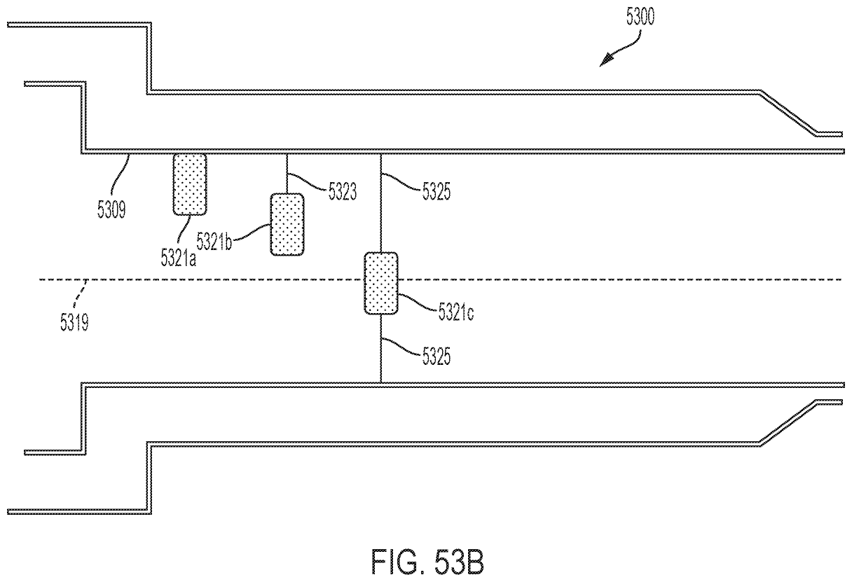

FIG. 53A provides a cutaway view of an exemplary variably-dimensioned component 5300 according to the present disclosure. As shown, a component can include an outer (first) wall 5301 and an inner (second) wall 5309, which walls define a sealed, insulating space 5303 therebetween. Space 5303 can be at a reduced (e.g., sub-atmospheric pressure, e.g. a pressure of less than 760 Torr. Suitable such pressures are described herein, and can be, e.g., from about 0.0001 to about 700 Torr, e.g., from about 0.001 to about 70 Torr, from about 0.01 to about 7 Torr, or even about 1 Torr.

Pressures of from about 1×10⁻¹ Torr to about 1×10⁻⁹ Torr, or from about 1×10⁻² Torr to about 1×10⁻⁷ Torr, or from 1×10⁻³ Torr to about 1×10⁻⁶ Torr, or from about 1×10⁻⁴ Torr to about 1×10⁻⁵ Torr are all considered suitable, as are pressures of about 1×10⁻¹ Torr, about 1×10⁻² Torr, about 1×10⁻³ Torr, about 1×10⁻⁴ Torr, about 1×10⁻⁵ Torr, about 1×10⁻⁶ Torr, about 1×10⁻⁷ Torr, about 1×10⁻⁸ Torr, and/or about 1×10⁻⁹ Torr. Although the foregoing pressures are given in the context of an illustrative, non-limiting embodiment, it should be understood that an insulating space of any embodiment of the disclosed technology can be at any of the disclosed pressures or pressure ranges (or any sub-range).

Second wall 5309 can define a lumen 5317 therein. It should be understood that lumen 5317 can have a constant cross-sectional dimension along the length of the lumen, but this is not a requirement, as lumen 5317 can define one or more regions (e.g., of contraction or expansion) where the cross-sectional dimension changes. As an example, the cross-sectional dimension can change gradually over a distance along the major axis (element 5319) of the component. The cross sectional dimension can also change in a step-type fashion as measured along major axis 5319, as shown in FIG. 53A.

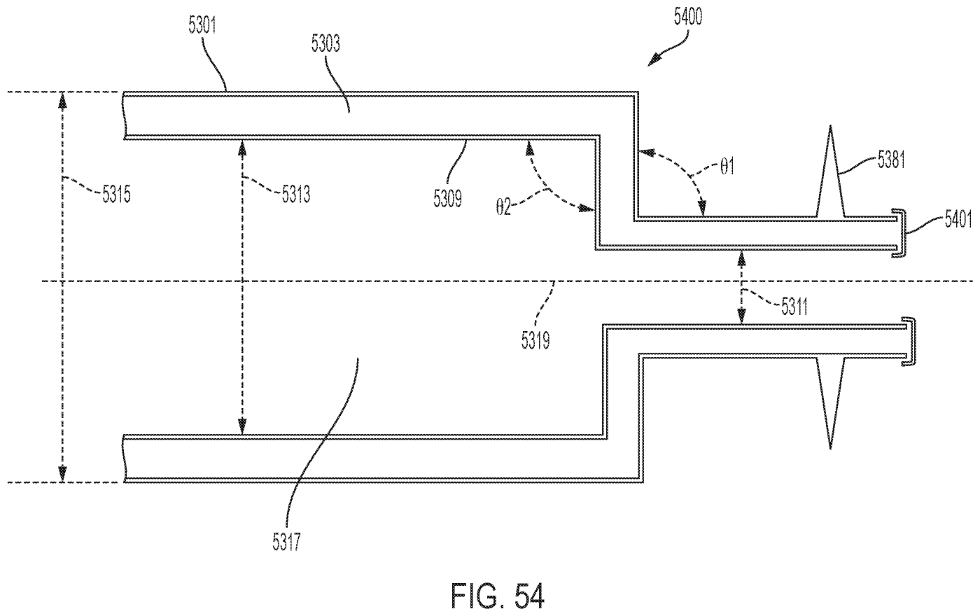

As shown in FIG. 53A, second wall 5309 can define an angle θ2 at a location along its length, which angle can define the degree of contraction or expansion in second wall 5309. As an example, when 02 is 90 degrees, the cross-sectional dimension of lumen 5317 changes in a step-type fashion as shown in FIG. 54, with the cross-sectional dimension changing from a first value 5313 as one moves along the major axis of the lumen to a throat region (having length 5390) that has a cross-sectional dimension of a second value 5311, which second value 5311 is less than first value 5313. First wall 5301 can also define an outer cross-sectional dimension 5315, which can be measured as an external diameter of first wall 5301.

First value 5313 can be from, e.g., 0.01 to 100 times second value 5311, e.g., from 0.01 to 100, from 0.1 to 10, or even from 1 to 5 times 5311. Thus, lumen 5317 can define a region of relative width and a region of relative narrowness that are in fluid communication with one another. As shown in FIG. 54 (depicting component 5400), first wall 5301 can include a fitting 5381. Fitting 5381 can be used to connect the component to an external device, e.g., a manifold, exhaust, or other external device. Fitting 5381 can include a threading, a bolt, a closure, a collar, a tab, a slot, or other feature used to secure the fitting to an external device (and/or to a fitting of an external device).

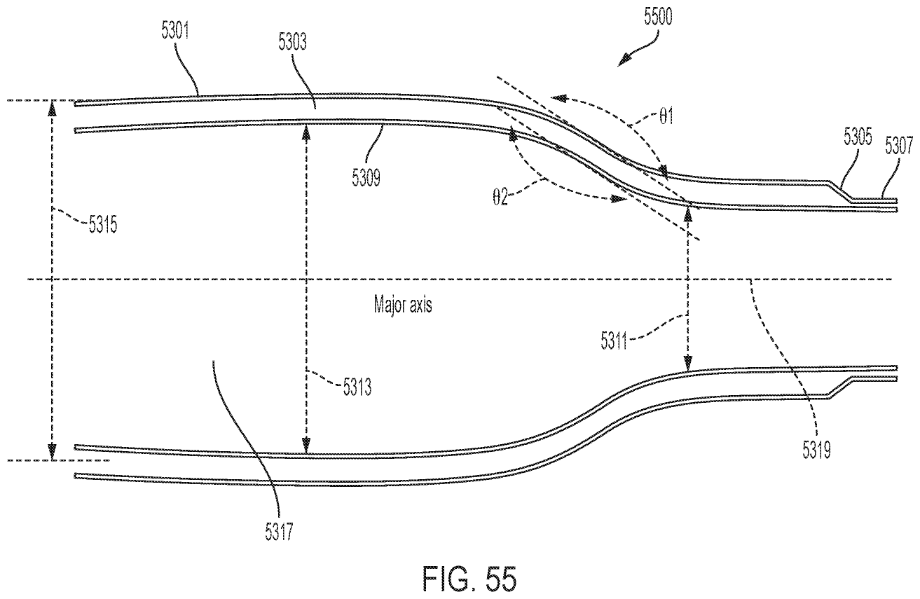

As shown in FIG. 55 (depicting component 5500), second wall 5309 (and first wall 5301) can also include a bend that is not a step-type corner as shown in non-limiting FIG. 53A. As shown, second wall 5309 can include an angle θ2, which angle can be measured tangent to the curve of second wall 5309. Likewise, first wall can include a bend that is not a step-type corner as shown in FIG. 53. As shown, first wall 5301 can include an angle θ1, which angle can be measured tangent to the curve of first wall 5301.

It should be understood that angle θ2 can be from, e.g., 0 degrees to about 90 degrees, from about 1 to about 89 degrees, from about 2 to about 88 degrees, from about 3 to about 87 degrees, from about 4 to about 86 degrees, from about 5 to about 85 degrees, from about 6 to about 84 degrees, from about 7 to about 83 degrees, from about 8 to about 82 degrees, from about 9 to about 81 degrees, from about 10 to about 80 degrees, from about 11 to about 79 degrees, from about 12 to about 78 degrees, from about 13 to about 77 degrees, from about 14 to about 76 degrees, from about 15 to about 75 degrees, from about 16 to about 74 degrees, from about 17 to about 73 degrees, from about 18 to about 72 degrees, from about 19 to about 71 degrees, from about 20 to about 70 degrees, from about 21 to about 69 degrees, from about 22 to about 68 degrees, from about 23 to about 67 degrees, from about 24 to about 66 degrees, from about 25 to about 65 degrees, from about 26 to about 64 degrees, from about 27 to about 63 degrees, from about 28 to about 62 degrees, from about 29 to about 61 degrees, from about 30 to about 30 degrees, from about 31 to about 59 degrees, from about 32 to about 58 degrees, from about 33 to about 57 degrees, from about 34 to about 56 degrees, from about 35 to about 55 degrees, from about 36 to about 54 degrees, from about 37 to about 53 degrees, from about 38 to about 52 degrees, from about 39 to about 51 degrees, from about 40 to about 50 degrees, from about 41 to about 49 degrees, from about 42 to about 48 degrees, from about 43 to about 37 degrees, from about 44 to about 46 degrees, or even about 45 degrees. Angle θ2 can also be from 0 to 90 degrees, from about 7 to about 80 degrees, from about 11 to about 71 degrees, from about 17 to about 62 degrees, from about 22 to about 59 degrees, from about 29 to about 51 degrees, or even from about 33 to about 44 degrees.

As shown, first wall 5301 can also define an angle θ1 along its length. Angle θ1 can be the same as (e.g., congruent to) angle θ2, though this is not a requirement. As an example, angle θ1 can differ from angle θ2 by from about 0.1 to about 10 degrees, although this is not limiting or a requirement.

Sealed insulating space 5303 can be sealed in a variety of manners. In one non-limiting embodiment, the distance between the first and second walls is variable in a portion of the insulating space adjacent the vent such that gas molecules within the insulating space are directed towards the vent during evacuation of the insulating space. The direction of the gas molecules towards the vent imparts to the gas molecules a greater probability of egress than ingress with respect to the insulating space. A getter can be used in space 5303, although this is not a requirement, and space 5303 can be sealed without any getter material being disposed therein. As one example, in non-limiting FIG. 53A, first wall 5301 includes a portion 5305 that tapers towards second wall 5309 as well as a land portion 5307 that is sealed (e.g., via brazing) to second wall 5309.

As shown in FIG. 54, space 5303 can also be sealed using a cap (e.g., cap 5401), but can also be sealed using one or more of the various other sealing techniques described elsewhere herein, e.g., using one or more of the techniques shown in FIGS. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, and 52 presented herein.

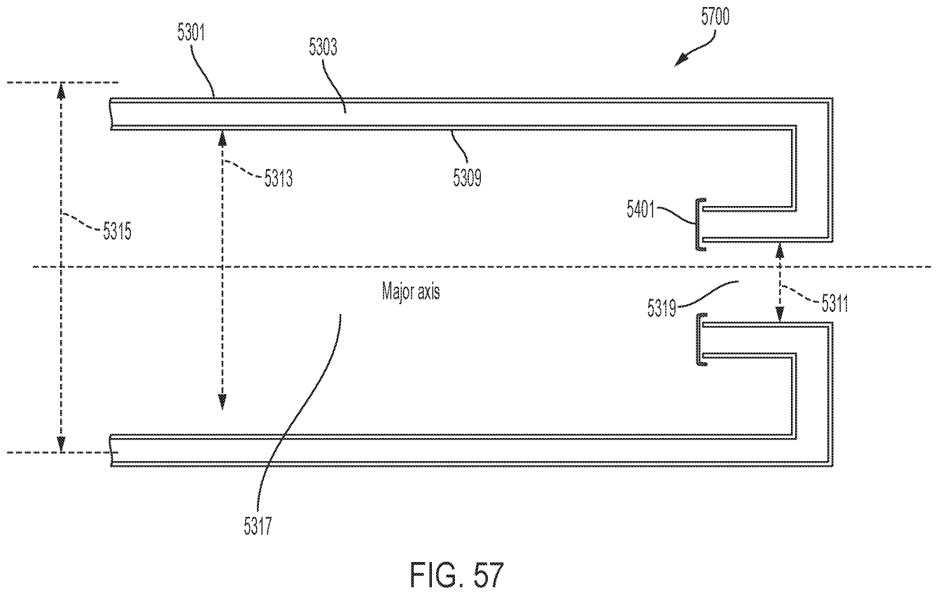

As shown in FIG. 53A, a throat region having a cross-sectional dimension can be formed by second wall 5309 as the wall extends along major axis 5319. As shown in non-limiting FIG. 57 (depicting component 5700), the throat region can also be formed (i.e., defined) by outer wall 5301 curling back on itself into lumen 5317. As shown, second wall 5309 can effectively “double-back” on itself. In FIG. 57, sealed insulating space 5303 is shown as being sealed with cap 5401, but it should be understood that this is illustrative only and that space 5303 can be sealed using one or more of the various other sealing techniques described elsewhere herein, e.g., using one or more of the techniques shown in FIGS. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, and 52 presented herein.

Although not shown, a component (e.g., a wire, a cable, a lead, a probe, and the like) can be inserted into lumen 5317 via the throat region. The inserted component and throat region can be sealed by, e.g., brazing, glass, a hermetic seal, and the like.

As FIG. 53A shows, a component can include a jacket 5327. Jacket 5327 can provide mechanical protection for the component, e.g., protection against dents, bumps, and scrapes. Jacket 5327 can also provide additional thermal insulation. The space (not labeled) between jacket 5327 and first wall 5301 can act as an insulator, e.g., as an air-gap insulator. The space between jacket 5327 and first wall 5301 can be at least partially filled with an insulating material, e.g., a fibrous or porous material. The space between jacket 5327 and first wall 5301 can be sealed and can also be evacuated.

Jacket 5327 can be secured to the component in a variety of ways. For example, connection 5329 can be used to secure jacket 5327 to first wall 5301. The connection can be, e.g., a threaded connection between a threading of jacket 5327 and first wall 5301, a snap-fit connection, a welded connection, an adhesive (e.g., glue) connection, and the like. Jacket 5327 can also be secured to the throat region of the component. As an example, jacket 5327 can include a threading 5331 that mates with a threading 5329 of the throat region of the component. Jacket 5327 can also be connected to first wall 5301 via a snap-fit connection, a welded connection, a brazed connection, an adhesive connection, and the like.

As provided in FIG. 53A, payload 5321a can be present within lumen 5317. Exemplary payloads include, e.g., electronic components, sensors, meters, and the like. Payload 5321a can be secured directly to second wall 5309 and can even contact second wall 5309. A payload 5321b can be secured to second wall 5309 via a support 5323. Support 5323 can be rigid or flexible, and can act to maintain payload 5321b in position within lumen 5317. Support 5323 can extend from a point on second wall 5309, but can also extend from along a portion of second wall 5309, e.g., in the form of an arc or sector. A payload (e.g., 5321c) can be suspended by multiple supports, e.g., by first support 5325 and second support 5325a.

FIG. 53B provides a magnified view of the throat region of an exemplary component. As shown, payload 5321a can be present within the throat region of a component. Payload 5321a can be secured directly to second wall 5309 and can even contact second wall 5309. A payload 5321b can be secured to second wall 5309 via a support 5323. Support 5323 can be rigid or flexible, and can act to maintain payload 5321b in position within lumen 5317. Support 5323 can extend from a point on second wall 5309, but can also extend from along a portion of second wall 5309, e.g., in the form of an arc or sector. A payload (e.g., 5321c) can be suspended by multiple supports, e.g., by first support 5325 and second support 5325a.

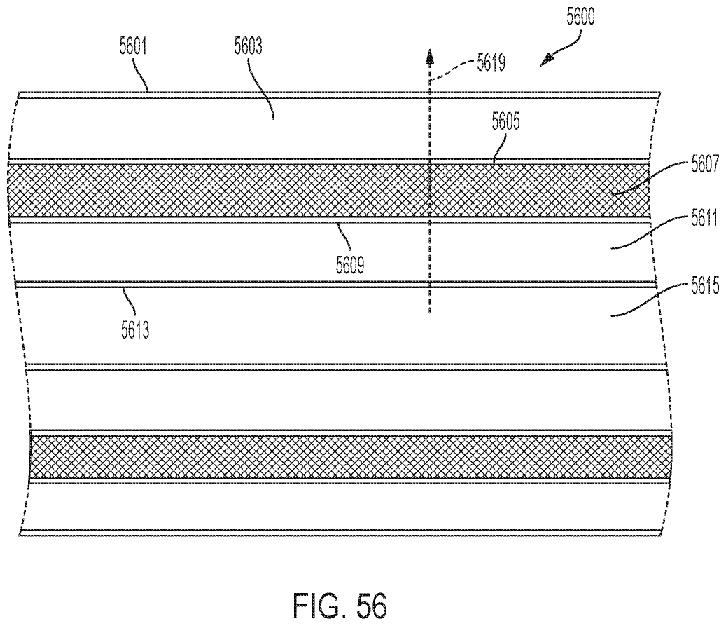

Another embodiment of the disclosed technology is provided in FIG. 56 (depicting component 5600). As shown in that FIG. 56, a first sealed insulating region 5603 is defined between first wall 5601 and second wall 5605. A second sealed insulating region 5611 is defined between third wall 5609 and fourth wall 5613. As described elsewhere herein, a sealed insulating region can be at a reduced (e.g., sub-atmospheric pressure, e.g. a pressure of less than 760 Torr. Suitable such pressures are described herein, and can be, e.g., from about 0.0001 to about 700 Torr, e.g., from about 0.001 to about 70 Torr, from about 0.01 to about 7 Torr, or even about 1 Torr. Pressures of from about 1×10−1 Torr to about 1×10−9 Torr, or from about 1×10−2 Torr to about 1×10−7 Torr, or from 1×10−3 Torr to about 1×10−6 Torr, or from about 1×10−4 Torr to about 1×10−5 Torr are all considered suitable, as are pressures of about 1×10−1 Torr, about 1×10−2 Torr, about 1×10−3 Torr, about 1×10−4 Torr, about 1×10−5 Torr, about 1×10−6 Torr, about 1×10−7 Torr, about 1×10−8 Torr, and/or about about 1×10−9 Torr.

Sealed insulating spaces can be sealed according to one or more of the various techniques described herein, e.g., using one or more of the techniques shown in FIGS. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, and 52 presented herein. One or more of the first, second, third, and fourth walls can be cylindrical in configuration, though this is not a requirement.

An interstitial space 5607 can be defined between second wall 5605 and third wall 5609. Interstitial space 5607 can be filled with a fluid (e.g., air) at atmospheric pressure. This is not, however, a requirement, as interstitial space 5607 can be at a reduced, sub-atmospheric pressure, as described elsewhere herein.

Interstitial space 5607 can also be filled at least partially with an insulating material (which can be refractory such material), e.g., a porous insulating material, a fibrous insulating material, or some combination thereof. Alumina felt is one exemplary such material; other ceramic porous and/or fibrous materials can also be used.

Interstitial space 5607 can define a cross-sectional dimension (e.g., a width) that is from 0.01 to 100 times the corresponding cross-sectional dimension of first sealed insulating region 5603, e.g., from 0.01 to 100, from 0.1 to 10, or even from 1 to 5 times the corresponding cross-sectional dimension of first sealed insulating region 5603.

Interstitial space 5607 can define a cross-sectional dimension (e.g., a width) that is from 0.01 to 100 times the corresponding cross-sectional dimension of second sealed insulating region 5611 e.g., from 0.01 to 100, from 0.1 to 10, or even from 1 to 5 times the corresponding cross-sectional dimension of first sealed insulating region 5611.

As shown in FIG. 56, fourth wall 5613 can define a lumen 5615 therein. Lumen 5615 can be used to convey and/or contain fluid, e.g., an exhaust, a cooling fluid, and the like. Fluid disposed within lumen 5615 is thus insulated from the environment exterior to first wall 5601 by two sealed insulating spaces (i.e., first insulating region 5603 and second insulating region 5611) as well as by interstitial space 5607 and any insulating material that may be disposed within interstitial space 5607, first insulating region 5603, and/or second insulating region 5611.

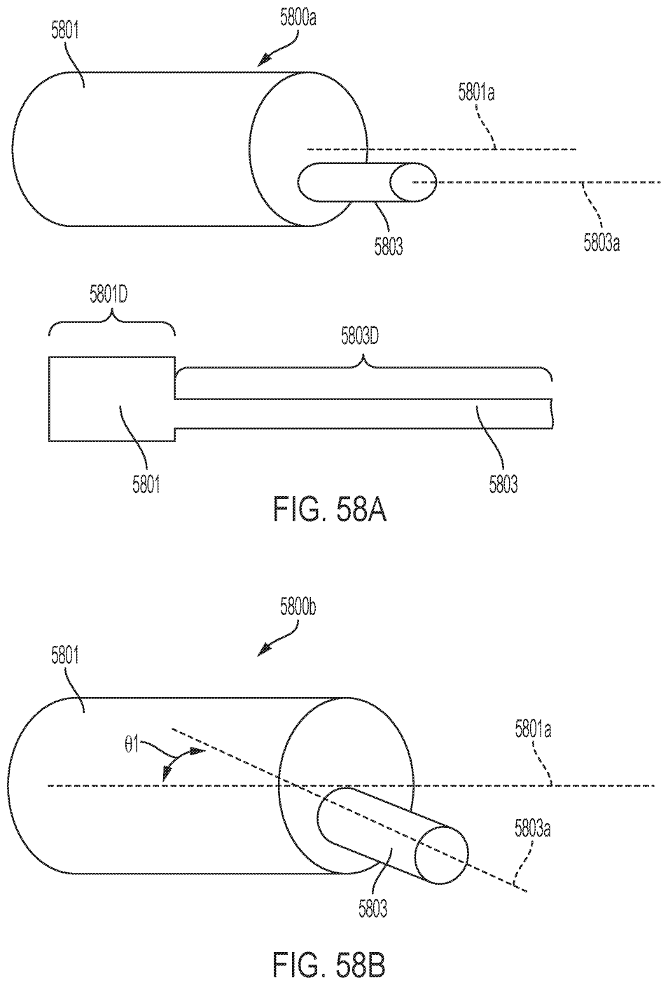

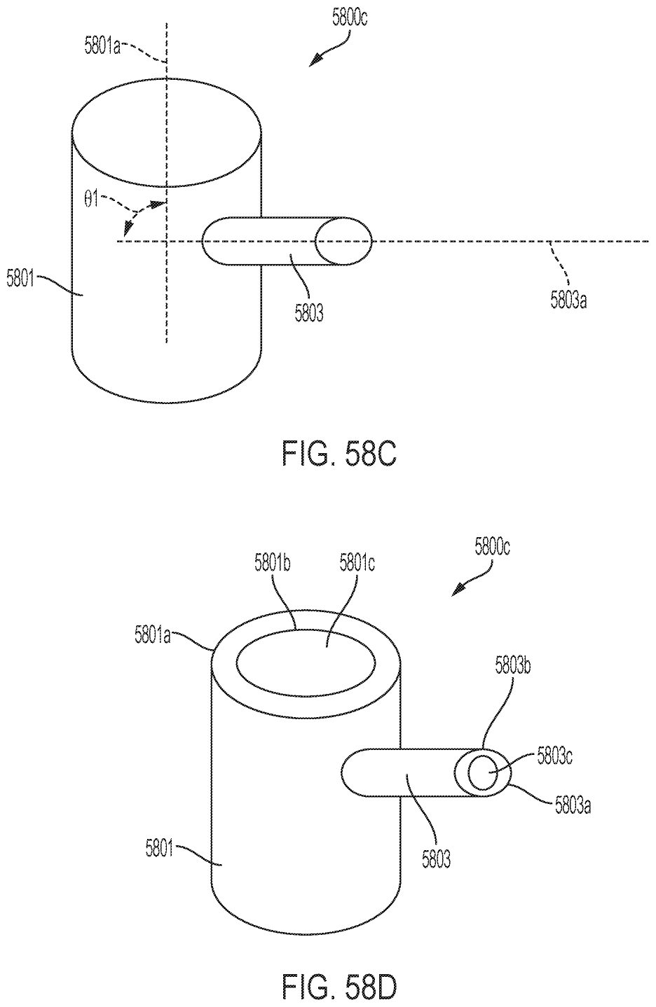

FIG. 58A provides a further embodiment of the disclosed technology. As shown, a component 5800a can include a first vessel 5801, which vessel can comprise two walls with a sealed insulating space defined therebetween and the innermost wall defining an interior volume (e.g., a lumen) therein. (Suitable techniques for forming such sealed spaces are described elsewhere herein.) The first vessel can define a major axis 5801a, as shown in FIG. 58A. A component can also include a feedthrough portion 5803. The feedthrough portion 5803 can define a lumen therein, with the lumen of the feedthrough portion being in fluid communication with the interior volume of the first vessel 5801. As shown in FIG. 58A, a feedthrough can connect with a first vessel 5801 at the top (or bottom) of vessel 5801. The feedthrough can also connect with the first vessel at any location of the first vessel, e.g., the sidewall of the first vessel. Although the first vessel is shown as being cylindrical in FIG. 58A, the first vessel can be of any shape, e.g., spherical, ovoid, cube, box, and the like.

It should be understood that the first vessel can be a can or container, but can also be a conduit, e.g., a tube having a larger internal diameter than the internal diameter of feedthrough portion 5803. Feedthrough 5803 can include two walls that define a sealed insulating space therebetween; suitable techniques for forming such sealed spaces are described elsewhere herein.

As shown, feedthrough portion 5803 can define a major axis 5803a. The major axis 5803a of the feedthrough portion 5803 can be parallel to the major axis 5801 of the first vessel, though this is not a requirement. In some embodiments, the first vessel and the feedthrough are coaxial with one another, but this is not a requirement.

Without being bound to any particular embodiment, the feedthrough portion 5803 can be used in a variety of manners. As one example, the feedthrough portion can be used to protect a wire, cable, fiber, or other transmission medium that is introduced into or through the interior volume of first vessel 5801. As an example, an electrical cable can be fed through feedthrough 5803 so that the cable can be connected to an element (e.g., a sensor) located in or beyond the internal volume of first vessel 5801.

The bottom panel of FIG. 58A shows the relative sizes of first vessel 5801 and feedthrough portion 5803; as shown, first vessel 5801 can define a length 5801D, and feedthrough portion 5803 can define a length 5803D. The ratio of 5801D to 5803D can be from 1:0.5 to 1:1000, or from 1:1 to 1:500, or from 1:2 to 1:250, or from 1:3 to 1:300, or from 1:5 to 1:200, or from 1:7 to 1:150, or from 1:8 to 1:100, or from 1:10 to 1:50 and all intermediate values. Thus, the length 5803D of feedthrough potion 5803 can be greater than the length 5801D of first vessel 5801. It should be understood that the feedthrough portion can be rigid, but can also be flexible, e.g., as disclosed in WO 2019/040885, the entirety of which is incorporated herein by reference.

FIG. 58B provides an alternative embodiment of a component (5800a) according to the present disclosure. As shown, the major axis 5803a of feedthrough 5803 can be offset by an angle θ1 from the major axis 5801a of first vessel 5801 where the axes intersect. It should be understood, however, that there is no requirement that the major axes of the feedthrough portion and the first vessel intersect, as they may be offset or skewed from one another such that the axes do not intersect. Angle θ1 can be from 0 to 180 degrees, e.g., from about 1 to about 180 degrees, from about 5 to about 170 degrees, from about 10 to about 160 degrees, from about 20 to about 140 degrees, from about 40 to about 120 degrees, from about 45 to about 110 degrees, or even from about 60 to about 80 degrees. Although feedthrough 5803 is shown connected to first vessel 5801 at the top of first vessel 5801, it should be understood that feedthrough 5803 can connect to first vessel at any location.

FIG. 58C provides an alternative view of a component (5800c) according to the present disclosure. As shown, feedthrough portion 5803 connects to a side wall of first vessel 5801. The major axis 5801a of the first vessel intersects the major axis 5803a of the feedthrough portion, with the axes being offset by an angle θ1, which angle can be from 0 to 180 degrees, e.g., from about 1 to about 180 degrees, from about 5 to about 170 degrees, from about 10 to about 160 degrees, from about 20 to about 140 degrees, from about 40 to about 120 degrees, from about 45 to about 110 degrees, or even from about 60 to about 80 degrees. It should be understood, however, that the major axes of the first vessel and the feedthrough need not intersect at any location.

FIG. 58D provides a further view of the component 5800c of FIG. 58C. As shown in FIG. 58D, the first vessel 5801 can comprise second wall 5801b and first wall 5801a, which walls can define a sealed insulating space therebetween. Second wall 5801b can bound interior volume 5801c.

The feedthrough portion 5803 can comprise a first feedthrough wall 5803a and a second feedthrough wall 5803b, with the second feedthrough wall 5803b defining a lumen 5803c therein. Lumen 5803c can be in fluid communication with interior volume 5801c.

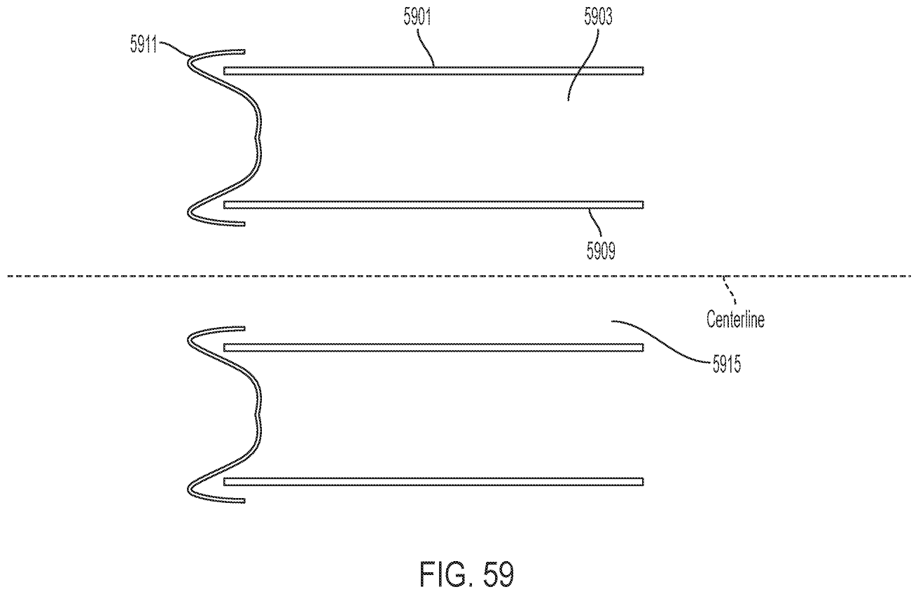

FIG. 59 provides a cutaway view of an article according to the present disclosure. As shown, first wall 5901 and second wall 5909 define a sealed insulating space 5903 therebetween. Second wall 5909 can define a lumen 5915 therein.

As shown in FIG. 59, space 5903 defined between first wall 5901 and second wall 5909 can be sealed by end cap 5911. End cap 5911 can have a profile that is M-shaped in cross-section, as shown in FIG. 59. As shown, end cap 5911 can have a portion that enters into space 5903. End cap 5911 can also have a portion that overlaps with first wall 5901, which portion can extend along a portion of first wall 5901. Similarly, end cap 5911 can also have a portion that overlaps with second wall 5909, which portion can extend along a portion of first wall 5909.

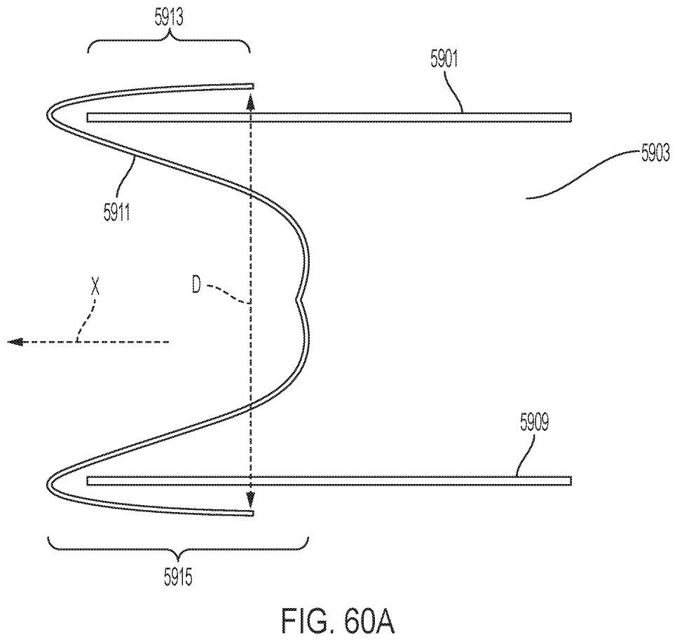

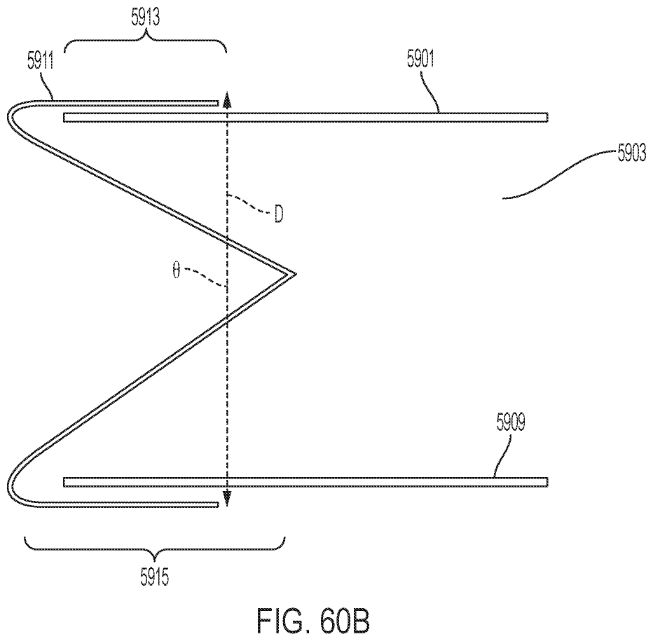

FIG. 60A provides a magnified view of the article of FIG. 59. As shown, end cap 5911 can have an M-shaped cross-section. A portion (5913) of end cap 5911 can extend along the length of first wall 5901. The length of portion 5913 (as measured in the x-direction, as shown in FIG. 60A) can be, e.g., from about 0.01 mm to about 10 mm, or from about 0.1 mm to about 8 mm, or from about 0.3 mm to about 5 mm, or even from about 0.5 mm to about 2.5 mm. End cap 5911 can comprise a metal or a metal alloy. End cap 5911 can also comprise a ceramic material. (As described elsewhere herein, one or both of first wall 5901 and second wall 5909 can comprise a metal or a metal allow; one or both of first wall 5901 and second wall 5909 can comprise a ceramic material.)

As shown in FIG. 60A, end cap 5911 can define a width D, which is the end-to-end distance as shown in FIG. 60A. The ratio of the length of portion 5913 to width D can be, e.g., from 1:50 to 1:2, or from 1:10 to 1:1.7, or from 1:5 to 1:1.2, and all intermediate values.

Also as shown in FIG. 60A, end cap 5911 can comprise a concave portion (e.g., the portion of end cap 5911 that extends into space 5903) as well as a portion that is convex relative to the concave portion. End cap 5911 can be characterized as being undulating; as an example, end cap 5911 can have the curved M-shaped cross-sectional profile shown in FIG. 60A. End cap 5911 can extend into space 5903, e.g., by from 0.1 to about 10 mm, or from about 0.3 to about 7 mm, or from about 0.5 to about 5 mm, or even from about 1 to about 2.5 mm.

As shown in FIG. 60A, end cap 5911 can define a depth 5915, which is the distance from the lowest point on the end cap to the highest point, measured in the x-direction as shown in FIG. 60A. The ratio of depth 5915 to width D can be, e.g., from 1:50 to 1:2, or from 1:10 to 1:1.7, or from 1:5 to 1:1.2, and all intermediate values.

FIG. 60B provides an alternative view of a component according to FIG. 60A. As shown, end cap 5911 can define a cross-sectional profile that is M-shaped, wherein the M-shaped profile defines a V-shaped portion having an angle θ, which angle can be, e.g., from about 179 to about 1 degree, or from about 170 to about 5 degrees, or from about 165 to about 10 degrees, or from about 160 to about 15 degrees, or from about 155 to about 20 degrees, or from about 150 to about 25 degrees, or from about 145 to about 30 degrees, or from about 140 to about 35 degrees, or from about 135 to about 40 degrees, or from about 130 to about 45 degrees, or from about 125 to about 50 degrees, or from about 120 to about 55 degrees, or from about 125 to about 60 degrees, or from about 130 to about 65 degrees, or from about 125 to about 70 degrees, or from about 120 to about 75 degrees, or from about 120 to about 80 degrees, or from about 115 to about 85 degrees, or from about 110 to about 90 degrees, or even from about 105 to about 95 degrees, and all intermediate values and ranges.

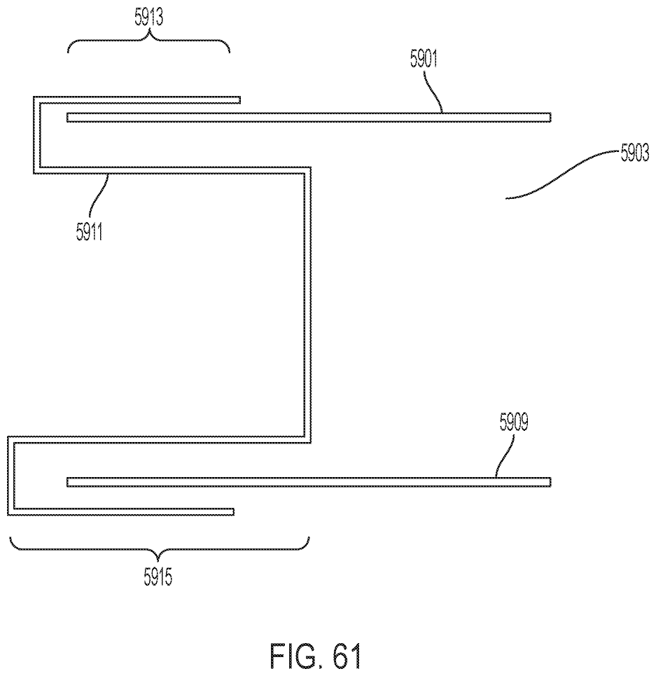

FIG. 61 provides an alternative view of a component according to FIG. 60A. As shown, end cap 5911 can define a cross-sectional profile that is M-shaped, wherein the M-shaped profile defines one or more corners, rather than curves. An end cap can include both corners as well as curves. As an example, an end cap can include a curved portion that hooks over the edge of first wall 5901, and a cornered portion that extends into space 5903. Similarly, an end cap can include a cornered portion that hooks over the edge of first wall 5901 and a curved portion that extends into space 5903. It should be understood that a V-shaped portion can be considered a cornered portion.

An end cap can include a V-shaped portion that hooks over the end of first wall 5901 and/or over second wall 5909. An end cap can include a V-shaped portion that extends into space 5903. An end cap can include a curved portion that hooks over the end of first wall 5901 and/or over second wall 5909. An end cap can include a curved portion that extends into space 5903. An end cap can include a cornered portion that hooks over the end of first wall 5901 and/or over second wall 5909. An end cap can include a cornered portion that extends into space 5903. And end cap can include any combination of curved portions, V-shaped portions, and cornered portions.

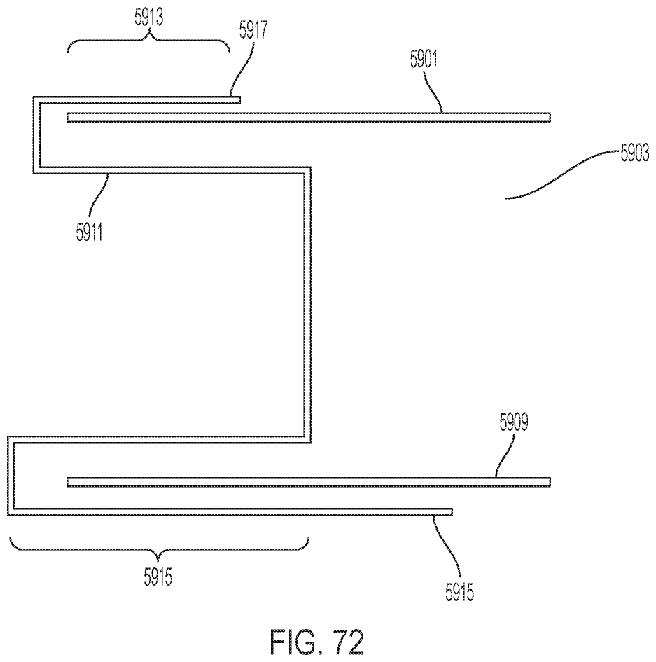

FIG. 72 provides a further variation on the article shown in FIG. 61. As shown, end cap 5911 can include a first portion 5917, which first portion extends along first wall 5901. End cap 5911 can also include second portion 5915, which extends along second wall 5909. First portion 5917 and second portion 5915 can be of the same length, but can also be of different lengths. For example, first portion 5917 can have a length that is, e.g., from about 1 to about 100% longer than the length of second portion 5915. Alternatively, second portion 5915 can have a length that is from about 1 to about 100% longer than the length of first portion 5917.

As described elsewhere herein, a component can include a jacket that is secured to a wall of the component. Suitable jackets and attachments for the jackets are also described elsewhere herein.

Exemplary Insulating Articles

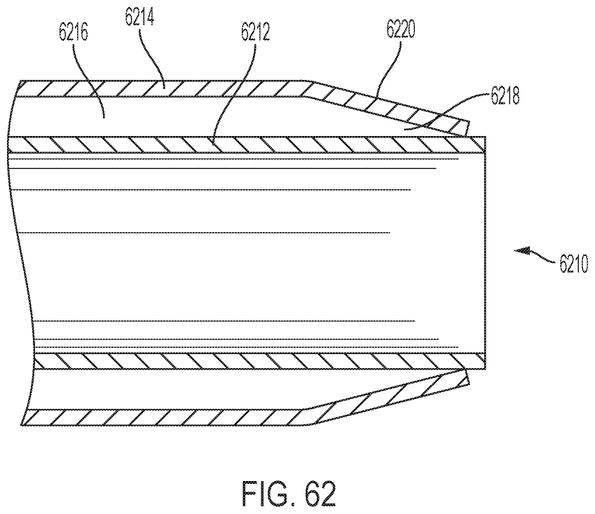

Referring to the drawings, where like numerals identify like elements, there is shown in non-limiting FIG. 62 an end portion of a structure 6210 according to the invention having gas molecule guiding geometry. Structure 6210 appears in FIG. 62 at a scale that was chosen for clearly showing the gas molecule guiding geometry of the invention. The invention, however, is not limited to the scale shown and has application to devices of any scale from miniaturized devices to devices having insulating spaces of very large dimensions. Structure 6210 includes inner and outer tubes 6212, 6214, respectively, sized and arranged to define an annular space 6216 therebetween. The tubes 6212, 6214 engage each other at one end to form a vent 6218 communicating with the vacuum space 6216 and with an exterior. The vent 6218 provides an evacuation path for egress of gas molecules from space 16 when a vacuum is applied to the exterior, such as when structure 6210 is placed in a vacuum chamber, for example.

PTC material (not shown) can be disposed along the inner surface of inner tube 6212. As described elsewhere herein, the PTC material can be separated from the surface of inner tube 6212 by one or more separator materials such that the PTC material does not contact directly the inner wall 6212. In some embodiments, inner wall 6212 itself comprises an amount of PTC material.

In other embodiments, outer tube 6214 can comprise PTC material. PTC material (not shown) can be disposed along the outer surface of outer tube 6214. The PTC material can be separated from the surface of outer tube 6214 by one or more separator materials such that the PTC material does not contact directly the outer tube 6214. Without being bound to any particular theory, having PTC material on the outer surface of outer tube 6214 allows for heating of the exterior of an article while the interior lumen of the article (enclosed by inner wall 6212) is thermally insulated from such heating.

The vent 18 is sealable in order to maintain a vacuum within the insulating space following removal of gas molecules in a vacuum-sealing process. In its presently preferred form, the space 6216 of structure 6210 is sealed by brazing tubes 6212, 6214 together. The use of brazing to seal the evacuation vent of a vacuum-sealed structure is generally known in the art. To seal the vent 6218, a brazing material (not shown) is positioned between the tubes 6212, 6214 adjacent their ends in such a manner that, prior to the brazing process, the evacuation path defined by the vent 6218 is not blocked by the material. During the evacuation process, however, sufficient heat is applied to the structure 10 to melt the brazing material such that it flows by capillary action into the evacuation path defined by vent 6218. The flowing brazing material seals the vent 6218 and blocks the evacuation path. A brazing process for sealing the vent 6218, however, is not a requirement of the invention. Alternative methods of sealing the vent 6218 could be used, such as a metallurgical or chemical processes.

The geometry of the structure 6210 effects gas molecule motion in the insulating space 6216 in the following manner. A major assumption of Maxwell's gas law regarding molecular kinetic behavior is that, at higher concentrations of gas molecules, the number of interactions occurring between gas molecules will be large in comparison to the number of interactions that the gas molecules have with a container for the gas molecules. Under these conditions, the motion of the gas molecules is random and, therefore, is not affected by the particular shape of the container. When the concentration of the gas molecules becomes low, however, as occurs during evacuation of an insulating space for example, molecule-to-molecule interactions no longer dominate and the above assumption of random molecule motion is no longer valid. As relevant to the invention, the geometry of the vacuum space becomes a first order system effect rather than a second order system effect when gas molecule concentration is reduced during evacuation because of the relative increase in gas molecule-to-container interactions.

The geometry of the insulating space 6216 guides gas molecules within the space 6216 toward the vent 6218. As shown in FIG. 62, the width of the annular space 6216 is not uniform throughout the length of structure 6210. Instead, the outer tube 6214 includes an angled portion 6220 such that the outer tube converges toward the inner tube 6212 adjacent an end of the tubes. As a result the radial distance separating the tubes 6212, 6214 varies adjacent the vent 6218 such that it is at a minimum adjacent the location at which the vent 6218 communicates with the space 6216. As will be described in greater detail, the interaction between the gas molecules and the variable-distance portion of the tubes 6212, 6214 during conditions of low molecule concentration serves to direct the gas molecules toward the vent 6218.

The molecule guiding geometry of space 6216 provides for a deeper vacuum to be sealed within the space 6216 than that which is imposed on the exterior of the structure 6210 to evacuate the space. This somewhat counterintuitive result of deeper vacuum within the space 6216 is achieved because the geometry of the present invention significantly increases the probability that a gas molecule will leave the space rather than enter. In effect, the geometry of the insulating space 6216 functions like a check valve to facilitate free passage of gas molecules in one direction (via the exit pathway defined by vent 6218) while blocking passage in the opposite direction.

As shown in FIG. 62, the angled portion 6220 of tube 6214 of structure 6210 extends to the end of tube 6214 as tube 6214 converges toward tube 6212. This is not a requirement, however, as a tube can include an angled portion that does not extend all the way to the immediate end of the tube. As one example, a tube can have a first region having a first inner diameter, which first region transitions to an angled region having a variable diameter, which angled region transitions to a second region having a second inner diameter; the first and second regions can even be parallel to one another. (The second inner diameter can be smaller than the first inner diameter.)

A benefit associated with the deeper vacuums provided by the geometry of insulating space 6216 is that it is achievable without the need for a getter material within the evacuated space 6216. The ability to develop such deep vacuums without a getter material provides for deeper vacuums in devices of miniature scale and devices having insulating spaces of narrow width where space constraints would limit the use of a getter material.

Although not required, a getter material could be used in an evacuated space having gas molecule guiding structure according to the invention. Other vacuum enhancing features could also be included, such as low-emissivity coatings on the surfaces that define the vacuum space. The reflective surfaces of such coatings, generally known in the art, tend to reflect heat-transferring rays of radiant energy. Limiting passage of the radiant energy through the coated surface enhances the insulating effect of the vacuum space.

The construction of structures having gas molecule guiding geometry according to the present invention is not limited to any particular category of materials. Metals and ceramics are suitable materials. Some suitable ceramic materials include, e.g., alumina (Al₂O₃,mullite, zirconia (ZrO₂) (including yttria-stabilized, yttira partially-stabilized, and magnesia partially-stabilized zirconia), silicon carbide, silicon nitride, and other glass-ceramic combinations.

Referring again to the structure 6210 shown in FIG. 62, the convergence of the outer tube 6214 toward the inner tube 6212 in the variable distance portion of the space 6216 provides guidance of molecules in the following manner. When the gas molecule concentration becomes sufficiently low during evacuation of space 6216 such that structure geometry becomes a first order effect, the converging walls of the variable distance portion of space 6216 will channel gas molecules in the space 6216 toward the vent 6218. The geometry of the converging wall portion of the vacuum 62 space 16 functions like a check valve or diode because the probability that a gas molecule will leave the space 6216, rather than enter, is greatly increased.

The effect that the molecule guiding geometry of structure 6210 has on the relative probabilities of molecule egress versus entry can be understood by analogizing the converging-wall portion of the vacuum space 6216 to a funnel that is confronting a flow of particles. Depending on the orientation of the funnel with respect to the particle flow, the number of particles passing through the funnel would vary greatly. It is clear that a greater number of particles will pass through the funnel when the funnel is oriented such that the particle flow first contacts the converging surfaces of the funnel inlet rather than the funnel outlet.

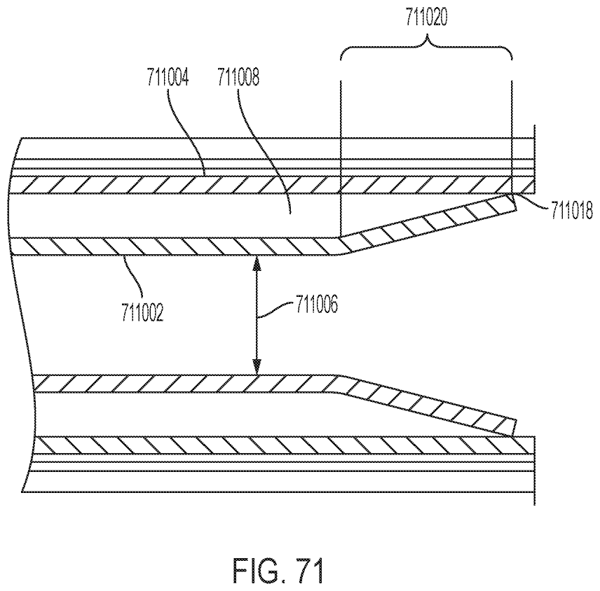

FIG. 71 provides a view of an alternative embodiment. As shown in that figure, an insulated article can include inner tube 711002 and outer tube 711004, which tubes define insulating space 711008 therebetween. Inner tube 711002 also defines a lumen within, which lumen can have a cross-section (e.g., diameter) 711006. Insulating space 711008 can be sealed by sealable vent 711018. As shown in FIG. 71, inner tube 711002 can include a portion 711020 that flares outward toward outer tube 711004, so as to converge towards outer tube 711004.

The convergence of the outer tube 711004 toward the inner tube 711002 in the variable distance portion of the space 711008 provides guidance of molecules in the following manner. When the gas molecule concentration becomes sufficiently low during evacuation of space 711008 such that structure geometry becomes a first order effect, the converging walls of the variable distance portion of space 1008 will channel gas molecules in the space 711008 toward the vent 711018. The geometry of the converging wall portion of the vacuum space 711008 functions like a check valve or diode because the probability that a gas molecule will leave the space 711008, rather than enter, is greatly increased.

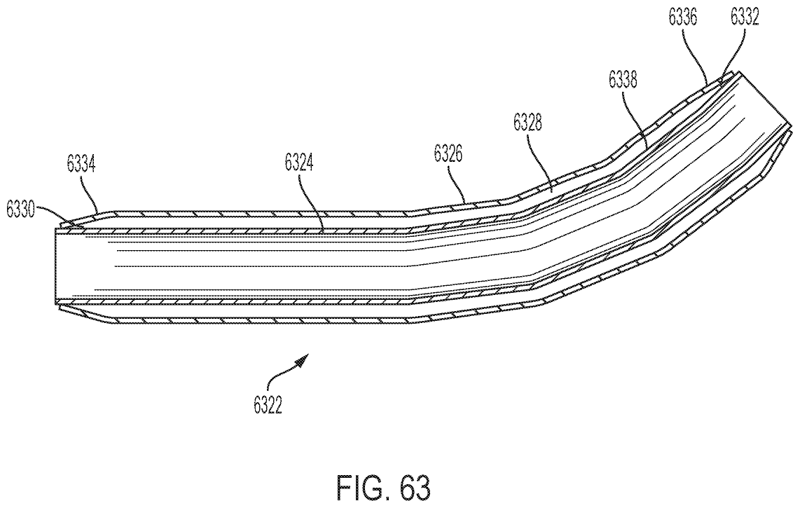

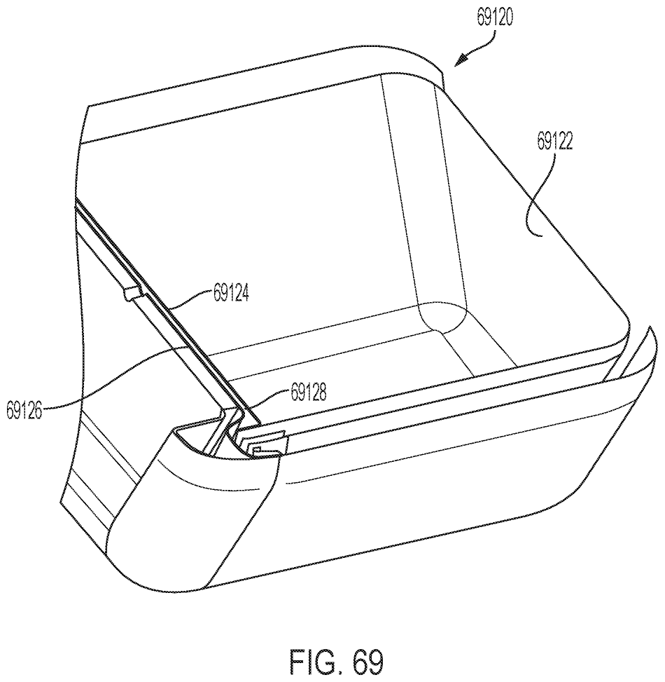

Various examples of devices incorporating a converging wall exit geometry for an insulating space to guide gas particles from the space like a funnel are shown in FIGS. 63-68. However, it should be understood that the gas guiding geometry of the invention is not limited to a converging-wall funneling construction and can, instead, utilize other forms of gas molecule guiding geometries. For example, the Dewar shown in FIG. 69 and described in greater detail below, incorporates an alternate form of variable distance space geometry according to the invention.

Some exemplary vacuum-insulated structures (and related techniques for forming and using such structures) can be found in United States published patent applications 2017/0253416; 2017/0225276; 2017/0120362; 2017/0062774; 2017/0043938; 2016/0084425; 2015/0260332; 2015/0110548; 2014/0090737; 2012/0090817; 2011/0264084; 2008/0121642; and 2005/0211711 and also in international application PCT/US2019/027682. All of the foregoing documents (and any priority applications cited therein) are incorporated herein by reference in their entireties for any and all purposes.

Insulated Probes

Referring to FIG. 63, there is shown a structure 6322 incorporating gas molecule guiding geometry according to the invention. Similar to structure 6210, structure 6322 includes inner and outer tubes 6324, 6326 defining an annular vacuum space 6328 therebetween. Structure 6322 includes vents 6330, 6332 and angled portions 6334, 6336 of outer tube 6326 at opposite ends that are similar in construction to vent 6218 and angled portion 6220 of structure 6210 of FIG. 62.

The structure 6322 can be useful, for example, in an insulated surgical probe. In such an application, it can be desirable that the structure 6322 be bent as shown to facilitate access of an end of the probe to a particular target site. In some embodiments, the concentrically arranged tubes 6324, 6326 of structure 6322 have been bent such that the resulting angle between the central axes of the opposite ends of the structure is approximately 45 degrees.

To enhance the insulating properties of the sealed vacuum layer, an optical coating 6328 having low-emissivity properties can be applied to the outer surface of the inner tube 6324. The reflective surface of the optical coating limits passage of heat-transferring radiation through the coated surface. The optical coating can comprise copper, a material having a desirably low emissivity when polished. Copper, however, is subject to rapid oxidation, which would detrimentally increase its emissivity. Highly polished copper, for example, can have an emissivity as low as approximately 0.02 while heavily oxidized copper can have an emissivity as high as approximately 0.78.

To facilitate application, cleaning, and protection of the oxidizing coating, the optical coating is preferably applied to the inner tube 6324 using a radiatively-coupled vacuum furnace prior to the evacuation and sealing process. When applied in the elevated-temperature, low-pressure environment of such a furnace, any oxide layer that is present will be dissipated, leaving a highly cleaned, low-emissivity surface, which will be protected against subsequent oxidation within the vacuum space 6328 when the evacuation path is sealed.

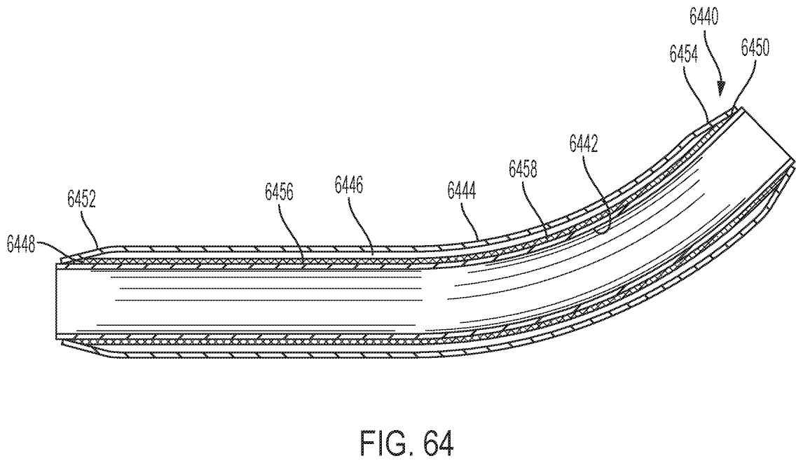

Referring to FIG. 64, there is shown another structure 6440 incorporating having gas molecule guiding geometry according to the invention. Similar to structure 6210 of FIG. 62, structure 6440 includes inner and outer tubes 6442, 6444 defining an annular vacuum space 6446 therebetween. Structure 6440 includes vents 6448, 6450 and angled portions 6452, 6454 of outer tube 6444 at opposite ends similar in construction to vent 6418 and angled portion 6220 of structure 6210 of FIG. 62. Preferably, the concentrically arranged tubes 6442, 6444 of structure 6440 have been bent such that the resulting angle between the central axes of the opposite ends of the structure is approximately 45 degrees. The structure 6440, similar to structure 6322 of FIG. 63, includes an optical coating 6456 applied to the outer surface of inner tube 6442.

When concentrically arranged tubes, such as those forming the vacuum spaces of the probes structures 6322 and 6440 of FIGS. 63 and 64, are subjected to bending loads, contact can occur between the inner and outer tubes while the loading is imposed. The tendency of concentric tubes bent in this fashion to separate from one another, or to “springback,” following removal of the bending loads can be sufficient to ensure that the tubes separate from each other. Any contact that does remain, however, could provide a detrimental “thermal shorting” between the inner and outer tubes, thereby defeating the intended insulating function for the vacuum space. To provide for protection against such thermal shorting, structure 6440 of FIG. 64 includes a layer 6458 of a spacer material, which is preferably formed by winding yarn or braid comprising micro-fibers, e.g., of ceramic or other low conductivity material. The spacer layer 58 provides a protective barrier that limits direct contact between the tubes.

Each of the structures of FIGS. 62 to 64 could be constructed as a stand-alone structure. Alternatively, the insulating structures of FIGS. 62 to 64 could form an integrated part of another device or system. Also, the insulating structures shown in FIGS. 62 to 64 can be sized and arranged to provide insulating tubing having diameters varying from sub-miniature dimensions to very large diameter and having varying length. In addition, as described previously, the gas molecule guiding geometry of the invention allows for the creation of deep vacuum without the need for getter material. Elimination of getter material in the space allows for vacuum insulation spaces having exceptionally small widths.

Joule-Thomson Devices

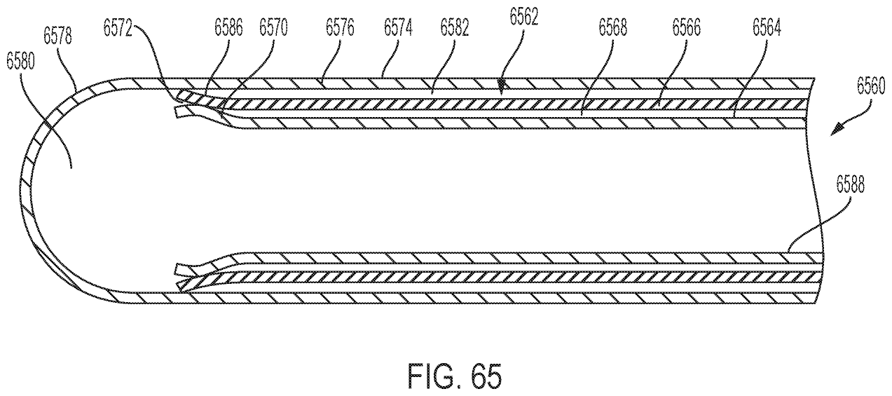

Referring to FIG. 65, there is shown a cooling device 6560 incorporating gas molecule guiding geometry according to the present invention for insulating an outer region of the device 6560. The device 6560 is cooled utilizing the Joules-Thomson effect in which the temperature of a gas is lowered as it is expanded. First and second concentrically arranged tubes 6564 and 6566 define an annular gas inlet 6568 therebetween. Tube 6564 includes an angled portion 6570 that converges toward tube 6566. The converging-wall portions of the tubes 6564, 6566 form a flow-controlling restrictor or diffuser 6572 adjacent an end of tube 6564.

The cooling device 6560 includes an outer jacket 6574 having a cylindrical portion 6576 closed at an end by a substantially hemispherical portion 6578. The cylindrical portion 6576 of the outer jacket 6574 is concentrically arranged with tube 6566 to define an annular insulating space 6582 therebetween. Tube 6566 includes an angled portion 6584 that converges toward outer jacket 6574 adjacent an evacuation path 6586. The variable distance portion of the insulating space 6582 differs from those of the structures shown in FIGS. 62-64 because it is the inner element, tube 6564, that converges toward the outer element, the cylindrical portion 6576. The functioning of the variable distance portion of insulating space 6582 to guide gas molecules, however, is identical to that described above for the insulating spaces of the structures of FIGS. 62-64.

The annular inlet 6568 directs gas having relatively high pressure and low velocity to the diffuser 6572 where it is expanded and cooled in the expansion chamber 80. As a result, the end of the cooling device 6560 is chilled. The expanded low-temperature/low-pressure is exhausted through the interior of the inner tube 6564. The return of the low-temperature gas via the inner tube 6564 in this manner quenches the inlet gas within the gas inlet 6568. The vacuum insulating space 6582, however, retards heat absorption by the quenched high-pressure side, thereby contributing to overall system efficiency. This reduction in heat absorption can be enhanced by applying a coating of emissive radiation shielding material on the outer surface of tube 6566. The invention both enhances heat transfer from the high-pressure/low-velocity region to the low-pressure/low-temperature region and also provides for size reductions not previously possible due to quench area requirements necessary for effectively cooling the high pressure gas flow.

The angled portion 6570 of tube 6564, which forms the diffuser 6572, can be adapted to flex in response to pressure applied by the inlet gas. In this manner, the size of the opening defined by the diffuser 6572 between tubes 6564 and 6566 can be varied in response to variation in the gas pressure within inlet 6568. An inner surface 6588 of tube 6564 provides an exhaust port (not seen) for removal of the relatively low-pressure gas from the expansion chamber 6580.

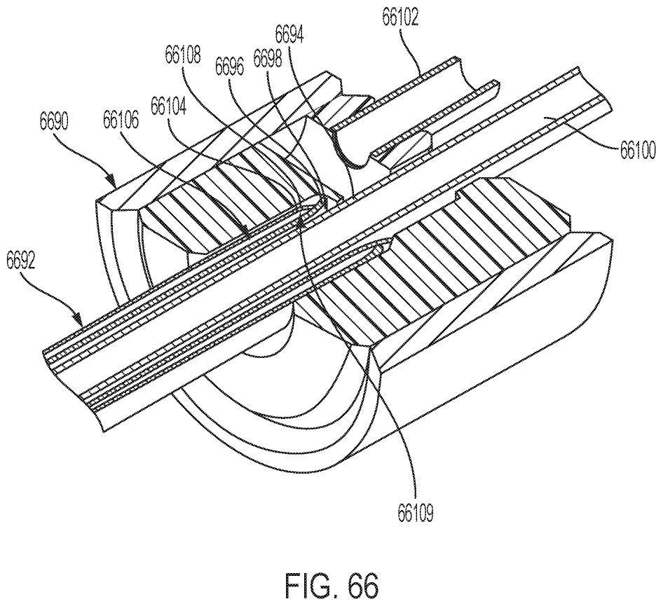

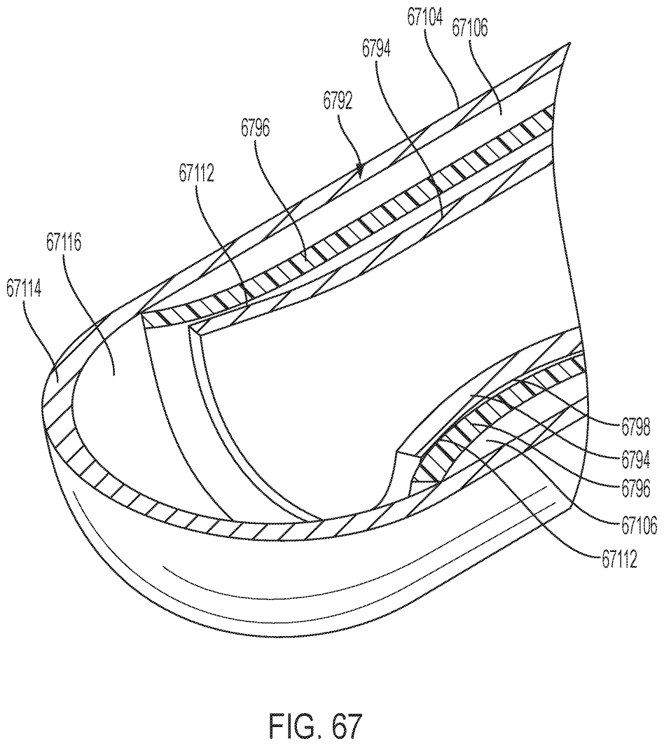

Referring to FIGS. 66 and 67, there is shown a cryogenic cooler 6690 incorporating a Joules-Thomson cooling device 6692. The cooling device 6692 of the cryogenic cooler 6690, similar to the device of FIG. 4, includes tubes 6694 and 6696 defining a high pressure gas inlet 6698 therebetween and a low-pressure exhaust port 66100 within the interior of tube 6694. The gas supply for cooling device 6690 is delivered into cooler 90 via inlet pipe 66102. An outer jacket 66104 forms an insulating space 66106 with tube 6696 for insulating an outer portion of the cooling device. The outer jacket 66104 includes an angled portion 66108 that converges toward the tube 6696 adjacent an evacuation path 66109. The converging walls adjacent the evacuation path 66109 provides for evacuation and sealing of the vacuum space 66106 in the manner described previously.

Referring to FIG. 67, the cooling device 6792 of the cryogenic cooler 6790 includes a flow controlling diffuser 67112 defined between tubes 6794 and 6796. A substantially hemispherical end portion 67114 of outer jacket 67104 forms an expansion chamber 67116 in which expanding gas from the gas inlet 6798 chills the end of the device 6792.

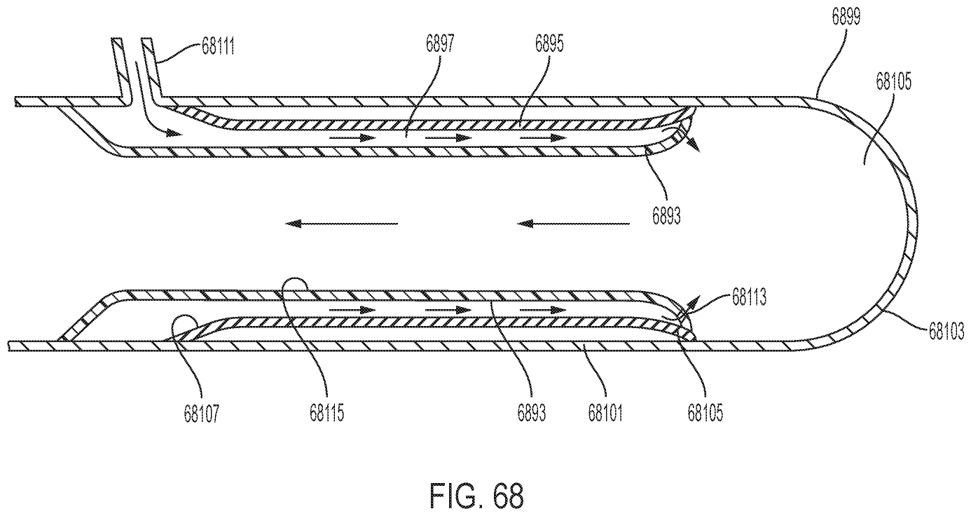

Referring to FIG. 68, there is shown a cooling device 6891 including concentrically arranged tubes 6893, 6895 defining an annular gas inlet 6897 therebetween. An outer jacket 6899 includes a substantially cylindrical portion 68101 enclosing tubes 6893, 6895 and a substantially semi-spherical end portion 68103 defining an expansion chamber 68105 adjacent an end of the tubes 6893, 6895. As shown, tube 6895 includes angled or curved end portions 68105, 68107 connected to an inner surface of the outer jacket 6899 to form an insulating space 68109 between the gas inlet 6897 and the outer jacket 6899. A supply tube 68111 is connected to the outer jacket adjacent end portion 68107 of tube 6895 for introducing gas into the inlet space 6897 from a source of the gas.

The construction of the gas inlet 6897 of cooling device 6891 adjacent the expansion chamber 68105 differs from that of the cooling devices shown in FIGS. 65-67, in which an annular escape path from the gas inlet was provided for delivering gas into the expansion chamber. Instead, tube 6893 of cooling device 6891 is secured to tube 6895 adjacent one end of the tubes 6893, 6895 to close the end of the gas inlet. Vent holes 68113 are provided in the tube 6893 adjacent the expansion chamber 68105 for injection of gas into the expansion chamber 68105 from the gas inlet 6897. Preferably, the vent holes 68113 are spaced uniformly about the circumference of tube 6893. The construction of device 6891 simplifies fabrication while providing for a more exact flow of gas from the gas inlet 6897 into the expansion chamber 68105.

A coating 68115 of material having a relatively large thermal conductivity, preferably copper, is formed on at least a portion of the inner surface of tube 93 to facilitate efficient transfer of thermal energy to the tube 93.

Non-Annular Devices

Each of the insulating structures of FIGS. 62-68 includes an insulating vacuum space that is annular. An annular vacuum space, however, is not a requirement of the invention, which has potential application in a wide variety of structural configurations. Referring to FIG. 69, for example, there is shown a vacuum insulated storage container 69120 having a substantially rectangular inner storage compartment 69122. The compartment 69122 includes substantially planar walls, such as wall 69124 that bounds a volume to be insulated. An insulating space 69128 is defined between wall 69124 and a second wall 69126, which is closely spaced from wall 69124. Closely spaced walls (not shown) would be included adjacent the remaining walls defining compartment 69122 to provide insulating spaces adjacent the container walls. The insulating spaces could be separately sealed or, alternatively, could be interconnected. In a similar fashion as the insulating structures of FIGS. 62-69, a converging wall portion of the insulating space 69128 (if continuous), or converging wall portions of insulating spaces (if separately sealed), are provided to guide gas molecules toward an exit vent. In the insulated storage container 69120, however, the converging wall portions of the insulated space 69128 is not annular.

The vacuum insulated storage container 69120 of FIG. 69 provides a container capable of indefinite regenerative/self-sustaining cooling/heating capacity with only ambient energy and convection as input energy. Thus, no moving parts are required. The storage container 69120 can include emissive radiation shielding within the vacuum insulating envelope to enhance the insulating capability of the vacuum structure in the manner described previously.

The storage container 69120 can also include an electrical potential storage system (battery/capacitor), and a Proportional Integrating Derivative (PID) temperature control system for driving a thermoelectric (TE) cooler or heater assembly. The TE generator section of the storage container would preferably reside in a shock and impact resistant outer sleeve containing the necessary convection ports and heat/light collecting coatings and or materials to maintain the necessary thermal gradients for the TE System. The TE cooler or heater and its control package would preferably be mounted in a removable subsection of a hinged cover for the storage container 69120. An endothermic chemical reaction device (e.g., a “chemical cooker”) could also be used with a high degree of success because its reaction rate would relate to temperature, and its effective life would be prolonged because heat flux across the insulation barrier would be exceptionally low.

Commercially available TE generator devices are capable of producing approximately 1 mW/in² with a device gradient of 20 deg. K approximately 6 mW/in² with a device gradient of 40 deg. K. Non-linear efficiency curves are common for these devices. This is highly desirable for high ambient temperature cooling applications for this type of system, but can pose problems for low temperature heating applications.

High end coolers have conversion efficiencies of approximately 60%. For example a 10 inch diameter container 10″ in height having 314 in² of surface area and a convective gradient of 20 deg. K would have a total dissipation capacity of approximately 30 mW. A system having the same mechanical design with a 40.degree. K convective gradient would have a dissipation capacity of approximately 150 mW.

Examples of potential uses for the above-described insulated container 120 include storage and transportation of live serums, transportation of donor organs, storage and transportation of temperature products, and thermal isolation of temperature sensitive electronics.

Alternate Molecule Guiding Geometry

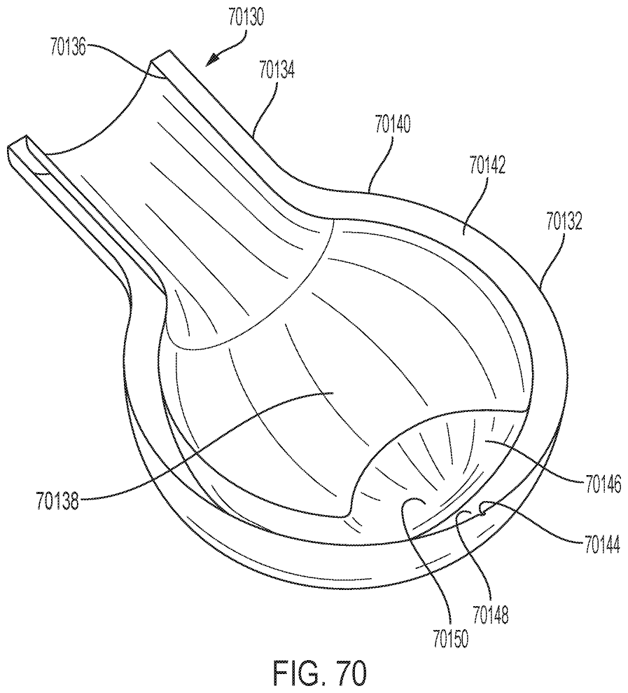

The present invention is not limited to the converging geometry incorporated in the insulated structure shown in FIGS. 62-69. Referring to FIG. 70, there is shown a Dewar 70130 incorporating an alternate form of gas molecule guiding geometry according to the invention. The Dewar 70130 includes a rounded base 70132 connected to a cylindrical neck 70134. The Dewar 70130 includes an inner wall 70136 defining an interior 70138 for the Dewar. An outer wall 70140 is spaced from the inner wall 70136 by a distance to define an insulating space 70142 therebetween that extends around the base 70132 and the neck 70134. A vent 70144, located in the outer wall 70140 of the base 70132, communicates with the insulating space 142 to provide an exit pathway for gas molecules during evacuation of the space 70142.

A lower portion 70146 of the inner wall 70136 opposite vent 70144 is indented towards the interior 70138, and away from the vent 70144. The indented portion 70146 forms a corresponding portion 70148 of the insulating space 70142 in which the distance between the inner and outer walls 70136, 70140 is variable. The indented portion 70146 of inner wall 70136 presents a concave curved surface 70150 in the insulating space 70142 opposite the vent 70144. Preferably the indented portion 70146 of inner wall 70136 is curved such that, at any location of the indented portion a normal line to the concave curved surface 70150 will be directed substantially towards the vent 70144. In this fashion, the concave curved surface 70150 of the inner wall 70136 is focused on vent 70144. The guiding of the gas molecules towards the vent 70144 that is provided by the focused surface 70150 is analogous to a reflector returning a focused beam of light from separate light rays directed at the reflector. In conditions of low gas molecule concentration, in which structure becomes a first order system effect, the guiding effect provided by the focused surface 70150 serves to direct the gas molecules in a targeted manner toward the vent 70144. The targeting of the vent 70144 by the focused surface 70150 of inner wall 70136 in this manner increases the probability that gas molecules will leave the insulating space 70142 instead of entering thereby providing deeper vacuum in the insulating space than vacuum applied to an exterior of the Dewar 70130.

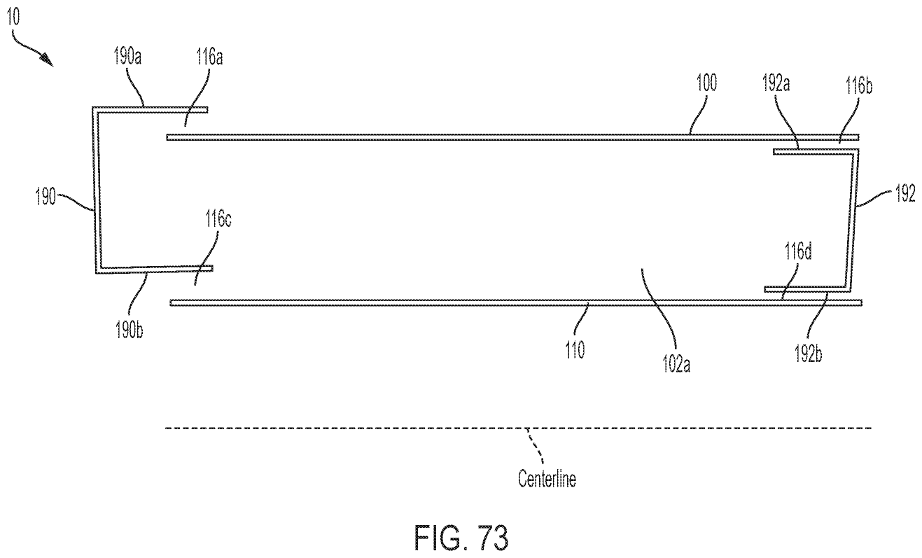

FIG. 73 provides a cutaway view of a component according to the present disclosure. As shown, walls 100 and 110 define a space 102a therebetween. A first cap 190 can include lands 190a and 190b. Lands 190a and 190b can be sealed, respectively, to wall 100 and wall 110. As shown in FIG. 2, first cap 190 defines a height that is less than or about equal to the distance between walls 100 and 110.

It should be understood that cap 190 can include (as shown) a flat portion that connects lands 190a and 190b. It should be understood, however, that lands 190a and 190b can be connected by a curved portion, which curved portion can be concave or even convex. Cap 190 can be U-shaped, in some embodiments. As shown, the shape of cap 190 can be a flat-bottomed U. As an example, the U can have two 90-degree corners.

A flat-bottomed U, however, is not a requirement. As shown in FIG. 50, a cap (190) can be U-shaped, with the U being curved. A cap can include—though it does not have to—first land 190a and second land 190b. (As shown in FIG. 50, cap 192 can be curved and be free of lands.)

As shown in FIG. 73, lands 190a and 190b can extend in or about in the same direction, relative to one another. A component can include a second cap 192, which second cap can include lands 192a and 192b. Lands 192a and 192b can be sealed, respectively, to walls 100 and 110.

As shown in FIG. 73, cap 192 can define a height that is less than or about equal to the distance between walls 100 and 110. Sealing can be effected by various techniques known in the art, including, e.g., brazing, adhesives, welding, sonic welding, and the like. Cap 190 can be constructed such that lands 190a and 190b overlap the exterior of walls 100 and 110.

As shown, lands 192a and 192b can extend in or about in the same direction, relative to one another. Space 102a can be at or below ambient pressure. As shown in FIG. 73, one or both of caps 190 and 192 can be convex relative to space 102a.

Also as shown in FIG. 73, lands 190a, 190b, 192a, and 192b can be overlapped by one or both of walls 100 and 110. As shown in FIG. 73, land 190a defines a vent with wall 100, land 190b defines a vent with wall 110, land 192a defines a vent with wall 100, and land 192b defines a vent with wall 110. The vents can be sealed simultaneously, but can also be sealed in a sequence. As one example, a user can first seal the vents defined by land 190a and wall 100 and land 192b and wall 110. In this way, the vents defined by land 190b and wall 100 and land 192a and wall 100 remain open and positioned diagonally (within space 102a) across from one another. It should be understood that either or both of caps 190 and 192 can be friction-fit against one or both of walls 100 and 110. As shown in FIG. 73, a portion of a cap (e.g., a land) can be disposed within the space between the walls, as shown by cap 192 in FIG. 73 and also a portion of a cap (e.g., the other land) can be disposed outside the space between the walls, as shown by cap 190 in FIG. 73.

Without being bound to any particular theory, the configuration in FIG. 73 (and in other disclosed embodiments) allows for multiple avenues by which molecules present in the space 102a between the walls (e.g., 100 and 110) can transit out of that space. As shown, vent 116a is formed with wall 100 and land 190a of cap 190, vent 116c is formed with wall 110 and land 190b of cap 190, vent 116b is formed with wall 100 and land 192a of cap 192, and vent 116d is formed by land 192b and wall 110. In this way, molecules present in the space 102a have multiple avenues for egress.

### Other Applications

The present invention has application for providing insulating layers in a wide range of thermal devices ranging from devices operating at cryogenic temperatures to high temperature devices. A non-limiting list of examples includes insulation for heat exchangers, flowing or static cryogenic materials, flowing or static warm materials, temperature-maintained materials, flowing gases, and temperature-controlled processes.

This invention allows direct cooling of specific micro-circuit components on a circuit. In the medical field, the present invention has uses in cryogenic or heat-therapy surgery, and insulates healthy tissue from the effects of extreme temperatures. An insulted container, such as container 70120, will allow the safe transport over long distances and extended time of temperature critical therapies and organs.

### EMBODIMENTS

The following non-limiting embodiments are illustrative only and do not serve the limit the scope of the present disclosure or the appended claims. It should be understood that all embodiments are combinable, in whole or in part.

Embodiment 1. A molecule excitation chamber, comprising: a first wall bounding an interior volume, the first wall comprising a main portion having a length and a projection portion having a length, the main portion optionally extending perpendicular to the projection portion; a second wall bounding the interior volume, the second wall comprising a main portion having a length and optionally comprising a projection portion having a length, (a) the projection portion of the first wall and the second wall defining a first vent therebetween, or (b) the second wall and the first wall defining a second vent therebetween, or (c) both (a) and (b), and the ratio of the length of the main portion of the first wall to the projection portion of the first wall being from about 1000:1 to about 1;1, and, optionally, a heat source configured to effect heating of molecules disposed within the interior volume of the molecule excitation chamber.

Embodiment 2. The molecule excitation chamber of Embodiment 1, wherein the second wall is configured to deflect molecules that collide with the second wall toward the first vent. This deflection can be accomplished by, e.g., the wall being angled and/or curved. The first wall can also be configured to deflect molecules that collide with the first wall toward the second vent.

Embodiment 3. The molecule excitation chamber of any one of Embodiments 1-2, wherein the molecule excitation chamber comprises a second vent.

Embodiment 4. The molecule excitation chamber of Embodiment 3, wherein the second vent is defined by the first wall and the projection portion of the second wall.

Embodiment 5. The molecule excitation chamber of any one of Embodiments 3-4, wherein the second vent is disposed opposite the first vent.

Embodiment 6. The molecule excitation chamber of Embodiment 5, wherein the space defines a major axis and wherein, a line drawn parallel to the major axis does not intersect both the first vent and the second vent.

Embodiment 7. The molecule excitation chamber of any one of Embodiments 1-6, wherein the space is sealed and further wherein the space is evacuated to a pressure of from about 0.0001 to about 700 Torr, e.g., from about 0.001 to about 70 Torr, from about 0.01 to about 7 Torr, or even about 1 Torr.

Embodiment 8. The molecule excitation chamber of Embodiment 7, wherein the space is evacuated to a pressure of from about 0.005 to about 5 Torr.

Embodiment 9. A method, comprising opening the first vent of a molecule excitation chamber according to any of Embodiments 1-8. The opening can be effected by, e.g, heating so as to effect thermal expansion of a wall or other component that defines the vent.

Embodiment 10. A method, comprising: assembling (a) a first wall comprising a main portion having a length and a projection portion having a length, the main portion optionally extending perpendicular to the projection portion, and the ratio of the length of the main portion of the first wall to the projection portion of the first wall being from about 1000:1 to about 1;1, and (b) a second wall comprising a main portion having a length and optionally comprising a projection portion having a length, the assembling being performed so as to define a first vent defined by the projection portion of the first wall and the second wall, and, sealing the first vent so as to seal a space between the first wall and the second wall.

Embodiment 11. The method of Embodiment 10, wherein the sealing is accomplished with a sealing material. Suitable sealing materials include, e.g., brazing materials, welding materials, and the like. The sealing can be effected under heating, and the heating can be applied such that one or both walls undergo thermal expansion so as to open a space into which brazing material can flow. The walls, brazing material, and heating can be accomplished such that under the heating, a space between the walls is formed, and then the brazing material flows into the space so as to fill the space. Heating can also be modulated to as to close the space between the walls.

Without being bound to any particular theory, one can utilize heating the disclosed components as a thermal valve. As one non-limiting example, a user can heat the walls (that define between them an insulating space that will be sealed by and end cap) and the end cap, and owing to the relatively smaller mass of the end cap, the end cap can expand so as to fit over (or fit against) one or both of the walls to facilitate sealing. By effecting this expansion, one can open an opening (which can be considered a vent) between the end cap and the wall, which opening can then facilitate evacuation of the space defined between the walls. In this way, one can use an end cap that under ambient temperature may not fit over a wall; by applying an appropriate temperature, one can expand the end cap as to allow the end cap to fit over the wall.

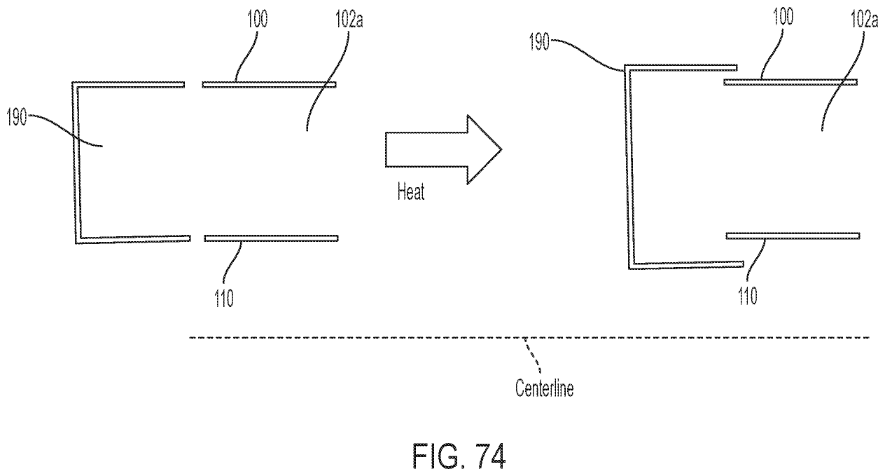

An example of the foregoing is shown by non-limiting FIG. 74. As shown, cap 190 does not initially fit around wall 100 and wall 110. Following application of heat, cap 190 has expanded such that there is space between the cap and the walls, which space can allow for the passage of molecules out of space 102a during the evacuation process. The cap can be sealed to the walls in the cap's expanded form. After the heat is reduced or removed, the cap contracts. Alternatively, one can heat one or both walls such that the walls expand in such a way that expansion of the walls gives rise to a space between the wall (or walls) and the cap. One can then utilize this space as a vent or passage through which molecules are evacuated.

Embodiment 12. The method of Embodiment 11, wherein the sealing material acts to at least partially occlude the first vent during sealing.

Embodiment 13. The method of Embodiment 12, wherein the sealing material forms a meniscus during sealing.

Embodiment 14. The method of Embodiment 10, wherein the first wall and the second wall define a second vent therebetween.

Embodiment 15. The method of Embodiment 14, wherein the second vent is defined by the first wall and a projection portion of the second wall.

Embodiment 16. The method of any of Embodiments 14-15, wherein the space defines a major axis and wherein, a line drawn parallel to the major axis does not intersect both the first vent and the second vent. A non-limiting example of this is provided in FIG. 1, in which a line parallel to line 150 does not intersect both vent 116 and vent 118.

Embodiment 17. The method of any of Embodiments 10-16, further comprising applying heat under conditions sufficient so as to give rise to a pressure within the space of from about 0.0001 to about 50 Torr.

Embodiment 18. The method of Embodiment 17, wherein the heat is applied so as to give rise to a pressure within the space of from about 0.005 to about 5 Torr.

Embodiment 19. An insulating component, comprising: a first wall bounding an interior volume; a second wall spaced at a distance from the first wall so as to define an insulating space between the first wall and the second wall; an inner surface of the second wall facing the insulating space, and an outer surface of the first wall facing the insulating space, (a) the first wall comprising an extension portion that (i) extends from a first end of the first wall toward the inner surface of the second wall and is optionally essentially perpendicular to the inner surface of the second wall and/or (ii) extends toward a second end of the first wall, the extension portion of the first wall optionally further comprising a land portion that is essentially parallel to the inner surface of the second wall, or (b) the second wall comprising an extension portion that (i) extends from a first end of the second wall toward the outer surface of the first wall and is optionally essentially perpendicular to the outer surface of the first wall and/or (ii) extends toward a second end of the second wall, the extension portion of the second wall optionally further comprising a land portion that is essentially parallel to the outer surface of the first wall, or both (a) and (b), and a first vent communicating with the insulating space to provide an exit pathway for gas molecules from the insulating space, the vent being sealable for sealing the insulating space following egress of gas molecules through the vent.

Embodiment 20. The insulating component of Embodiment 19, wherein the first and second walls are characterized, respectively, as a first tube and a second tube. It should be understood that in any embodiment herein, one or both walls can be tubular in configuration.

Embodiment 21. The insulating component of Embodiment 20, wherein the first and second tubes are arranged coaxial with one another.

Embodiment 22. The insulating component of any one of Embodiments 19-21, wherein the extension portion of the first wall defines a length LE1, as measured by a line perpendicular to the first wall.

Embodiment 23. The insulating component of Embodiment 22, wherein the first wall defines a length WL1, and wherein the ratio of LE1 to WL1 is from about 1:1000 to about 1:2.

Embodiment 24. The insulating component of Embodiment 23, wherein the ratio of LE1 to WL1 is from about 1:10 to about 1:5.

Embodiment 25. The insulating component of any one of Embodiments 19-24, wherein the extension portion of the second wall defines a length LE2, as measured by a line perpendicular to the second wall.

Embodiment 26. The insulating component of Embodiment 25, wherein the second wall defines a length WL2, and wherein the ratio of LE2 to WL2 is from about 1:1000 to about 1:2.

Embodiment 27. The insulating component of Embodiment 26, wherein the ratio of LE2 to WL2 is from about 1:100 to about 1:5.

Embodiment 28. The insulating component of any of Embodiments 19-27, wherein the second wall is configured such that effective conditions effect thermal expansion of the second wall relative to the first wall such that the first vent is opened.

Embodiment 29. The insulating component of any one of Embodiments 19-28, wherein the first vent is at least partially defined by the land portion of the first wall.

Embodiment 30. The insulating component of Embodiment 29, further comprising a second vent, the second vent being at least partially defined by the land portion of the second wall.

Embodiment 31. The insulating component of Embodiment 30, wherein, along a line extending parallel to the inner surface of the second wall, the first vent and the second vent do not overlap one another.

Embodiment 32. The insulating component of any one of Embodiments 19-31, further comprising a sealant that seals the first vent so as to seal the insulating space, the sealant optionally being disposed so as to at least partially occlude the first vent. Sealants can be, e.g., braze materials. An insulating component can include one or more heat exchange features; e.g., fins that extend from one or both of the first wall and the second wall.

Embodiment 33. A method, comprising communicating a fluid within the interior volume of an insulating component according to any one of Embodiments 19-32.

Embodiment 34. A method, comprising heating a material disposed at least partially within the interior volume of an insulating component according to any one of Embodiments 19-32. As described elsewhere herein, materials can be heated within any component according to the present disclosure. As described elsewhere herein, materials can be heated within any component according to the present disclosure.

Embodiment 35. The method of Embodiment 34, wherein the heating comprising heating the material without burning the material. As described elsewhere herein, materials can be heated within any component according to the present disclosure.

Embodiment 36. The method of any one of Embodiments 34-36, wherein the material comprises a smokable material, e.g., a plant-based material.

Embodiment 37. A method, comprising: with a first wall bounding an interior volume and a second wall spaced at a distance from the first wall, a volume defined between the first wall and the second wall, (a) the first wall comprising an extension portion that extends toward the second wall and is optionally essentially perpendicular to the inner surface of the second wall, the extension portion of the first wall optionally further comprising a land portion that is essentially parallel to the inner surface of the second wall, (b) the second wall comprising an extension portion that extends toward the outer surface of the first wall and is optionally essentially perpendicular to the outer surface of the first wall, the extension portion of the second wall optionally further comprising a land portion that is essentially parallel to the outer surface of the first wall, or both (a) and (b), and (c) the land portion of the first wall contacting the second wall so as to define a volume between the first wall and the second wall, (d) the land portion of the second wall contacting the first wall so as to define a volume between the first wall and the second wall, or both (c) and (d), heating the first wall and the second wall under conditions effective to effect thermal expansion of the second wall relative to the first wall, the thermal expansion giving give rise to or increasing a space between the land portion of the first wall and the second wall and/or giving rise to or increasing a space between the land portion of the second wall and the first wall, thereby allowing gas molecules to exit the volume defined between the first wall and the second wall.

Embodiment 38. The method of Embodiment 37, wherein the heating is performed at less than atmospheric pressure.

Embodiment 39. The method of any one of Embodiments 37-38, wherein the thermal expansion gives rise to or increases a space between the land portion of the first wall and the second wall.

Embodiment 40. The method of any one of Embodiments 37-39, wherein the thermal expansion gives rise to or increases a space between the land portion of the second wall and the first wall.

Embodiment 41. The method of any one of Embodiments 37-40, wherein the thermal expansion gives rise to or increases a space between the land portion of the first wall and the second wall and gives rise to or increases a space between the land portion of the second wall and the first wall.

Embodiment 42. The method of any one of Embodiments 37-41, wherein the heating is effective to effect sealing by a sealant of the space between the land portion of the first wall and the second wall and/or the space between the land portion of the second wall and the first wall.

Embodiment 43. An insulating component, comprising: a first wall bounding an interior volume; a second wall spaced at a distance from the first wall so as to define an insulating space between the first wall and the second wall; a first cap, the first cap at least partially sealing the insulating space defined between the first wall and the second wall, the first cap comprising a first land, the first land optionally sealed to the first wall, and the first cap further comprising a second land, the second land optionally sealed to the second wall. a first vent communicating with the insulating space to provide an exit pathway for gas molecules from the insulating space, the first vent being sealable for sealing the insulating space following egress of gas molecules through the vent.

Embodiment 44. The insulating component of Embodiment 43, wherein the first vent is defined by the first land and the first wall. The first vent can, in some embodiments, be defined between the second land and the second wall.

As described elsewhere herein, a cap can be sealed to the walls by way of, e.g., brazing, welding, adhesive, sonic welding, and the like. Sealing material (e.g., a ribbon of braze material) can be disposed at a distance from an end of the cap (see, e.g., FIG. 37 attached hereto and related description). Without being bound to any particular theory, the longer the distance (along the wall, in a direction away from the cap) from the end of cap to the sealing material, the less heat transfer between the interior volume and the environment exterior to the insulating component. Again without being bound by any particular theory, the reduction in heat transfer can be a result of the comparatively long heat path presented by a component in which the distance from the end of the cap to the sealing material is comparatively long.

Embodiment 45. The insulating component of any one of Embodiments 43-44, further comprising a second cap, the second cap at least partially sealing the insulating space defined between the first wall and the second wall.

Embodiment 46. The insulating component of Embodiment 45, wherein the second cap comprises a first land and a second land.

Embodiment 47. The insulating component of Embodiment 45, wherein the first land and the second land of the second cap extend in generally the same direction.

Embodiment 48. The insulating component of Embodiment 45, wherein the first land and the second land of the second cap extend in generally opposite directions.

Embodiment 49. The insulating component of any one of Embodiments 43-48, wherein the first land and the second land of the first cap extend in generally the same direction.

Embodiment 50. The insulating component of any one of Embodiments 43-48, wherein the first land and the second land of the first cap extend in generally opposite directions. An insulating component can include one or more heat exchange features; e.g., fins that extend from one or both of the first wall and the second wall.

Embodiment 51. The insulating component of any one of Embodiments 43-50, wherein (a) the first land of the first cap defines a height that varies around a perimeter of the cap, (b) the second land of the first cap defines a height that varies around a perimeter of the cap, or (a) and (b). Without being bound to any particular theory or embodiment, FIGS. 47-48 are illustrative of Embodiment 51.

Embodiment 52: A method, comprising: with an insulating component according to any one of Embodiments 43-51, communicating a fluid within the interior volume.

Embodiment 53: A method, comprising: with an insulating component according to any one of Embodiments 43-51, sealing the first land of the first cap to the first wall.

Embodiment 54: An insulating component, comprising: a first wall; a second wall, the first wall enclosing the second wall, the first wall comprising a sloped portion that extends toward the second wall (e.g., by converging or diverging) and the first wall also comprising a land portion that extends from the sloped portion, the second wall comprising a sloped portion that extends (e.g., by converging or diverging) toward the first wall, and the second wall also comprising a land portion that extends from the sloped portion, a third wall; a fourth wall, the third wall enclosing the fourth wall, the land of the first wall being sealed to the third wall and the land of the second wall being sealed to the fourth wall so as to at least partially seal a space between the first wall and the second wall that is in fluid communication with a space between the third wall and the fourth wall.

An example is provided by FIG. 44, described elsewhere herein. Also as described elsewhere herein (e.g., in FIG. 44), the land of the first wall and/or the land of the second wall can be formed so as to effect spring back against one or both of the third wall and the fourth wall.

It should be understood that any component disclosed herein can be used as a molecular excitation chamber. As one example, a heating source can be used to excite molecules within the component (i.e., molecules located in the space between the walls of the component). Upon application of the heating, at least some of the molecules will, by virtue of their motion, exit the space by way of a vent disposed between the walls of the component.

By virtue of collisions between the molecules themselves and/or the walls (or other features of the space between the walls), the moving molecules will, statistically, have a probability of existing the space by way of a vent. The egress of at least some of the molecules from the space in turn acts to lower the pressure within the space, and the user can then—by sealing the space following molecular egress—give rise to a permanently evacuated space. A user can place a so-called getter material into the space between the walls, but a getter is not a requirement, and the disclosed components can operate without the presence of a getter, i.e., they can be getter-free.

The disclosed components can be used in a variety of applications, including, without limitation: medical equipment, consumer products, instrumentation (e.g., spectroscopy equipment), firearms, exhaust systems. The disclosed components can be used in, e.g., vaping or e-cigarette devices, including those that operate using solid and/or liquid consumables. A material can be heated within a component; the heating can be performed to heat the material by burning, but the material can also be heated in a heat-not-burn fashion. Smokeable materials can be heated within components according to the present disclosure. Solids, liquids, and even gases can be disposed within a component according to the present disclosure.

Embodiment 55: An insulating component, comprising: a first wall bounding an interior volume; a second wall spaced at a distance from the first wall so as to define an insulating space between the first wall and the second wall; a first cap defining a curved profile, the first cap at least partially sealing the insulating space defined between the first wall and the second wall, a second cap defining a curved profile, the second cap comprising a first portion sealed to the first wall, the second cap further comprising a second portion sealed to the second wall, and the curved profile of first wall and the curved profile of the second wall being concave away from one another.

Embodiment 56. The insulating component of Embodiment 55, wherein the first cap is sealed to facing surfaces of the first wall and the second wall.

Embodiment 57. The insulating component of Embodiment 55, wherein the first cap is sealed to non-facing surfaces of the first wall and the second wall.

Embodiment 58. The insulating component of Embodiment 55, wherein the second cap is sealed to facing surfaces of the first wall and the second wall.

Embodiment 59. The insulating component of Embodiment 55, wherein the second cap is sealed to non-facing surfaces of the first wall and the second wall.

Embodiment 60. An insulating component, comprising: a second wall bounding at least a portion of an interior volume and defining a lumen therein, the interior volume defining a major axis; a first wall spaced at a distance from the second wall so as to define an insulating space between the first wall and the second wall; the interior volume defining a first cross-sectional dimension at a first location along the major axis and the interior volume defining a second cross-sectional dimension at a second location along the major axis.

Embodiment 61. The insulating component of Embodiment 60, wherein the second wall defines a (a) step-wise contraction located between the first location along the major axis and the second location along the major axis or (b) a step-wise expansion located between the first location along the major axis and the second location along the major axis.

Embodiment 62. The insulating component of Embodiment 61, wherein the step-wise contraction is defined by a 90 degree corner formed in the second wall.

Embodiment 63. The insulating component of any one of Embodiments 60-62, wherein the first wall defines a (a) tapered contraction located between the first location along the major axis and the second location along the major axis or (b) a tapered expansion located between the first location along the major axis and the second location along the major axis.

Embodiment 64. The insulating component of any one of Embodiments 60-63, wherein the first cross-sectional dimension is from 0.01 to about 100 times the second cross-sectional dimension.

Embodiment 65. The insulating component of any one of Embodiments 60-64, wherein the second cross sectional dimension is defined by the second wall.

Embodiment 66. The insulating component of any one of Embodiments 60-64, wherein the second cross sectional dimension is defined by the first wall.

Embodiment 67. The insulating component of any one of Embodiments 60-64, further comprising a data transmission element extending into the interior volume, the data transmission element extending through the second location along the major axis of the interior volume.

Embodiment 68. The insulating component of Embodiment 67, wherein the data transmission element extends through the first location along the major axis of the interior volume.

Embodiment 69. The insulating component of any one of Embodiments 60-68, further comprising a jacket at least partially enclosing the first wall.

Embodiment 70. The insulating component of Embodiment 69, wherein the jacket is secured at at least one location to the first wall.

Embodiment 71. The insulating component of any one of Embodiments 60-70, further comprising a fitting connected to the first wall.

Embodiment 72. The insulating component of Embodiment 71, wherein the fitting comprises a threading.

Embodiment 73. The insulating component of any one of Embodiments 60-72, wherein the component (i) defines a first region having a first length measured along the major axis, the first region being characterized as having the first cross-sectional dimension and (ii) defines a second region having a second length measured along the major axis, the second region being characterized as having the second cross-sectional dimension.

Embodiment 74. The insulating component of Embodiment 73, wherein the ratio of the first length to the second length is from about 1:100 to about 100:1.

Embodiment 75. The insulating component of any one of Embodiments 60-72, further comprising an electronic component disposed within the interior volume.

Embodiment 76. A method, comprising communicating or retaining a fluid within the interior volume of an insulating component according to any one of Embodiments 60-75.

Embodiment 77. An insulating component, comprising: a first wall and a second wall, the first wall and second wall defining a sealed insulating space therebetween; a third wall and a fourth wall, the third wall and the fourth wall defining a sealed insulating space; and the second wall and third wall defining an interstitial space therebetween.

Embodiment 78. The insulating component of Embodiment 77, wherein the interstitial space is sealed.

Embodiment 79. The insulating component of any one of Embodiments 77-78, further comprising an insulating material disposed within the interstitial space.

Embodiment 80. The insulating component of Embodiment 79, wherein the insulating material comprises a refractory fibrous material, a refractory porous material, or any combination thereof.

Embodiment 81. The insulating component of Embodiment 80, wherein the insulating material comprises a ceramic.

Embodiment 82. The insulating component of Embodiment 81, wherein the insulating component comprises alumina.

Embodiment 83. A method, comprising communicating or retaining a fluid within the lumen of an insulating component according to any one of Embodiments 77-82.

Embodiment 84. An insulating component, comprising: (i) a first vessel comprising (a) a second wall bounding at least a portion of an interior volume, the interior volume defining a major axis and (b) a first wall spaced at a distance from the first wall so as to define a sealed insulating space between the first wall and the second wall; (ii) a feedthrough portion comprising (a) a first feedthrough wall and (b) a second feedthrough wall, the first feedthrough wall and the second feedthrough wall defining a sealed insulated space therebetween, the second feedthrough wall defining a lumen therein, the lumen of the feedthrough portion being in fluid communication with the interior volume of the first vessel.

Embodiment 85. The insulating component of Embodiment 84, wherein the first vessel defines a major axis, the feedthrough portion defines a major axis, and the major axis of the first vessel is offset by an angle from the major axis of the feedthrough portion.

Embodiment 86. The insulating component of Embodiment 84, wherein the first vessel defines a major axis, the feedthrough portion defines a major axis, and the major axis of the first vessel does not intersect the major axis of the feedthrough portion.

Embodiment 87. The insulating portion of any one of Embodiments 84-86, wherein the first vessel defines a length, wherein the feedthrough portion defines a length, and wherein the ratio of the length of the first vessel and the length of the feedthrough portion is from about 1:1 to about 1:100.

Embodiment 88. The insulating portion of any one of Embodiments 84-87, wherein the feedthrough portion is characterized as being flexible.

Embodiment 89. The insulating component of Embodiment 84, wherein the first vessel defines a major axis, the feedthrough portion defines a major axis, and the major axis of the first vessel is coaxial with the major axis of the feedthrough portion.

Embodiment 90. The insulating component of any one of Embodiments 84-89, further comprising a signal carrier extending from the lumen of the feedthrough portion into the interior volume of the first vessel.

Embodiment 91. The insulating component of Embodiment 90, wherein the signal carrier comprises an electrical conductor, a fiber optic, or any combination thereof.

Embodiment 92. The insulating component of any one of Embodiments 84-91, further comprising a tube extending from the lumen of the feedthrough portion into the interior volume of the first vessel.

Embodiment 93. The insulating component of any one of Embodiments 84-92, further comprising a jacket at least partially enclosing the first wall.

Embodiment 94. The insulating component of Embodiment 93, wherein the jacket is secured at at least one location to the first wall.

Embodiment 95. The insulating component of any one of Embodiments 84-94, further comprising a fitting connected to the first wall.

Embodiment 96. The insulating component of Embodiment 95, wherein the fitting comprises a threading.

Embodiment 97. An insulated article comprising: a first wall bounding an interior volume; a second wall spaced at a distance from the first wall to define an insulating space therebetween, the first and second walls being of the same or different materials; and a vent communicating with the insulating space to provide an exit pathway for gas molecules from the space, the vent being sealable for maintaining a vacuum within the insulating space following evacuation of gas molecules through the vent, the distance between the first and second walls being variable in a portion of the insulating space adjacent the vent such that gas molecules within the insulating space are directed towards the vent by the variable-distance portion of the first and second walls during the evacuation of the insulating space, the directing of the gas molecules by the variable-distance portion of the first and second walls imparting to the gas molecules a greater probability of egress from the insulating space than ingress, and (a) a positive thermal coefficient (PTC) material being at least partially disposed within the interior volume, (b) the first wall at least partially comprising a PTC material, (c) the second wall at least partially comprising a PTC material, (d) a PTC material being disposed exterior to the second wall, or any combination of (a), (b), (c), and (d).

The first and second walls can be formed of the same or different materials. As one example, both the first and second walls can be formed of alumina. In another example, the first wall is formed of alumina, and the second wall is formed of zirconia. One or both of the first and second walls can comprise a metal (including metal alloys).

The PTC material can be disposed along a surface of one of the walls, e.g., an inner wall of the insulated article. The PTC material can contact the wall material directly, but can also be spaced apart from the wall material by one or more separating materials, e.g., wall coatings. Such separating materials can be thermal insulators, e.g., ceramics.

The PTC material can be present as a layer that covers some or all of a surface of a wall. The PTC material can be present in the form of a continuous trace, e.g., a zig-zag, serpentine, ribbon, or coil. A trace may wrap around at least some of a tube-form wall, e.g., analogous to a striped barber pole. PTC material can also be present in the form of strips, which strips can be discrete from one another (e.g., as coaxial rings spaced apart from one another), or can be placed in electrical communication with one another, e.g., by a conductive material or even by a portion of PTC material. PTC material can be placed along a surface at any point in the fabrication process of an article according to the present disclosure. In a concentric tube embodiment with the first tube as the inner tube and the second tube as the outer tube, PTC material can be disposed within the inner tube. PTC material can also be disposed exterior to the outer (second) tube. In such an embodiment, the interior volume of the article is thermally insulated from the PTC material (which can be comprised within a PTC heater) that is exterior to the second outer (second) tube.

PTC material can be arranged so as to give rise to a temperature gradient along a direction of the article. For example, PTC material may be present at a relatively high density at a first end of a lumen of an article according to the present disclosure and a relatively low density at the second end of the lumen, thus giving rise to a higher temperature (during PTC heater operation) at the first end of the lumen. In some embodiments, different types of PTC material can be used in a single article such that the article can include a region of a first PTC material and a region of a second PTC material wherein the first PTC material operates at a temperature higher than the operating temperature of the second PTC material.

One or both of the walls can also comprise a PTC material. The first and second walls can comprise the same PTC material, but can also comprise different PTC materials.

As non-limiting examples, PTC material can be placed before, during, or even after the evacuation of the insulating space between the walls. As described elsewhere herein, one or more of the walls can also comprise a PTC material. PTC material can be present in a portion having a uniform thickness, but can also be present in a portion having a varying thickness.

In some embodiments, the PTC material has a thermal coefficient that is different (e.g., greater) than the thermal coefficient of one or both of the first and second walls. The PTC material can have a thermal coefficient that is greater than one or both of the thermal coefficients of the first and second walls. The PTC material can have, e.g., a thermal coefficient that is from more than 1 to about to 10,000 times, or from about 2 to about 5,000 times, or from about 5 to about 1,000 times, or from about 10 to about 500 times, or from about 50 to about 250 times one or both of the thermal coefficients of the first and second walls. The PTC material can have a thermal coefficient that is less than one or both of the thermal coefficients of the first and second walls.

Without being bound to any particular theory, the PTC material can be utilized as a PTC heater and can be comprised in a PTC heater. Such heaters are self-regulating heaters that can operate without external controls. As distinct from standard fixed-resistance heaters (described elsewhere herein), PTC heaters utilize PTC materials that effectively heat less the hotter they become, i.e., the materials exhibit a positive resistance change in response to an increase in temperature. As the material's temperature increases, the electrical resistance of the material also increases, which in turn limits the current that can flow through the material. In this way, PTC materials allow more current to pass when the materials are cold, and allow less current to pass when the materials reach higher (or even threshold) temperatures. In this way, a PTC heater acts to regulate its own temperature, and does not need an external control system. Because a PTC heater is self-regulating, such a heater has no risk of overheating. Furthermore, as the heat in the PTC increases, the power consumption of the device drops, which in turn makes for a very efficient heater. PTC heaters can operate in a comparatively wide range of temperatures. A PTC heater can even comprise one, two, three, or more temperature zones. Thus, the PTC material of an article according to the present disclosure can be in connection with a source of electrical current, e.g., a battery or other power source.

The converging portion of a wall can be adjacent to an end of the associated wall. In some embodiments; the converging portion of a wall can even terminate at an end of the associated wall. In some embodiments, the converging portion of a wall can terminate at a distance from an end of the associated wall.

Embodiment 98. The insulated article according to Embodiment 97, wherein one of the walls includes a portion that converges toward the other wall adjacent the vent, and wherein the distance between the walls is at a minimum adjacent the location at which the vent communicates with the insulating space.

As explained elsewhere herein, the converging portion can be present in the inner or outer of the two walls. It should be understood that the term “converging” means to approach. As one example, in FIG. 1, the angled portion 20 of tube 14 approaches (i.e., converges towards) tube 12. Thus, in this embodiment, the inner diameter of tube 14 is reduced along the length of the portion of the tube where the tube 14 approaches tube 12.

In one embodiment, the inner of the two tubes can flare outwards (i.e., having an increasing outside diameter) toward the outer of the tubes, thus forming a vent between the two tubes. The inner tube can be said to be converging toward the outer tube.

As described elsewhere herein, FIG. 10 provides a view of this alternative embodiment. As shown in that figure, an insulated article can include inner tube 1002 and outer tube 1004, which tubes define insulating space 1008 therebetween. Inner tube 1002 also defines a lumen within, which lumen can have a cross-section (e.g., diameter) 1006. Insulating space 1008 can be sealed by sealable vent 1018. As shown in FIG. 10, inner tube 1002 can include a portion 1020 that flares outward toward outer tube 1004, so as to converge towards outer tube 1004.

Embodiment 99. The insulated article according to Embodiment 97, wherein the first and second walls are provided by first and second tubes arranged substantially concentrically so as to define an annular space therebetween. The first and second tubes can be separated by, e.g., 0.004 to 0.010 inches, in some non-limiting embodiments.

Embodiment 100. The insulated article according to Embodiment 99, wherein the converging wall portion of the one of the walls is located adjacent an end of the associated tube.

Embodiment 101. The insulated article according to Embodiment 99, wherein the wall including the converging portion is comprised in an outer one of the tubes.

Embodiment 102. The insulated article according to Embodiment 97 further comprising a coating disposed on a surface of the one of the walls, the coating formed by a material having an emissivity that is less than that of the wall on which it is disposed.

Embodiment 103. The insulated article according to Embodiment 97, further comprising a material disposed between the first and second tubes so as to reduce direct contact between the first and second tubes. Such a material can be one that has a comparatively low thermal conductivity; in some embodiments, the material can have a thermal conductivity that is lower than the thermal conductivity of one or both of the walls separated by the material.

Embodiment 104. The insulated article according to Embodiment 103, wherein the material comprises thread, fiber, yarn, or any combination thereof.

Embodiment 105. The insulated article according to Embodiment 103, wherein the material comprises a reflective material.

Embodiment 106. The insulated article according to Embodiment 103, wherein the material comprises a ceramic.

Embodiment 107. The insulated article according to Embodiment 99, further comprising: a third tube located within the insulating space between the first and second tubes, the third tube being arranged substantially concentric to the first and second tubes. The third tube can comprise a ceramic material. The third tube can be comprised of a material that is the same or different from the material of the first and/or second tubes.

Embodiment 108. The insulated article according to Embodiment 97, wherein the article is a container and wherein the first wall defines a substantially rectangular storage space.

Embodiment 109. The insulated article according to Embodiment 98, wherein the vent is defined by an opening in one of the walls and wherein a portion of the other of the walls opposite the vent is arranged such that a tangent line at each location within the portion of the other of the walls is directed substantially towards the vent.

Embodiment 110. The insulated article according to any one of Embodiments 97-109, wherein the PTC material is comprised in a heater.

Embodiment 111. The insulated article of any one of Embodiments 97-110, wherein the PTC material comprises a polycrystalline ceramic. As an example, doped polycrystalline ceramics can be used as PTC materials. Barium titanate can be used as a PTC material.

Thermoplastic polymers with conductive fillers can be used as PTC materials. Some example thermoplastics are, e.g., high-density polyethylene, linear low-density polyethylene, low-density polyethylene, mid-density polyethylene, maleic anhydride functionalized polyethylene, a maleic anhydride functionalized elastomeric ethylene copolymer, am ethylene-butene copolymer, an ethylene-octene copolymer, an ethylene-acrylate copolymer, glycidyl methacrylate modified polyethylene, polypropylene, maleic anhydride functionalized polypropylene, glycidyl methacrylate modified polypropylene, polyvinyl chloride, polyvinyl acetate, polyvinyl acetyl, acrylic resin, syndiotactic polystyrene, polyphenylene-sulfide, polyamideimide, polyimide, polyetheretherketone, polyetherketone, polyethylene vinyl acetate, glycidyl methacrylate modified polyethylene vinyl acetate, polyvinylalcohol, polyisobutylene, poly(vinylidene chloride), poly(vinylidene fluoride), poly(methylacrylate), polyacrylonitrile, polybutadiene, polyesters, polyethylene-terephthalate, polybutylene-terephthalate, poly(8-aminocaprylic acid), poly(vinyl alcohol), polycaprolactone, polyamides like PA11, PA12, PA6, PA6.6, PA 6.10, polyphthalamide, high temperature nylon, or combinations thereof. Pure metals can be used as PTC materials.

A PTC material can have a temperature coefficient of resistance (alpha per degree C., at 20 degrees C.) in the range of from 0.0001 to about 0.007, or from about 0.0005 to about 0.003, or from about 0.0009 to about 0.001, and all intermediate values.

Embodiment 112. The insulated article of any one of Embodiments 97-111, further comprising an amount of a smokeable material disposed so as to be heatable by the PTC material. Such smokeable material can comprise tobacco, for example.

Embodiment 113. The insulated article of Embodiment 112, wherein the smokeable material is at least partially disposed within the interior volume. The smokeable material can be present in loose form (e.g., tobacco leaves), in a compacted form, a cartridge, a capsule, and the like—consumable portions of smokeable material are considered suitable. In some embodiments, the smokeable material can be disposed external to the interior volume. As an example, the smokeable material could be disposed about the outer tube of an inner-outer tube arrangement.

Embodiment 114. A method, comprising: applying a current to the PTC material of an insulated article according to any one of Embodiments 97-113 so as to effect heating of the PTC material. The current can be constant, but can also be varying with time.

Embodiment 115. The method of Embodiment 114, wherein the applying is effected so as to give rise to heating a smokeable material.

Embodiment 116. The method of Embodiment 115, wherein the applying is effected so as to give rise to heating the smokeable material without burning the smokeable material.

Embodiment 117. An insulated article comprising: a first wall bounding an interior volume; a second wall spaced at a distance from the first wall, a sealed insulating space defined between the first wall and the second wall; and (a) a positive thermal coefficient (PTC) material being at least partially disposed within the interior volume, (b) the first wall at least partially comprising a PTC material, (c) the second wall at least partially comprising a PTC material, (d) a PTC material being disposed exterior to the second wall, or any combination of (a), (b), (c), and (d).

As described elsewhere herein, the PTC material can be disposed within the interior volume of the article. The PTC material can be comprised in a heater device. In some embodiments, at least a portion of the first wall comprises PTC material. At least a portion of the second wall can comprise PTC material. PTC material can be disposed exterior to the second wall, e.g., on the outside face of the second wall when the second wall is a tube. As described elsewhere herein, PTC material can contact the first wall or the second wall, but this is not a requirement. Separation material can be disposed between the PTC material and the first wall and/or second wall so as to reduce or eliminate contact between the PTC material and the first and/or second wall.

The sealed insulating space can be an air gap, i.e., the space is at atmospheric pressure. The space can be filled with air, though this is not a requirement, as the space can also be filled with other gases and gas mixtures. The pressure within the space can be ambient (atmospheric) pressure.

Embodiment 118. The insulated article of Embodiment 117, wherein the first wall and the second wall are characterized as tubes.

Embodiment 119. The insulated article of any Embodiment 117, further comprising a material disposed between the first and second tubes so as to reduce direct contact between the first and second tubes.

Embodiment 120. The insulated article according to Embodiment 119, wherein the material comprises thread, fiber, yarn, or any combination thereof.

Embodiment 121. The insulated article according to Embodiment 120, wherein the material comprises a reflective material.

Embodiment 122. The insulated article according to Embodiment 119, wherein the material comprises a ceramic.

Embodiment 123. The insulated article according to Embodiment 120, further comprising: a third tube located within the insulating space between the first and second tubes, the third tube being arranged substantially concentric to the first and second tubes.

Embodiment 124. The insulated article according to any one of Embodiments 117-123, wherein the PTC material is comprised in a heater.

Embodiment 125. The insulated article of any one of Embodiments 117-124, wherein the PTC material comprises a polycrystalline ceramic.

Embodiment 126. The insulated article of any one of Embodiments 117-125, further comprising an amount of a smokeable material disposed so as to be heatable by the PTC material. Suitable smokeable materials are described elsewhere herein.

Embodiment 127. The insulated article of Embodiment 126, wherein the smokeable material is at least partially disposed within the interior volume. In some embodiments, the smokeable material can be disposed external to the interior volume. As an example, the smokeable material could be disposed about the outer tube of an inner-outer tube arrangement.

Embodiment 128. A method, comprising: applying a current to the PTC material of an insulated article according to any one of Embodiments 117-127 so as to effect heating of the PTC material.

Embodiment 129. The method of Embodiment 128, wherein the applying is effected so as to give rise to heating a smokeable material.

Embodiment 130. The method of Embodiment 129, wherein the applying is effected so as to give rise to heating the smokeable material without burning the smokeable material.

The disclosed articles can be used in a variety of applications. As one example, the disclosed articles can be used in heat-not-burn devices used by consumers with smokeable materials. The disclosed articles can be used as heating systems in heat-not-burn smoking systems (as well as heat-and-burn smoking systems). As an example, European patent application EP 2 316 286 provides an illustrative electrically heated smoking system into which the disclosed articles can be incorporated as heaters. By virtue of their self-regulated temperature, the disclosed articles are well-suited to heat-not-burn applications, as the articles can be configured to apply heat up to—but not above—a certain temperature. As an example, an article according to the present disclosure can be configured to heat a smokeable material at a temperature of, e.g., 50-400 deg C., 70-350 deg C., 90-300 deg. C., 100-250 deg C., or even 150-200 deg C. The temperature achieved by a PTC article according to the present disclosure can be effected by the choice of PTC material, the amount of PTC material (e.g., the placement of PTC material within the article), the current applied to the PTC material, and other variables that will be known to those of ordinary skill in the art.

As another example, the disclosed devices can also be used in exhaust systems, e.g., to reduce cold starts and/or dosing requirements. In one embodiment, the disclosed devices can be used to pre-heat one or more components of an exhaust system (including a catalytic converter). This can be done so as to bring the catalytic converter to operating temperature and/or to maintain the catalytic converter at operating temperature. This can be done so as to reduce the emissions associated with so-called cold starts of catalytic converters; it is known that catalytic converters are less effective before they have achieved their operating temperature. The disclosed articles can also be used to maintain a heated component in its heated state. As one example, a PTC article according to the present disclosure can be utilized to heat a automobile's catalytic converter so as to avoid (or reduce) cold starting of that catalytic converter. The insulating characteristics of the article can then be used to maintain the temperature of the catalytic converter after use so as to avoid (or reduce) cold starting of that catalytic converter when the automobile is next used. A catalytic converter can be at least partially disposed within an article according to the present disclosure. A catalytic converter can also comprise an article according to the present disclosure. An article according to the present disclosure can also be incorporated into an exhaust system. As an example, exhaust (e.g., from an internal combustion unit) can be communicated within an article according to the present disclosure.

The disclosed articles can also be used in, e.g., systems that supply steam for coffee steamers. The disclosed articles can be used to provide a heated conduit through which water and/or steam is flowed. In some embodiments, the conduit is sufficiently heated such that the conduit is hot enough to vaporize water flowed through the conduit. In some embodiments, the conduit is sufficiently heated such that the conduit is hot enough to maintain in vapor form steam that is flowed through the conduit. The disclosed articles can also be used in instant-hot water systems wherein fluid is flowed through the (heated) lumen of an article according to the present disclosure. As described elsewhere herein, by using the disclosed PTC approach, the lumen's temperature is controlled and does not exceed a threshold temperature, thereby increasing the safety for the user. Thus, the disclosed articles can be used in systems that effect fluid heating while the fluid is flowed through a conduit, the conduit comprising an article according to the present disclosure.

The disclosed articles can be used in heaters, including (without limitation) heaters for aircraft applications, heaters for automotive applications, heaters for marine applications, and the like.

The disclosed articles can also be utilized to provide spectral (e.g., thermal) signals. As one example, one or more of the disclosed articles (e.g., two, three, or more articles) can be activated so as to present a thermal signature to the environment. The thermal signature of an article can be tailored to reflect a particular desired signature, e.g., the thermal signature of a small engine or the thermal signature of an animal. The disclosed articles can be used in systems that provide multiple thermal spectra to the environment, e.g., an array of articles, each of which provides a thermal signature so as to guide night-time workers and/or vehicle operators to a particular location. As one example, articles according to the present disclosure can be arrayed in a chevron, stripes, or other pattern so as to guide users with thermal detection capabilities to a particular location, such as a unmarked entrance or rendezvous location.

Alternatively, the disclosed articles can be used to provide a particular thermal signature that mimics the profile of a particular object or location, e.g., a collection of idling vehicles, a camping stove, personnel, animals, armaments, and the like. In this way, the disclosed articles can be used to provide a thermal signature which can be used to camouflage activities.

Embodiment 131. An insulating component, comprising: a first wall bounding an interior volume; a second wall spaced at a distance from the first wall so as to define an insulating space between the first wall and the second wall; and an end cap defining an M-shaped cross-sectional profile, the end cap comprising a portion that extends along the first wall, the end cap comprising a portion that extends along the second wall, the end cap comprising a portion that extends into the insulating space, the end cap at least partially sealing the insulating space defined between the first wall and the second wall.

Embodiment 132. The insulating component of claim 131, wherein the end cap comprises a curved portion.

Embodiment 133. The insulating component of claim 132, wherein the curved portion extends into the insulating space.

Embodiment 134. The insulating component of claim 132, wherein the curved portion hooks over an edge of the first wall.

Embodiment 135. The insulating component of claim 132, wherein the curved portion hooks over an edge of the second wall.

Embodiment 136. The insulating component of claim 131, wherein the end cap comprises a cornered portion.

Embodiment 137. The insulating component of claim 136, wherein the cornered portion extends into the insulating space.

Embodiment 138. The insulating component of claim 136, wherein the cornered portion hooks over an edge of the first wall.

Embodiment 139. The insulating component of claim 136, wherein the cornered portion hooks over an edge of the second wall.

Embodiment 140. The insulating component of claim 136, wherein the cornered portion defines an angle of from about 85 to about 95 degrees.

Embodiment 141. An insulating component, comprising: a first wall bounding an interior volume; a second wall spaced at a distance from the first wall so as to define an insulating space between the first wall and the second wall; and an end cap, the end cap optionally being toroidal in form and further optionally defining a U-shaped cross-sectional profile, the end cap comprising a portion that extends along the first wall, the end cap comprising a portion that extends along the second wall, the end cap at least partially sealing the insulating space defined between the first wall and the second wall, the insulating component optionally comprising a second end cap, the second end cap configured to at least partially seal the insulating space defined between the first wall and the second wall. An exemplary, non-limiting illustration is provided in FIG. 23 and the related description.

It should be understood that an insulating component can also be considered a molecular excitation chamber. As but one example, molecules can be excited such that they exit from a space, thereby rendering the space (which now has fewer molecules available for heat conduction) a thermal insulator.

As an example, the end cap can seal the space at one end of the first wall and the second wall, and the second end cap can seal the space at the second end of the first wall and the second wall. This is not a requirement, as a space can be, e.g., sealed at one end by an end cap and sealed at the other end by sealing the walls to one another.

Without being bound to any particular theory, having first and second end caps can facilitate evacuation of the insulating space between the walls. The second end cap can be of the same configuration as the (first) end cap, although this is not a requirement. As an example, one end cap can have a certain cross-sectional profile (e.g., a squared-off U) and the other end cap can have a different cross-sectional profile (e.g., a curved U-shape). Toroidal configurations are considered suitable; illustrative such configurations are described elsewhere herein.

Embodiment 142. The insulating component of claim 141, wherein the portion of the end cap that extends along the first wall extends into the insulating space.

Embodiment 143. The insulating component of any one of claims 141-142, wherein the portion of the end cap that extends along the second wall extends into the insulating space.

Embodiment 144. The insulating component of any one of claims 141-143, wherein the portion of the end cap that extends along the first wall extends by distance that is greater than a distance by which the portion of the end cap that extends along the second wall extends.

What is claimed:

1. An insulating component, comprising:
a first wall bounding an interior volume;
a second wall spaced at a distance from the first wall so as to define an insulating space between the first wall and the second wall; and
an end cap, the end cap optionally being toroidal in form and further optionally defining a U-shaped cross-sectional profile,
the end cap comprising a portion that extends along the first wall,
the end cap comprising a portion that extends along the second wall,
the end cap at least partially sealing the insulating space defined between the first wall and the second wall,
the insulating component optionally comprising a second end cap, the second end cap configured to at least partially seal the insulating space defined between the first wall and the second wall.

2. The insulating component of claim 1, wherein the portion of the end cap that extends along the first wall extends into the insulating space.

3. The insulating component of claim 1, wherein the portion of the end cap that extends along the second wall extends into the insulating space.

4. The insulating component of claim 1, wherein the portion of the end cap that extends along the first wall extends by distance that is greater than a distance by which the portion of the end cap that extends along the second wall extends.

5. An insulating component, comprising:
a first wall bounding an interior volume;
a second wall spaced at a distance from the first wall so as to define an insulating space between the first wall and the second wall;
a first cap, the first cap at least partially sealing the insulating space defined between the first wall and the second wall,
the first cap comprising a first land, the first land optionally sealed to the first wall, and the first cap further comprising a second land, the second land optionally sealed to the second wall.
a first vent communicating with the insulating space to provide an exit pathway for gas molecules from the insulating space,
the first vent being sealable for sealing the insulating space following egress of gas molecules through the vent.

6. The insulating component of claim 5, wherein the first vent is defined by the first land and the first wall.

7. The insulating component of claim 5, further comprising a second cap, the second cap at least partially sealing the insulating space defined between the first wall and the second wall.

8. The insulating component of claim 7, wherein the second cap comprises a first land and a second land.

9. The insulating component of claim 8, wherein the first land and the second land of the second cap extend in generally the same direction.

10. The insulating component of claim 7, wherein the first land and the second land of the second cap extend in generally opposite directions.

11. The insulating component of claim 5, wherein the first land and the second land of the first cap extend in generally the same direction.

12. The insulating component of claim 5, wherein the first land and the second land of the first cap extend in generally opposite directions.

13. The insulating component of claim 5, wherein (a) the first land of the first cap defines a height that varies around a perimeter of the cap, (b) the second land of the first cap defines a height that varies around a perimeter of the cap, or (a) and (b).

14. An insulating component, comprising:
a first wall;
a second wall,
the first wall enclosing the second wall,
the first wall comprising a sloped portion that extends toward the second wall and the first wall also comprising a land portion that extends from the sloped portion,
the second wall comprising a sloped portion that extends toward the first wall and the second wall also comprising a land portion that extends from the sloped portion,
a third wall;
a fourth wall, the third wall enclosing the fourth wall,
the land of the first wall being sealed to the third wall and the land of the second wall being sealed to the fourth wall so as to at least partially seal a space between the first wall and the second wall that is in fluid communication with a space between the third wall and the fourth wall.

15. An insulating component, comprising:
a first wall bounding an interior volume;
a second wall spaced at a distance from the first wall so as to define an insulating space between the first wall and the second wall;
a first cap defining a curved profile,
the first cap at least partially sealing the insulating space defined between the first wall and the second wall,
a second cap defining a curved profile,
the second cap comprising a first portion sealed to the first wall,
the second cap further comprising a second portion sealed to the second wall, and
the curved profile of first wall and the curved profile of the second wall being concave away from one another.

16. The insulating component of claim 15, wherein the first cap is sealed to facing surfaces of the first wall and the second wall.

17. The insulating component of claim 15, wherein the first cap is sealed to non-facing surfaces of the first wall and the second wall.

18. The insulating component of claim 15, wherein the second cap is sealed to facing surfaces of the first wall and the second wall.

19. The insulating component of claim 15, wherein the second cap is sealed to non-facing surfaces of the first wall and the second wall.

20. A molecule excitation chamber, comprising:
a first wall bounding an interior volume,
the first wall comprising a main portion having a length and a projection portion having a length,
the main portion optionally extending perpendicular to the projection portion;
a second wall bounding the interior volume,
the second wall comprising a main portion having a length and optionally comprising a projection portion having a length,
(a) the projection portion of the first wall and the second wall defining a first vent therebetween, or (b) the second wall and the first wall defining a second vent therebetween, or (c) both (a) and (b), and
the ratio of the length of the main portion of the first wall to the projection portion of the first wall being from about 1000:1 to about 1;1, and, optionally,
a heat source configured to effect heating of molecules disposed within the interior volume of the molecule excitation chamber.

21. The molecule excitation chamber of claim 20, wherein the second wall is configured to deflect molecules that collide with the second wall toward the first vent.

22. The molecule excitation chamber of claim 20, wherein the molecule excitation chamber comprises a second vent.

23. The molecule excitation chamber of claim 22, wherein the second vent is defined by the first wall and the projection portion of the second wall.

24. The molecule excitation chamber of claim 22, wherein the second vent is disposed opposite the first vent.

25. The molecule excitation chamber of claim 22, wherein the space defines a major axis and wherein, a line drawn parallel to the major axis does not intersect both the first vent and the second vent.

26. The molecule excitation chamber of claim 20. wherein the space is sealed and further wherein the space is evacuated to a pressure of from about 0.0001 to about 50 Torr.

27. The molecule excitation chamber of claim 26, wherein the space is evacuated to a pressure of from about 0.005 to about 5 Torr.

28. A method, comprising opening the first vent of a molecule excitation chamber according to claim 20.

29. A method, comprising:
assembling
(a) a first wall comprising a main portion having a length and a projection portion having a length, the main portion optionally extending perpendicular to the projection portion, and the ratio of the length of the main portion of the first wall to the projection portion of the first wall being from about 1000:1 to about 1;1, and
(b) a second wall comprising a main portion having a length and optionally comprising a projection portion having a length,
the assembling being performed so as to define a first vent defined by the projection portion of the first wall and the second wall, and,
sealing the first vent so as to seal a space between the first wall and the second wall.

30. The method of claim 29, wherein the sealing is accomplished with a sealing material.

31. The method of claim 30, wherein the sealing material acts to at least partially occlude the first vent during sealing.

32. The method of claim 31, wherein the sealing material forms a meniscus during sealing.

33. The method of claim 29, wherein the first wall and the second wall define a second vent therebetween.

34. The method of claim 33, wherein the second vent is defined by the first wall and a projection portion of the second wall.

35. The method of claim 33, wherein the space defines a major axis and wherein, a line drawn parallel to the major axis does not intersect both the first vent and the second vent.

36. The method of claim 30, further comprising applying heat so as to give rise to a pressure within the space of from about 0.0001 to about 50 Torr.

37. The method of claim 36, wherein the heat is applied so as to give rise to a pressure within the space of from about 0.005 to about 5 Torr.

38. An insulating component, comprising:
a first wall bounding an interior volume;
a second wall spaced at a distance from the first wall so as to define an insulating space between the first wall and the second wall;
an inner surface of the second wall facing the insulating space, and an outer surface of the first wall facing the insulating space,
(a) the first wall comprising an extension portion that (i) extends from a first end of the first wall toward the inner surface of the second wall and is optionally essentially perpendicular to the inner surface of the second wall and/or (ii) extends toward a second end of the first wall, the extension portion of the first wall optionally further comprising a land portion that is essentially parallel to the inner surface of the second wall, or
(b) the second wall comprising an extension portion that (i) extends from a first end of the second wall toward the outer surface of the first wall and is optionally essentially perpendicular to the outer surface of the first wall and/or (ii) extends toward a second end of the second wall, the extension portion of the second wall optionally further comprising a land portion that is essentially parallel to the outer surface of the first wall, or
both (a) and (b), and
a first vent communicating with the insulating space to provide an exit pathway for gas molecules from the insulating space,
the vent being sealable for sealing the insulating space following egress of gas molecules through the vent.

39. The insulating component of claim 38, wherein the first and second walls are characterized, respectively, as a first tube and a second tube.

40. The insulating component of claim 39, wherein the first and second tubes are arranged coaxial with one another.

41. The insulating component of claim 38, wherein the extension portion of the first wall defines a length LE1, as measured by a line perpendicular to the first wall.

42. The insulating component of claim 41, wherein the first wall defines a length WL1, and wherein the ratio of LE1 to WL1 is from about 1:1000 to about 1:2.

43. The insulating component of claim 42, wherein the ratio of LE1 to WL1 is from about 1:10 to about 1:5.

44. The insulating component of claim 38, wherein the extension portion of the second wall defines a length LE2, as measured by a line perpendicular to the second wall.

45. The insulating component of claim 44, wherein the second wall defines a length WL2, and wherein the ratio of LE2 to WL2 is from about 1:1000 to about 1:2.

46. The insulating component of claim 45, wherein the ratio of LE2 to WL2 is from about 1:100 to about 1:5.

47. The insulating component of claim 38, wherein the second wall is configured such that effective conditions effect thermal expansion of the second wall relative to the first wall such that the first vent is opened.

48. The insulating component of claim 38, wherein the first vent is at least partially defined by the land portion of the first wall.

49. The insulating component of claim 48, further comprising a second vent, the second vent being at least partially defined by the land portion of the second wall.

50. The insulating component of claim 49, wherein, along a line extending parallel to the inner surface of the second wall, the first vent and the second vent do not overlap one another.

51. The insulating component of claim 38, further comprising a sealant that seals the first vent so as to seal the insulating space, the sealant optionally being disposed so as to at least partially occlude the first vent.

52. A method, comprising communicating a fluid within the interior volume of an insulating component according to claim 38.

53. A method, comprising heating a material disposed at least partially within the interior volume of an insulating component according to claim 38.

54. The method of claim 53, wherein the heating comprising heating the material without burning the material.

55. The method of claim 53, wherein the material comprises a smokeable material.

56. A method, comprising:
with a first wall bounding an interior volume and a second wall spaced at a distance from the first wall,
a volume defined between the first wall and the second wall,
(a) the first wall comprising an extension portion that extends toward the second wall and is optionally essentially perpendicular to the inner surface of the second wall, the extension portion of the first wall optionally further comprising a land portion that is essentially parallel to the inner surface of the second wall,
(b) the second wall comprising an extension portion that extends toward the outer surface of the first wall and is optionally essentially perpendicular to the outer surface of the first wall, the extension portion of the second wall optionally further comprising a land portion that is essentially parallel to the outer surface of the first wall,
or both (a) and (b), and
(c) the land portion of the first wall contacting the second wall so as to define a volume between the first wall and the second wall, (d) the land portion of the second wall contacting the first wall so as to define a volume between the first wall and the second wall,
or both (c) and (d),
heating the first wall and the second wall under conditions effective to effect thermal expansion of the second wall relative to the first wall,
the thermal expansion giving give rise to or increasing a space between the land portion of the first wall and the second wall and/or giving rise to or increasing a space between the land portion of the second wall and the first wall, thereby allowing gas molecules to exit the volume defined between the first wall and the second wall.

57. The method of claim 56, wherein the heating is performed at less than atmospheric pressure.

58. The method of claim 56, wherein the thermal expansion gives rise to or increases a space between the land portion of the first wall and the second wall.

59. The method of claim 56, wherein the thermal expansion gives rise to or increases a space between the land portion of the second wall and the first wall.

60. The method of claim 59, wherein the thermal expansion gives rise to or increases a space between the land portion of the first wall and the second wall and gives rise to or increases a space between the land portion of the second wall and the first wall.

61. The method of claim 56, wherein the heating is effective to effect sealing by a sealant of the space between the land portion of the first wall and the second wall and/or the space between the land portion of the second wall and the first wall.

62. An insulating component, comprising:
a second wall bounding at least a portion of an interior volume and defining a lumen therein, the interior volume defining a major axis;
a first wall spaced at a distance from the second wall so as to define an insulating space between the first wall and the second wall;
the interior volume defining a first cross-sectional dimension at a first location along the major axis and the interior volume defining a second cross-sectional dimension at a second location along the major axis.

63. The insulating component of claim 62, wherein the second wall defines a (a) step-wise contraction located between the first location along the major axis and the second location along the major axis or (b) a step-wise expansion located between the first location along the major axis and the second location along the major axis.

64. The insulating component of claim 63, wherein the step-wise contraction is defined by a 90 degree corner formed in the second wall.

65. The insulating component of claim 62, wherein the first wall defines a (a) tapered contraction located between the first location along the major axis and the second location along the major axis or (b) a tapered expansion located between the first location along the major axis and the second location along the major axis.

66. The insulating component of claim 62, wherein the first cross-sectional dimension is from 0.01 to about 100 times the second cross-sectional dimension.

67. The insulating component of claim 62, wherein the second cross sectional dimension is defined by the second wall.

68. The insulating component of claim 62, wherein the second cross sectional dimension is defined by the first wall.

69. The insulating component of claim 62, further comprising a data transmission element extending into the interior volume, the data transmission element extending through the second location along the major axis of the interior volume.

70. The insulating component of claim 69, wherein the data transmission element extends through the first location along the major axis of the interior volume.

71. The insulating component of claim 62, further comprising a jacket at least partially enclosing the first wall.

72. The insulating component of claim 71, wherein the jacket is secured at at least one location to the first wall.

73. The insulating component of claim 62, further comprising a fitting connected to the first wall.

74. The insulating component of claim 73, wherein the fitting comprises a threading.

75. The insulating component of claim 62, wherein the component (i) defines a first region having a first length measured along the major axis, the first region being characterized as having the first cross-sectional dimension and (ii) defines a second region having a second length measured along the major axis, the second region being characterized as having the second cross-sectional dimension.

76. The insulating component of claim 75, wherein the ratio of the first length to the second length is from about 1:100 to about 100:1.

77. The insulating component of claim 62, further comprising an electronic component disposed within the interior volume.

78. A method, comprising communicating or retaining a fluid within the interior volume of an insulating component according to claim 62.

79. An insulating component, comprising:
a first wall and a second wall, the first wall and second wall defining a sealed insulating space therebetween;
a third wall and a fourth wall, the third wall and the fourth wall defining a sealed insulating space; and
the second wall and third wall defining an interstitial space therebetween.

80. The insulating component of claim 79, wherein the interstitial space is sealed.

81. The insulating component of claim 79, further comprising an insulating material disposed within the interstitial space.

82. The insulating component of claim 81, wherein the insulating material comprises a refractory fibrous material, a refractory porous material, or any combination thereof.

83. The insulating component of claim 82, wherein the insulating material comprises a ceramic.

84. The insulating component of claim 83, wherein the insulating component comprises alumina.

85. A method, comprising communicating or retaining a fluid within the lumen of an insulating component according to claim 79.

86. An insulating component, comprising:
a first vessel comprising (a) a second wall bounding at least a portion of an interior volume, the interior volume defining a major axis and (b) a first wall spaced at a distance from the first wall so as to define a sealed insulating space between the first wall and the second wall;
a feedthrough portion comprising (a) a first feedthrough wall and (b) a second feedthrough wall, the first feedthrough wall and the second feedthrough wall defining a sealed insulated space therebetween, the second feedthrough wall defining a lumen therein, the lumen of the feedthrough portion being in fluid communication with the interior volume of the first vessel.

87. The insulating component of claim 86, wherein the first vessel defines a major axis, the feedthrough portion defines a major axis, and the major axis of the first vessel is offset by an angle from the major axis of the feedthrough portion.

88. The insulating component of claim 86, wherein the first vessel defines a major axis, the feedthrough portion defines a major axis, and the major axis of the first vessel does not intersect the major axis of the feedthrough portion.

89. The insulating portion of claim 86, wherein the first vessel defines a length, wherein the feedthrough portion defines a length, and wherein the ratio of the length of the first vessel and the length of the feedthrough portion is from about 1:1 to about 1:100.

90. The insulating portion of claim 86, wherein the feedthrough portion is characterized as being flexible.

91. The insulating component of claim 86, wherein the first vessel defines a major axis, the feedthrough portion defines a major axis, and the major axis of the first vessel is coaxial with the major axis of the feedthrough portion.

92. The insulating component of claim 86. further comprising a signal carrier extending from the lumen of the feedthrough portion into the interior volume of the first vessel.

93. The insulating component of claim 92, wherein the signal carrier comprises an electrical conductor, a fiber optic, or any combination thereof.

94. The insulating component of claim 86, further comprising a tube extending from the lumen of the feedthrough portion into the interior volume of the first vessel.

95. The insulating component of claim 86, further comprising a jacket at least partially enclosing the first wall.

96. The insulating component of claim 95, wherein the jacket is secured at at least one location to the first wall.

97. The insulating component of claim 86, further comprising a fitting connected to the first wall.

98. The insulating component of claim 97, wherein the fitting comprises a threading.

99. An insulated article comprising:
a first wall bounding an interior volume;
a second wall spaced at a distance from the first wall to define an insulating space therebetween,
a vent communicating with the insulating space to provide an exit pathway for gas molecules from the space,
the vent being sealable for maintaining a vacuum within the insulating space following evacuation of gas molecules through the vent,
the distance between the first and second walls being variable in a portion of the insulating space adjacent the vent such that gas molecules within the insulating space are directed towards the vent by the variable-distance portion of the first and second walls during the evacuation of the insulating space,
the directing of the gas molecules by the variable-distance portion of the first and second walls imparting to the gas molecules a greater probability of egress from the insulating space than ingress, and
(a) a positive thermal coefficient (PTC) material being at least partially disposed within the interior volume, (b) the first wall at least partially comprising a PTC material, (c) the second wall at least partially comprising a PTC material, (d) a PTC material being disposed exterior to the second wall, or any combination of (a), (b), (c), and (d).

100. The insulated article according to claim 99, wherein one of the walls includes a portion that converges toward the other wall adjacent the vent, and wherein the distance between the walls is at a minimum adjacent the location at which the vent communicates with the insulating space.

101. The insulated article according to claim 99, wherein the first and second walls are provided by first and second tubes arranged substantially concentrically so as to define an annular space therebetween.

102. The insulated article according to claim 99, wherein the converging wall portion of the one of the walls is located adjacent an end of the associated tube.

103. The insulated article according to claim 99, wherein the wall including the converging portion is comprised in an outer one of the tubes.

104. The insulated article according to claim 99, further comprising a coating disposed on a surface of the one of the walls, the coating formed by a material having an emissivity that is less than that of the wall on which it is disposed.

105. The insulated article of claim 99, further comprising a material disposed between the first and second tubes so as to reduce direct contact between the first and second tubes.

106. The insulated article according to claim 105, wherein the material comprises thread, fiber, yarn, or any combination thereof.

107. The insulated article according to claim 105, wherein the material comprises a reflective material.

108. The insulated article according to claim 105, wherein the material comprises a ceramic.

109. The insulated article according to claim 99, further comprising: a third tube located within the insulating space between the first and second tubes, the third tube being arranged substantially concentric to the first and second tubes.

110. The insulated article according to claim 99, wherein the article is a container and wherein the first wall defines a substantially rectangular storage space.

111. The insulated article according to claim 99, wherein the vent is defined by an opening in one of the walls and wherein a portion of the other of the walls opposite the vent is arranged such that a tangent line at each location within the portion of the other of the walls is directed substantially towards the vent.

112. The insulated article according to claim 99, wherein the PTC material is comprised in a heater.

113. The insulated article of claim 99, wherein the PTC material comprises a polycrystalline ceramic.

114. The insulated article of claim 99, further comprising an amount of a smokeable material disposed so as to be heatable by the PTC material.

115. The insulated article of claim 114, wherein the smokeable material is at least partially disposed within the interior volume.

116. A method, comprising:
applying a current to the PTC material of an insulated article according to claim 99 so as to effect heating of the PTC material.

117. The method of claim 116, wherein the applying is effected so as to give rise to heating a smokeable material.

118. The method of claim 117, wherein the applying is effected so as to give rise to heating the smokeable material without burning the smokeable material.

119. An insulated article, comprising:
a first wall bounding an interior volume;
a second wall spaced at a distance from the first wall, a sealed insulating space defined between the first wall and the second wall; and
(a) a positive thermal coefficient (PTC) material being at least partially disposed within the interior volume, (b) the first wall at least partially comprising a PTC material, (c) the second wall at least partially comprising a PTC material, (d) a PTC material being disposed exterior to the second wall, or any combination of (a), (b), (c), and (d).

120. The insulated article of claim 119, wherein the first wall and the second wall are characterized as tubes.

121. The insulated article according to claim 119, further comprising a material disposed between the first and second tubes so as to reduce direct contact between the first and second tubes.

122. The insulated article according to claim 121, wherein the material comprises thread, fiber, yarn, or any combination thereof.

123. The insulated article according to claim 122, wherein the material comprises a reflective material.

124. The insulated article according to claim 123, wherein the material comprises a ceramic.

125. The insulated article according to claim 119, further comprising: a third tube located within the insulating space between the first and second tubes, the third tube being arranged substantially concentric to the first and second tubes.

126. The insulated article according to claim 119, wherein the PTC material is comprised in a heater.

127. The insulated article of claim 119, wherein the PTC material comprises a polycrystalline ceramic.

128. The insulated article of claim 119, further comprising an amount of a smokeable material disposed so as to be heatable by the PTC material.

129. The insulated article of claim 128, wherein the smokeable material is at least partially disposed within the interior volume.

130. A method, comprising:
applying a current to the PTC material of an insulated article according to any one of claims 115-125 so as to effect heating of the PTC material.

131. The method of claim 130, wherein the applying is effected so as to give rise to heating a smokeable material.

132. The method of claim 131, wherein the applying is effected so as to give rise to heating the smokeable material without burning the smokeable material.

133. An insulating component, comprising:
a first wall bounding an interior volume;
a second wall spaced at a distance from the first wall so as to define an insulating space between the first wall and the second wall; and
an end cap defining an M-shaped cross-sectional profile,
the end cap comprising a portion that extends along the first wall,
the end cap comprising a portion that extends along the second wall,
the end cap comprising a portion that extends into the insulating space,
the end cap at least partially sealing the insulating space defined between the first wall and the second wall.

134. The insulating component of claim 133, wherein the end cap comprises a curved portion.

135. The insulating component of claim 134, wherein the curved portion extends into the insulating space.

136. The insulating component of claim 134, wherein the curved portion hooks over an edge of the first wall.

137. The insulating component of claim 134, wherein the curved portion hooks over an edge of the second wall.

138. The insulating component of claim 133, wherein the end cap comprises a cornered portion.

139. The insulating component of claim 134, wherein the cornered portion extends into the insulating space.

140. The insulating component of claim 134, wherein the cornered portion hooks over an edge of the first wall.

141. The insulating component of claim 134, wherein the cornered portion hooks over an edge of the second wall.

142. The insulating component of claim 134, wherein the cornered portion defines an angle of from about 85 to about 95 degrees.
